(19) United States
(12) Patent Application Publication
(10) Pub. No.: US 2024/0412603 A1
(43) Pub. Date: Dec. 12, 2024

(54) Instant Game Network Integrated Technology Enhancement Systems and Methods

(71) Applicant: Frederick Sandvick, San Diego, CA (US)

(72) Inventor: Frederick Sandvick, San Diego, CA (US)

(21) Appl. No.: 18/331,142

(22) Filed: Jun. 7, 2023

(51) Int. Cl. G07F 17/32

(52) U.S. Cl. CPC G07F 17/329; G07F 17/3225; G07F 17/3262

(57) ABSTRACT

An instant-winner lottery game system includes a central computer programmed to communicate via a network and process instant-winner lottery games; one or more lottery retail interface terminals and/or point of sale devices located at one or more spaced-apart locations having a means capable of interfacing with and/or a device providing information to and from the central computer; a means capable of storing and/or processing information, and a means capable of communicating information to mobile computing devices; and one or more mobile computing devices capable of downloading a software application and networking with the central computer, wherein a player can select instant-winner lottery games from a display, wherein an identifying code or data can be communicated to lottery retail interface terminals and/or point-of-sale devices, wherein information and/or codes relating to selected games is communicated from lottery retail interface terminals or central computer to mobile computing devices.

### CROSS-REFERENCE TO RELATED APPLICATIONS

The present nonprovisional application claims priority benefit of the U.S. provisional application for patent Ser. No. 63/350,374 titled “Systems and Methods for Providing Digital Lottery Games” filed on Jun. 8, 2022 under 35 U.S.C. § 119 (e). The contents of this related nonprovisional application are incorporated herein by reference for all purposes to the extent that such subject matter is not inconsistent herewith or limiting hereof.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### BACKGROUND OF THE INVENTION

### 1. Field of the Invention

The invention relates to the field of instant-winner lottery games and other games of chance and skill, the technological architecture for systems and methods of implementing such games, and the integration of effective game enhancements, advertising, player monitoring, game management and related methodologies into the technology of such systems and methods.

### 2. Description of the Related Art

The internet and mobile devices have changed peoples' habits on how they transact business and personal matters and the lottery and gambling industries are pressed to integrate these means into their systems, devices and products. However, security issues, jurisdictional laws and regulations, as well as social resistance, have limited the ability of those industries to create a technological architecture to achieve such integration,

As for the lottery industry, currently, instant-winner lottery games provided at point-of-sale locations are sold as physical instant-winner lottery tickets (aka. “scratch-off” and “pull-tab” tickets). Many modern methodologies have attempted to obsolete existing ticket dispensing systems of lotteries and replace them with “on line,” “internet,” or “digital ecommerce” systems so that instant-winner lottery games could be sold over real-time terminals or through websites. However, these methodologies have been politically and socially rejected and/or significantly limited in many lottery jurisdictions. Most jurisdictions require point-of-sale type lottery transactions to be performed through designated “lottery terminals,” “lottery vending machines,” and/or jurisdictionally approved “clerk-assisted” establishments. Further, lotteries themselves are reluctant to simply discard physical instant ticket systems that generate billions of dollars in lottery revenue for alternative systems that may or may not generate the same level of revenue. Therefore, lotteries face the conundrum of maintaining their relatively high-cost ticket distribution and dispensing systems, with the pressure of maintaining and increasing lottery revenues in the modern world of advanced technology and the internet.

This inventor, a former lottery and gambling industry executive, who has already invented and patented changes to instant-winner ticket technology and systems, has monitored the industry's inability to create the architecture for commercially feasible technological systems and methods that could eliminate and/or augment its traditional instant-winner ticket retail systems while having the flexibility to adjust to changing requirements of political and legislative jurisdictions. The problems he saw were in would-be inventors' primary focus on trying to simply introduce new technology rather than on creating a novel technological architecture capable of integrating compelling features and novel methodological solutions to the various problems associated with instant tickets, business dynamics and the lottery industry that otherwise limit the ability to change existing systems and methods. The Inventor realized that none of the existing and prior art that was related to mobile technology and digital games solved the major problems that have limited the ability of the industry to significantly improve its instant-winner lottery systems and methods in a cost effective and/or practical manner. This invention is a culmination of his many years of research and studies into developing technological systems and methods that could work harmoniously together to meet regulatory rules and social standards, technological system requirements, player expectations and demands, and lottery supplier expectation and demands, while creating a commercially feasible system that could solve the “real” problems the lottery industry faces with respect to advancing the sale of instant-winner lottery games both at physical point-of-sale locations and on mobile devices into the 21st century. Inventing such a technological system and method is similar to solving the first Rubik's cube—although all of the elements may be seen and may be known, the genius is in how to put them together to make them work harmoniously with commercial feasibility.

### Paper-Based Instant-Winner Lottery Ticket Systems

Currently, almost all instant-winner lottery games sold at physical point-of-sale locations are packaged as paper-based instant-winner lottery tickets (referred to herein as “instant ticket games”) that are sold “over-the-counter” (i.e. clerk-assisted in retail locations) and through vending machines (i.e. clerk-assisted dispensers and self-service vending machines). Instant-winner lottery games are games in which a player has the ability to determine whether they have won or lost at the time that they purchase or play the game, versus draw games, such as Powerball® or Mega Millions®, which provide periodic drawings to determine the winner. Most instant-winner lottery games are physical instant ticket games, but a small number of lottery jurisdictions also allow for gambling devices that are linked to a central server to play instant-winner digital lottery games, but these are similar to casino type games, small in number, and are not point-of-sale (retail) and/or mobile type transactions. Gambling devices are also referred to herein as gaming devices, as the gambling industry is also referred to as the gaming industry.

The methodologies for instant ticket games require them to be paper-based, batched (a specified number of tickets at a specified price) and pre-printed in a secure facility, with all the outcomes of the tickets predetermined. These methodologies subject the tickets and the systems to a myriad of issues and limitations, including: tremendous administrative and printing costs; theft and pilferage; jackpot payout limitations; stale inventory; game design limitations; promotional and advertising limitations; reward program limitations; extended play limitations; second chance play limitations; administrative and accounting errors and limitations; game management limitations; analytical limitations, revenue limitations and many other issues and limitations.

Although much of the digital technology and mobile computing devices, which are internet capable devices, such as smart phones, tablets, laptop computers, smart watches, e-readers, handheld gaming consoles, personal digital assistants, netbooks, ultra-mobile personal computers, pocket mobile personal computers, and other mobile internet capable computer devices (all of them also referred to herein as “Smart Devices”) have been around for over two decades, traditional instant ticket systems and methods continue because no system or methodology for digital games has been invented in which the benefits to implementing such system and methodology outweigh the costs. The reason for this is that no prior methodology has addressed all the “real” problems associated with replacing physical instant ticket systems. Real problems refer to issues that are not just technological, but are significant in their affect on implementing technology, such as revenue, costs, regulations, distribution, administration, entertainment and security.

In order to replace traditional instant ticket systems with a new technological architecture, economically feasible novel features and methodologies must simultaneously be created that not only provide a profitable basis to incur the costs associated with the creation and implementation of a new technological architecture, but help solve all the myriad real problems of the prior systems. None of the prior art has created or suggested how to create the necessary technological architecture with such novel features, and methodologies that allow for a new technological system to be economically feasible to implement.

Some methodologies have attempted to use 21^{st} Century technology to evolve the instant ticket game. A very simple creation of a hybrid method can be found in U.S. Pat. No. 8,696,431B2, “Mobile play instant ticket lottery game” (“the '431 patent”) where the method describes scanning an instant ticket on a mobile internet-capable device, which then must communicate with a lottery central computer to show a visual presentation of the ticket game. The problem with the method is that it failed to justify why a player would want to scan the ticket and receive a visual presentation of the ticket game. In fact, the method has a dependent claim that simply allows the player to determine the outcome of the game without scanning the ticket on a mobile internet-capable device. What was the point of the invention? The method simply assumes that a player would prefer using their mobile phone for everything, regardless of inconveniences. The methodology fails to understand that this field is about gambling—in which the primary motivation of a player is to determine if they won or lost, which can be learned in a matter of seconds from a traditional instant ticket by scratching off the surface, or pulling a tab, to reveal the outcome. Scanning the ticket to a mobile internet device is, quite simply, more work for the player, and more cost to the lottery and lottery suppliers to provide digital simulations, making the invention cost prohibitive. The method simply inserted technology and solved none of the problems or limitations associated with paper-based instant tickets. It is an invention that provides something that solves nothing.

The real evolution of instant ticket games into a mobile friendly system that could solve some of the problems and limitations associated with paper-based instant tickets can be found in patents U.S. Pat. Nos. 9,251,663, 9,443,397, and 10,354,495, (referred to as the Sandvick patents). Although the Sandvick patents similarly provided for the scanning of instant tickets, it is not the scanning of the ticket or visual presentation of the instant ticket game that solves any problems or creates any advantages. The methodologies for scanning and displaying digital data onto a smart phone have been available for almost two decades. It is the novel methodologies beyond simply scanning and displaying visual game results that the Sandvick patents provided that for the first time could solve some of the problems and limitations of paper-based instant tickets.

But, as novel and advancing as the Sandvick patents are, they are still limited by the fact that the underlying fundamentals of the system and method incorporate and embrace traditional paper-based instant tickets as one of the primary elements of the invention. This was done so that a player could choose a particular physical ticket from one of many retail displays and then scan that ticket at a retailer terminal or on their own personal pc or mobile device. By embracing paper-based tickets, that invention allows lotteries to continue selling at point-of-sale retail locations with very little changes necessary to their retail system. It is a novel and inexpensive solution for lotteries to advance paper-based instant tickets into the 21^{st} Century. Nevertheless, the system still requires the pre-printing, deployment, and sale of instant tickets. Simply put, it is not an instant-winner digital game system, it is an instant-winner ticket system, which is completely different and does not enable nor suggest the new architecture of the technological systems and methodologies created from this invention.

Unlike the Sandvick patents, this invention creates the architecture of a new technological system and methodology that eliminates the need for paper-based instant tickets, yet still allows the lotteries to continue to sell at physical point-of-sale retail locations, while being flexible enough to provide multiple configurations so that a lottery can choose how they want to provide game play data, through dedicated communication means, and/or through low cost designed lottery retail interface terminals, and/or through the internet to Smart Devices. As will be further described herein, the current invention completely solves the problems and limitations of paper-based instant tickets that the Sandvick patents or any other previous invention were not intended to solve.

### Digital-Based Lottery Game Systems

Digital lottery games have been in existence for quite some time, most of which are operated from websites solely through the internet or closed-end systems (such as in casino systems and video lottery gaming systems). Although there are many differences between those systems and the current invention, the major difference is that the current invention primarily focuses on creating a technological architecture that includes networking multiple devices, including devices at physical point-of-sale locations, such as retailer locations (e.g. supermarkets, convenience stores, shopping malls, etc.) and/or self-service non-retailer locations (e.g. airports, bus stops, subways, bowling alleys, etc.) in order to either eliminate the use of traditional paper-based instant tickets or augment their use as an additional method for selling instant winner lottery games.

There are some systems that have been patented relating to mobile devices and lottery games, but none of those systems suggest nor enable the current invention. For instance, U.S. Pat. No. 9,672,687B2, “Processing of a mobile device game-playing transaction based on the mobile device location” simply discloses the method of receiving information associated with a game-playing transaction between a user device and a user game-playing terminal. It only focuses on a system related to the location of the mobile device, which has no embodiment in the current invention. And, US20120089468A1, “Lottery Ticket Purchase Apparatus and Method” focuses on purchasing lottery game tickets remotely, which, again, has no embodiment in the current invention, as the current invention neither uses lottery tickets, nor has claims for remote purchasing of tickets.

Also, U.S. Pat. No. 9,836,923B2, “Ordering lottery tickets using mobile devices,” only focuses on a system to purchase lottery tickets on a mobile device, which also has no relevance to the current invention. Although the mobile device in that system interacts with a retailer system by providing a bar code from the mobile device, it requires the retailer system to communicate with the lottery central server to obtain verification of the transaction, wherein the lottery central server would then send the image of the tickets to the mobile device or email. It does not focus on the sale of digital games, but on the sale of paper-based lottery tickets. Further, it completely ignores the method of selling and displaying digital games at retail locations and the integration of enhanced features.

In other non-lottery methods, such as, U.S. Pat. No. 9,754,443B2, “System and method for remote control gaming sessions using a mobile device,” the method only focuses on communication between existing gaming machines and mobile devices, which, again, has no embodiment in the current invention, as it does not relate to an instant-winner lottery system, nor does it have physical point of sale display, deployment and purchasing at multiple retail locations. The same deficiencies exist for patents U.S. Pat. No. 9,412,227B2, “Method and apparatus for offering a mobile device version of an electronic gaming machine game at the electronic gaming machine” and U.S. Pat. No. 9,589,415B2, “Gaming machine and method to effect information transfer between a gaming machine and an external device.”

Based on a review of available information on patents and literature, only one proposed system and patent was found to provide a method of displaying and selling digital lottery game play in retail locations—U.S. Pat. No. 10,453,296B2, “Method and system for lottery game play transactions via a kiosk and a player's mobile smart device (“the '296 patent”). However, as will be further explained, that method and system have significant issues and limitations that prevent them from practical implementation, and they neither suggest nor enable the solutions to those issues and limitations.

The first major issue with the '296 patent is that it does not deploy digital lottery games. It only provides for a self-service kiosk, which would display and provide a means to purchase lottery game play. The kiosk is simply a conduit to a central lottery server, which must be in perpetual real-time connection with such kiosk for the system to operate. Under that system, a player would select a game type from the kiosk and provide payment using a means at the kiosk, whereupon the system would be prompted to communicate such purchase to the lottery central server so that an ID code could be generated and communicated back to the kiosk, whereupon the kiosk would communicate the ID code to an application program on the player's mobile smart phone. The application program on the smart phone would then be prompted to wirelessly communicate over the internet the ID code to the lottery central server so that the actual lottery game could be wirelessly communicated over the internet back to the smart phone for display. As described, the kiosk does not provide for the actual digital lottery games, it simply provides a means to obtain a code for the later deployment of the actual game data from the central lottery server to the mobile smart phones; not that dissimilar from the methodology of the '431 patent.

The '296 patent methodology fails to recognize that not all retail locations have the ability for perpetual real time connection, nor does it recognize that the costs of having perpetual real time connection for some locations could exceed the benefits of even selling such games at the location. Since the kiosks themselves under that method do not store the data for the digital lottery games, no games can be sold under the '296 patent without the ability to have a perpetual real time connection to the central computer-a fatal flaw in the ability to fully deploy the methodology.

As will be further described herein, the current invention provides for a methodology whereby the data for the digital lottery games can be stored in a retail computer terminal so that no real-time connection is necessary to sell the instant-winner lottery games, solving the fatal flaw of the '296 patent. Although the current invention also provides methodologies for using real-time connection, such methodologies have other embodiments making them completely different from the '296 patent method.

Quite frankly, the '296 patent provides a cumbersome and expensive methodology for an application already invented more efficiently in the Sandvick patents. The '296 patent requires deployment of self-service kiosks in all retail locations just to provide an ID code that it must obtain real-time from the central lottery server in order to get that ID code communicated to mobile smart phones. The Sandvick patents already have provided a more efficient methodology to communicate such an ID code to mobile devices. In the Sandvick patents, the ID code is embedded in the existing instant tickets, which are simply scanned into the mobile smart phones, whereupon an application on the mobile smart phones would communicate with the lottery central server to retrieve game play data—an efficient, cost effective methodology. The methodology of the '296 patent may be different, but it is more cumbersome and expensive with the same result that the Sandvick patents already created.

Further, the '296 patent methodology fails to recognize that it is not practical to have self-service kiosks in every retail location. The majority of retail locations that sell instant-winner lottery tickets today have “clerk-assisted payment means,” which provide for retail clerks to be an integral part of the lottery ticket sale process, as they must accept payment for any purchases and control providing the tickets to players. The reason for this is simple: it is not economically feasible to have self-service devices in all of the hundreds of thousands of retail locations that sell lottery games. Those familiar with the lottery industry understand that self-service kiosks are not only more costly to manufacture, but more expensive to operate. The '296 patent requires self-service kiosks to sell all of the digital lottery game play in every location-another fatal flaw in the '296 patent and likely the primary reason it has never been commercialized.

As will be further described herein, the current invention provides for a methodology whereby the lottery retail interface terminals that would sell the digital lottery games do not need to be self-service; they can be manufactured for far less cost with less servicing issues, and simply used to augment existing clerk-assisted processes. Further, the current invention provides an additional method to completely circumvent the need for any kiosk or add-on lottery retail interface terminal by introducing lottery displays on Smart Devices and integrating point-of-sale device communication to provide the purchasing means, solving another fatal flaw of the '296 patent.

Further, the '296 patent fails to recognize the security issues associated with wirelessly communicating via the internet complete lottery game data, which involve hundreds of millions of dollars of jackpots. This is exactly what the '296 patent methodology requires, as all of the data related to the lottery games must be communicated from the central lottery server to the players' mobile smart phones via the internet. This is a similar problem with the '431 patent and the Sandvick patents. Of course, the methodologies require encryption techniques, which all secure systems require, but even with encryption techniques the dangers of interception, manipulation, and cyber attacks are substantial. We read daily how cyber attacks happen to some of the most secure systems in the world, and such attacks are made even more possible once a system uses the worldwide web for any part of their communication. Lottery organizations are likely to be extremely sensitive to this possibility and, therefore, very skeptical of allowing the use of the '296 patent methodology, which would be another fatal flaw in its successful practical use.

As will be further described herein, the current invention provides for technological architecture that has the option to have the lottery retail interface terminals, not the central lottery computer, provide the game play data to the Smart Devices so that no communication would be necessary over the internet between the central lottery computer and players' Smart Devices for the “initial” game play data, solving this potentially fatal flaw of the '296 patent and every other prior patent.

Further, even if the above mentioned fatal flaws in the '296 patent could be overcome (and the current invention has embodiments that solve some of those problems), as described, the '296 methodology simply is an impractical, costly technology-based alternative to existing paper-based instant tickets; it fails to compel its implementation as it provides no features that would make the display of the games more desirable for players or the lotteries. Why does a player want to go to the trouble of downloading a game to get a result in 3 to 7 seconds of display time, when they could just scratch a ticket in less time than it would take to get the ID code from the kiosk and download the game simulation from the internet? Further, why does a lottery supplier want to incur all the equipment, communication, and design of digital game costs, when they are limited by statutory guidelines of how much they can earn from the sale of instant tickets? The '296 patent does not suggest nor enable positive answers to those questions. In fact, as previously mentioned, the '296 patent is a more cumbersome and expensive methodology to a result that is already invented in the existing Sandvick patents. The '296 patent is another technology application that provides something that solves nothing.

As will be further described herein, unlike the '296 patent, the current invention can solve all the problems associated with instant ticket games—it can literally transform an industry. Unlike the '296 patent and other patents, this invention focuses on a novel technological architecture integrating methodologies that incorporate novel ways of using technology in order to integrate and provide compelling features for digital games that can enhance the games, enhance game management, minimize administrative problems, and create new revenue streams, such as: enabling jackpots to progress to unparalleled levels-driving players to want to view the digital game results; eliminating stale inventory problems through the use of non-predesignated fixed jackpots; creating true pari-mutuel games; introducing effective never-before-possible advertising and promotions with the games by extending game view through novel insertions of algorithm manipulations-which can create additional revenue streams; and, introducing free play, second chance play, extended play, and rewards programs, game analytics, and game enhancements never before possible with instant-winner lottery games, as well as other features that can increase the ability of lotteries to positively affect game play and monitor performance. In addition, the methodologies of this invention can be implemented with greater security and adapt to any lottery regulation.

Although digital lottery games have been around for over a decade, no one has ever been able to create or introduce a commercially feasible technological system or method to display, deploy and sell digital instant-winner lottery games at the hundreds of thousands of physical point-of-sale retail locations because of the flaws and problems in the technology, methodologies and features of those systems. This new invention goes beyond any prior system and methodology, by creating novel digital instant-winner lottery game systems and methodologies that solve all the practical flaws and problems of previous methods that failed to address the “real” problems of practical implementation.

Problems Associated with Creating a Technological Architecture with Methodologies for Networking an Instant-Winner Lottery System with Retail Locations and Smart Devices

As previously described, there are many problems associated with the prior art related to attempts to create a digital lottery game system that incorporates the sale of such games from retail locations and the display of such games on Smart Devices. These problems are why there has never been a successful implementation of a system for displaying, deploying, and selling instant-winner digital lottery games at retail locations for use on Smart Devices, even though digital gaming has been around and used on Smart Devices ever since such devices were created almost two decades ago. The reason is that the methodologies shown in the prior art focus primarily on technology, such as how to use wireless technology, or how to download games onto a smart phone, or how to use a kiosk, or how to connect to a website, or how to manage the location of a player, etc, rather than the integration of technology with new features that address the real problems of the industry.

The lottery industry is highly regulated and intensely competitive. Any methodology that proposes an enormous shift in procedures, applications, and technologies must provide methods that address ALL of the “real” problems associated with any proposed technological change. For instance, past technologies and methodologies failed to address such real problems as: (a) “flexibility”—a system must be able to adapt to many different types of retail environments; (b) “gambling motivations”—a system must be able to drive players to play; (c) “costs versus benefits”—a system must be more beneficial than its costs to implement and operate; (d) “statutory regulations”—a system must address the limitations established by statutory guidelines, including the types of games that can be played and the amount of fees lottery suppliers' can earn from any implementation; (c) “social standards”—a system must address the social standards of the times that limit changes to what may be socially acceptable; (f) “inherent risks”—a system must address the systems inherent risks, such as the use of certain wireless communication for high profile gaming transactions; (g) “creating new revenue”—a system should address ways lotteries and/or lottery suppliers can create new revenue, such as from third party sponsors; (h) “player rewards”—a system should address ways lotteries can reward and incentivize players to play, which is an important element for revenue growth; (i) “game designs”—a system should address its ability to foster new game designs, which is another important element for revenue growth; (j) “game enhancements”—a system should address how to enhance game play so players are motivated to take the additional steps to view the display of such games; and (k) “play information and analytics”—a system should address its ability to provide data that is necessary for administration and monitoring of the games and performance of the lottery.

The industry has a socially accepted and over four decades-long proven system and method to sell instant-winner lottery games, which is via paper-based instant tickets. In order to eliminate or augment paper-based instant tickets and effectively enable the sale and distribution of digital instant-winner lottery games, a new system must provide compelling reasons for lotteries and lottery suppliers to switch to such a system by addressing all the issues mentioned above and provide effective solutions. This is exactly what this current invention does—it provides a technological architecture for systems and methodologies that address all of the real problems and solves the Rubik's cube to creating successful digital instant-winner lottery game systems and methodologies for any particular point-of-sale environment.

### SUMMARY

In a first embodiment of the invention, an instant-winner lottery game system and method involving: a central computer programmed to communicate via an intranet, the world-wide web and/or any remote communication means; a plurality of lottery retail interface terminals located at one location or a plurality of spaced-apart locations, said plurality of lottery retail interface terminals involving: (1) a means capable of entering into a communication interface with (i) said central computer, and/or (ii) a device providing information to and/or from said central computer; (2) a means capable of storing and/or processing information provided from said central computer; (3) a display of one or a plurality of instant-winner lottery games, displaying visual identification markings of said lottery games to allow selection for purchase and, instead of a display or in conjunction with a display, a means capable of the selection of said games; and (4) a means capable of communicating and providing said information to mobile computing devices; whereby, identifying data and/or codes relating to predetermined digital instant-winner lottery games are communicated from the central computer to the lottery retail interface terminals via real-time, intermittent or intermediary communication and stored in the lottery retail interface terminals; whereby, a player selects said games from said display or a display on their mobile computing device and purchases said games via point-of-sale devices separate from or integrated with said lottery retail interface terminals; whereupon, the player provides a mobile computing device with an applicable lottery gaming application so that said identifying data and/or codes can be communicated from the computer terminal to the mobile computing device upon purchase; whereupon, the data and/or codes can be used to display and play an instant-winner lottery game(s) on the mobile computing device with no further communication necessary with said central computer, although such communication is optional; whereupon, any winnings from the game played can be redeemed by confirmation that the unique identifying code included with said information communicated to the mobile device was one as being valid in the applicable lottery system.

In a second embodiment of the invention, an instant-winner lottery game system and method involving: a central computer programmed to communicate via an intranet, the world-wide web and/or any remote communication means; a plurality of lottery retail interface terminals located at one location or a plurality of spaced-apart locations, said plurality of lottery retail interface terminals comprising: (1) a means capable of entering into a communication interface with: (i) said central computer, and/or (ii) a device providing information to and/or from said central computer; (2) a means capable of storing and/or processing information provided from said central computer; (3) a display of one or a plurality of instant-winner lottery games, displaying visual identification markings of said lottery games to allow selection for purchase and, instead of a display or in conjunction with a display, a means capable of the selection of said games; and (4) a means capable of communicating and providing said information to mobile computing devices; whereby, identifying data and/or codes relating to predetermined and/or non-predetermined digital instant-winner lottery games are communicated from the central computer to the lottery retail interface terminals via real time, intermittent and/or intermediary communication and stored in the lottery retail interface terminals; whereby, a player selects said games from said display or a display on their mobile computing device and purchases said games via point-of-sale devices separate from or integrated with said lottery retail interface terminals; whereupon, the player provides a mobile computing device with an applicable lottery gaming application so that the identifying data and/or codes of the selected game can be communicated from the applicable computer terminal to the mobile computing device upon purchase; whereupon, said application on the mobile computing device communicates the identifying data and/or codes of the selected game with the central computer, which confirms such data and/or codes as one being valid in the applicable lottery system and provides, if necessary, play data to said application on the mobile computing device to complete the display and processing of one or a plurality of said lottery games and/or a feature(s) of said games, and, optionally, coordinates internally and/or with other computer servers/networks the communication of non-play data to and/or from said mobile computing devices; whereupon, any winnings from the game played can be redeemed by confirmation that the identifying code included with said information was one being valid in the applicable lottery system.

In a third embodiment of the invention, an instant-winner lottery game system and method involving: a central computer programmed to communicate via an intranet, the world-wide web and/or any remote communication means; a plurality of lottery retail interface terminals located at one location or a plurality of spaced-apart locations, said plurality of lottery retail interface terminals comprising: (1) a means capable of entering into a communication interface with (i) said central computer and/or (ii) a device providing information to and/or from said central computer; (2) a means capable of storing and/or processing information provided from said central computer; (3) a display of one or a plurality of instant-winner lottery games, displaying visual identification markings of said games to allow selection for purchase and, instead of a display or in conjunction with a display, a means capable of the selection of said games; and (4) a means capable of communicating and providing said information to mobile computing devices; whereby a player selects said games from said display or a display on their mobile computing device and purchases said games via point-of-sale devices separate from or integrated with said lottery retail interface terminals; whereupon, the computer terminal communicates such purchase with said central computer, which confirms said purchase as one being valid in the lottery system, then communicates some or all of the identifying data and/or codes relating to the selected lottery game to said computer terminal and, optionally non-play data; whereupon, the player provides a mobile computing device with an applicable lottery gaming application so that the identifying data and/or codes relating to the selected game can be communicated from the computer terminal to the mobile computing device upon or after purchase; whereupon, said application on the mobile computing device communicates the identifying data and/or codes relating to the selected game with the central computer, which confirms such data and/or codes as one being valid in the said lottery system, which: (a) provides play data to said application on the mobile computing device to complete, continue, or begin the display and processing of one or a plurality of said lottery games and/or a feature(s) of said games on said mobile computing device; and (b) provides and/or coordinates internally and/or with other computer servers/networks the communication of non-play data to and/or from said mobile computing devices; whereupon, any winnings from the game played can be redeemed by confirmation that the identifying code included in the information was one being valid in the applicable lottery system.

In a fourth embodiment of the invention, an instant-winner lottery game system and method involving: a central computer programmed to communicate via an intranet, the world-wide web and/or any remote communication means; a plurality of lottery retail interface terminals located at one location or a plurality of spaced-apart locations, said plurality of lottery retail interface terminals comprising: (1) a means capable of entering into a communication interface with (i) said central computer and/or (ii) a device providing information to and/or from said central computer; (2) a means capable of storing and/or processing information provided from said central computer; (3) a display of one or a plurality of instant-winner lottery games, displaying visual identification markings of said games to allow selection for purchase and, instead of a display or in conjunction with a display, a means capable of the selection of said games; and (4) a means capable of communicating and providing said information to mobile computing devices; wherein the central computer is programmed to conduct one or a plurality of said games as a progressive jackpot game and/or a non-designated fixed jackpot game; whereby a player selects said games from said display or a display on their mobile computing device and purchases said games via point-of-sale devices separate from or integrated with said lottery retail interface terminals; whereupon, the computer terminal communicates such purchase with said central computer, which confirms said purchase as one that is valid in the lottery system, then communicates some or all of the identifying data and/or codes of the selected lottery game to said computer terminal; whereupon, the player provides a mobile computing device with an applicable lottery gaming application so that the identifying data and/or codes of the selected game can be communicated from the computer terminal to the mobile computing device upon or after purchase; whereupon, said application on the mobile computing device communicates the identifying data and/or codes of the selected game with the central computer, which confirms such game as being valid in the said lottery system, which: (a) provides play data to said application on the mobile computing device to complete, continue, or begin the display and processing of one or a plurality of said lottery games and/or a feature(s) of said games on said mobile computing device; (b) conducts one or a plurality of said games that have at least one fixed jackpot prize that is a non-predesignated jackpot to a particular game and/or at least one progressive jackpot game that incrementally increases in some predetermined manner as the particular game and/or game feature is played until won; and, optionally, (c) provides and/or coordinates internally and/or with other computer servers/networks the communication of non-play data to and/or from said mobile computing devices; whereupon, any winnings from the game played can be redeemed by confirmation that the unique identifying code included in the information was one being valid in the applicable lottery system.

In a fifth embodiment of the invention, an instant-winner lottery game system and method involving: a central computer programmed to communicate predetermined and/or non-predetermined digital instant-winner lottery games via an intranet, the world-wide web and/or any remote communication means; a plurality of lottery retail interface terminals located at one location or a plurality of spaced-apart locations, said plurality of lottery retail interface terminals comprising: (1) a means capable of entering into a communication interface with (i) said central computer and/or (ii) a device providing information to and/or from said central computer; (2) a means capable of storing and/or processing information provided from said central computer; (3) a display of one or a plurality of instant-winner lottery games, displaying visual identification markings of said game types to allow selection for purchase and, instead of a display or in conjunction with a display, a means capable of the selection of said games; and (4) a means capable of communicating and providing said information to mobile computing devices; whereby, a player selects said games from said display or a display on their mobile computing device and purchases said games via point-of-sale devices separate from or integrated with said lottery retail interface terminals; said purchase transaction is communicated to said central computer, which confirms said purchase as one as being valid in said system, whereupon the information relating to said games are communicated from the central computer to the lottery retail interface terminals; whereupon, the player provides a mobile computing device with an applicable lottery gaming application so that said information can be communicated from the computer terminal to said application on the mobile computing device upon or after purchase; whereupon, said application can complete the display and processing of one or a plurality of said lottery games and/or a feature(s) of said games from such information, and, optionally, coordinate with the central computer and/or with other computer servers/networks the communication of non-play data to and/or from said mobile computing device; whereupon, any winnings from the game played can be redeemed by confirmation that the identifying code included in said information as being valid in the applicable lottery system.

In a sixth embodiment of the invention, an instant-winner lottery game system and method involving: a central computer programmed to communicate predetermined or non-predetermined digital instant-winner lottery games via an intranet, the world-wide web and/or any remote communication means; a plurality of lottery retail interface terminals located at one location or a plurality of spaced-apart locations, said plurality of lottery retail interface terminals comprising: (1) a means capable of entering into a communication interface with (i) said central computer and/or (ii) a device providing information to and/or from said central computer; (2) a means capable of storing and/or processing information provided from said central computer; (3) a display of one or a plurality of instant-winner lottery games, displaying visual identification markings of said game types to allow selection for purchase and, instead of a display or in conjunction with a display, a means capable of the selection of said games; and (4) a means capable of communicating and providing said information to mobile computing devices; whereby, a player selects said games from said display or a display on their mobile computing device and purchases said games via point-of-sale devices separate from or integrated with said lottery retail interface terminals; wherein, said purchase transaction is communicated to said central computer, which confirms said purchase as one as being valid in said system, whereupon some of the information relating to said games are communicated from the central computer to the lottery retail interface terminals; whereupon, the player provides a mobile computing device with an applicable lottery gaming application so that said information can be communicated from the computer terminal to the mobile computing device upon or after purchase; whereupon, said application on the mobile computing device communicates the identifying data and/or codes of the selected game with the central computer, which confirms such data and/or codes as one being valid in the applicable lottery system and provides play data to said application on the mobile computing device to complete, continue, or begin the display and processing of one or a plurality of said lottery games and/or a feature(s) of said games, and, optionally, coordinates internally and/or with other computer servers/networks the communication of non-play data to and/or from said mobile computing devices; whereupon, any winnings from the game played can be redeemed by confirmation that the identifying code included in the said information communicated to the mobile device was one being valid in the applicable lottery system.

In a seventh embodiment of the invention, an instant-winner lottery game system and method involving: a central computer programmed to communicate predetermined and/or non-predetermined digital instant-winner lottery games via an intranet, the world-wide web and/or any remote communication means; a plurality of lottery retail interface terminals located at one location or a plurality of spaced-apart locations, said plurality of lottery retail interface terminals comprising: (1) a means capable of entering into a communication interface with (i) said central computer and/or (ii) a device providing information to and/or from said central computer; (2) a means capable of storing and/or processing information provided from said central computer; (3) a display of one or a plurality of instant-winner lottery games, displaying visual identification markings of said game types to allow selection for purchase and, instead of a display or in conjunction with a display, a means capable of the selection of said games; and (4) a means capable of communicating and providing said information to mobile computing devices; whereby, a player selects said games from said display or a display on their mobile computing device and purchases said games via point-of-sale devices separate from or integrated with said lottery retail interface terminals; if the information relating to said games have been preloaded onto the lottery retail interface terminals, then no further communication is necessary with the central computer, but if said information has not been preloaded, then said purchase transaction is communicated to said central computer, which confirms said purchase as one as being valid in said system, whereupon some or all of the information relating to the selected lottery game is communicated from the central computer to the lottery retail interface terminals; whereupon, the player provides a mobile computing device with an applicable lottery gaming application so that said information can be communicated from the computer terminal to the mobile computing device upon or after purchase; whereupon, said application on the mobile computing device communicates the information relating to the selected game with the central computer, which confirms such information as one being valid in the applicable lottery system and provides, if necessary, any additional play data to said application on the mobile computing device to complete, continue, or begin the display and processing of one or a plurality of said lottery games and/or a feature(s) of said games, and, optionally, coordinates internally and/or with other computer servers/networks the communication of non-play data to and/or from said mobile computing devices; whereupon, said application on the mobile computing device and/or said central computer is programmed to monitor game play on such player's mobile computing device and/or by the player, including, the amount of time of game play, the amount spent on such game play, and/or any such other factor related to game play, and provide rewards based on such game play; whereupon, any winnings from the game played can be redeemed by confirmation that the unique identifying code included in said information was one being valid in the applicable lottery system.

In an eighth embodiment of the invention, an instant-winner lottery game system and method involving: a central computer programmed to communicate predetermined and/or non-predetermined digital instant-winner lottery games via an intranet, the world-wide web and/or any remote communication means; a plurality of lottery retail interface terminals located at one location or a plurality of spaced-apart locations, said plurality of lottery retail interface terminals comprising: (1) a means capable of entering into a communication interface with (i) said central computer and/or (ii) a device providing information to and/or from said central computer; (2) a means capable of storing and/or processing information provided from said central computer; (3) a display of one or a plurality of instant-winner lottery games, displaying visual identification markings of said game types to allow selection for purchase and, instead of a display or in conjunction with a display, a means capable of the selection of said games; and (4) a means capable of communicating and providing said information to mobile computing devices; whereby, a player selects said games from said display or a display on their mobile computing device and purchases said games via point-of-sale devices separate from or integrated with said lottery retail interface terminals; if the identifying data and/or codes for said games have been preloaded onto the lottery retail interface terminals, then no further communication is necessary with the central computer, but if the identifying data and/or codes have not been preloaded, then said purchase transaction is communicated to said central computer, which confirms said purchase as one as being valid in said system, whereupon some or all of the information relating to the selected lottery game is communicated from the central computer to the lottery retail interface terminals; whereupon, the player provides a mobile computing device with an applicable lottery gaming application so that said information can be communicated from the computer terminal to the mobile computing device upon or after purchase; whereupon, said application on the mobile computing device communicates the information relating to the selected game with the central computer, which confirms such information as one as being valid in the applicable lottery system and provides, if necessary, any additional play data to said application on the mobile computing device to complete the display and processing of one or a plurality of said lottery games and/or a feature(s) of said games, and, optionally, coordinates internally and/or with other computer servers/networks the communication of non-play data to and/or from said mobile computing devices; whereupon, said application on the mobile computing device and/or said central computer is programmed to track lottery activity on a player's mobile computing device and/or by a player, and provide analytical information related to such game play; whereupon, any winnings from the game played can be redeemed by confirmation that the unique identifying code included in said information was one as being valid in the applicable lottery system.

In a ninth embodiment of the invention, an instant-winner lottery game system and method involving: a central computer programmed to communicate via an intranet, the world-wide web and/or any remote communication means; a plurality of lottery retail interface terminals located at one location or a plurality of spaced-apart locations, said plurality of lottery retail interface terminals comprising: (1) a means capable of entering into a communication interface with (i) said central computer and/or (ii) a device providing information to and/or from said central computer; (2) a means capable of storing and/or processing information provided from said central computer; and (3) a means capable of communicating and providing said information to mobile computing devices; one or a plurality of mobile computing devices capable of downloading an applicable lottery gaming application and entering into a network to communicate with said central computer; whereby, a player can select said games from a display of one or a plurality of games on a mobile computing device using the lottery gaming application; whereupon, an identifying code is provided from the system for such selection that can be used to process the purchase transaction at an applicable lottery retail interface terminal and point-of-sale device; whereupon a player purchases said games via point-of-sale devices separate from or integrated with said lottery retail interface terminals; whereupon the player provides a mobile computing device with an applicable application so that the information and/or codes relating to the selected game(s) can be communicated from said lottery retail interface terminals to said mobile computing device upon or after purchase for the display and processing of one or a plurality of said lottery games and/or a feature(s) of said games on said mobile computing device; whereupon, any winnings from the game played can be redeemed by confirmation that the unique identifying code included in the said information communicated to the mobile device was one as being valid in the applicable lottery system.

In a tenth embodiment of the invention, an instant-winner lottery game system and method involving: a central computer programmed to communicate via an intranet, the world-wide web and/or any remote communication means; a plurality of lottery retail interface terminals located at one location or a plurality of spaced-apart locations, said plurality of lottery retail interface terminals comprising: (1) a means capable of entering into a communication interface with (i) said central computer and/or (ii) a device providing information to and/or from said central computer; (2) a means capable of storing and/or processing information provided from said central computer; and (3) a means capable of communicating and providing said information to mobile computing devices; one or a plurality of mobile computing devices capable of downloading an applicable lottery gaming application and entering into a network to communicate with said central computer; whereby, a player can select said games from a display of one or a plurality of games on a mobile computing device using the lottery gaming application; whereupon, an identifying code is provided from the system for such selection that can be used to process the purchase transaction at an applicable lottery retail interface terminal and point-of-sale device; whereupon a player purchases said games via point-of-sale devices separate from or integrated with said lottery retail interface terminals; whereupon, the player provides a mobile computing device with an applicable application so that the information and/or codes relating to the selected game(s) can be communicated from the central computer to the mobile computing device upon or after purchase to complete the display and processing of one or a plurality of said lottery games and/or a feature(s) of said games on said mobile computing device; whereupon, any winnings from the game played can be redeemed by confirmation that the unique identifying code included in the said information communicated to the mobile device was one as being valid in the applicable lottery system.

In an eleventh embodiment of the invention, an instant-winner lottery game system and method involving: a central computer programmed to communicate via an intranet, the world-wide web and/or any remote communication means; a plurality of point-of-sale devices capable of processing identifying codes relating to said lottery game system and located at one location or a plurality of spaced-apart locations; one or a plurality of mobile computing devices capable of downloading an applicable lottery gaming application and entering into a network to communicate with said central computer; whereupon, a player purchases said games by providing said code and a payment means to said point-of-sale devices; whereby, a player can select digital instant-winner lottery games from a display of one or a plurality of said games on a mobile computing device using said application and be provided an identifying code relating to such selection; whereupon, a player purchases said games by providing said code and a payment means to said point-of-sale devices; whereupon, said point-of-sale devices communicate an identifying code relating to such purchase to either:
said central computer, which confirms said purchase as one that is valid in the lottery system; or
said player, who inputs, or allows another person to input, said code into a mobile computing device and/or any internet compatible computing device, which communicates such code to said central computer via an applicable application to confirm said purchase as one that is valid in the lottery system; or
said mobile computing device, which communicates said code to said central computer via an applicable application to confirm said purchase as one that is valid in the lottery system;
whereupon, said central computer provides information to said application on the mobile computing device to complete the display and processing of one or a plurality of said lottery games and/or a feature(s) of said games on said mobile computing device.

In a twelfth embodiment of the invention, an instant-winner lottery game system and method involving: a central computer programmed to communicate predetermined and/or non-predetermined digital instant-winner lottery games via an intranet, the world-wide web and/or any remote communication means; a plurality of mobile computing devices capable of downloading an applicable lottery gaming application and entering into a network to communicate with the central computer; whereby, a player can select said games from a display of one or a plurality of games on a mobile computing device using the lottery gaming application; whereupon, a player purchases said games by using any approved applicable regulatory means (e.g. credit or debit card, gift card, rewards points, promotional offerings, crypto currency, digital wallet and/or any cloud, web-based, or other payment application); whereupon, the central computer communicates play data to said application on the mobile computing device to complete the display and processing of one or a plurality of said lottery games, and, optionally, coordinates internally and/or with other computer servers/networks the communication of non-play data to and/or from said mobile computing devices; whereupon, any winnings from the game played can be redeemed by confirmation that the unique identifying code included in the said information communicated to the mobile device was one as being valid in the applicable lottery system.

In an optional embodiment, the application on said mobile computing device communicates the identifying data and/or code relating to the selected game with the central computer, which confirms such game as one being valid in the applicable lottery system and provides or retrieves certain other play and/or non-play related data, such as, non-predesignated jackpots, progressive jackpots, advertising, promotions, email addresses, second chance play, player rewards, player tracking, game analytics, lottery game management, and other similar type data.

In another optional embodiment, the display of the play data and/or non-play data can be shown immediately on said mobile computing device after communication from said computer terminal even if further play or non-play data is in process of being communicated from said central computer to said mobile computing device.

In another optional embodiment, the lottery retail interface terminals can be operated by an attendant who receives payment for the purchase of said game(s) from players and uses either: a separate point of sale device(s) to complete said purchase and manually activates a device on the lottery retail interface terminal to authorize communication of the selected game(s) to a mobile computing device; or, an integrated point of sale device with the lottery retail interface terminal so that once such point of sale device completes said purchase it automatically communicates confirmation of said purchase with the lottery retail interface terminal; whereupon the lottery retail interface terminal is enabled to communicate the information relating to the selected game(s) to a mobile computing device.

Alternatively, in another embodiment the lottery retail interface terminals can be self-service, whereby the player selects said games from said display, purchases the selected game(s) via an integrated payment means, including a bill acceptor, a credit/debit card reader, and/or other scanner, and, upon confirmation of said purchase from said lottery retail interface terminal, receives communication of the information related to the selected game(s) directly from said lottery retail interface terminal to a mobile computing device.

Another optional embodiment enables gift cards, reward points and other promotional rewards to be used for the purchase of said games, and/or, lottery retail interface terminals or point of sale devices to be programmed to accept digital payments, such as from a digital wallet or other cloud, web-based, or other payment application.

In another optional embodiment, the lottery game system or particular lottery game provides advertising, or advertisers' images, or promotional offerings, including merchandise promotions, or cross-marketing coupons or other visual messages offering values or discounts for purchase before, during or after the display of said lottery game(s). Optionally, the lottery game system or particular instant-winner lottery game provides within or around the visually displayed game play, advertising or advertiser's images, or other promotional offerings that can be shown randomly, in a pre-set pattern, or at will, based on one or more factors related to the game play, such factors include: time elements; stages of the game; winning or losing; the occurrence of certain events; the demographics of the location or player; and, the presentation of certain numbers, letters, symbols, caricatures, game pieces, or other images.

In another optional embodiment, the lottery game system enables the coordination of the communication of promotions and advertising from the central computer, or one or a plurality of databases, or from one or a plurality of external advertising or similar networks to said lottery retail interface terminals or mobile computing devices.

In another optional embodiment, at least one of said lottery games includes an extended view feature in which the algorithms of a lottery game system or particular lottery game are designed to provide for the insertion of game stages (multi-stage games, extended games, bonus games, second chance play, or similar) that prolong the visual presentation of the game results over an extended length of time in order to provide a media better adaptable for greater entertainment or promotions and advertising, or other game and non-game features. Optionally, with or without the extended view feature, the system provides free play, extended play, second chance play, bonus games, or other similar type games.

In another optional embodiment, the lottery game system is programmed to provide for a player rewards or similar program, whereby selected play is monitored and some type of incentive rewards are provided to a player and/or to the selected application on the mobile computing device.

In another optional embodiment, the lottery game system includes programming to provide for a player or game performance tracking system, whereby selected play and game performance is monitored.

In another optional embodiment, the lottery game system or lottery games are enabled to enhance game play by providing win algorithms that allow for the extension of the visual display of entertaining features to those players with initial losing or winning outcomes by the insertion of free play, bonus games, bonus awards, extended play features, second chance play, or other incentives.

In another optional embodiment, the lottery game system or lottery games are enabled to enhance game play by providing games that include a combination of an entertainment game and a lottery game, where the combination provides an entertainment game that retains the playability and fun of a game of chance or skill while allowing for a lottery game to still be played and jackpots still to be won before, during or after the entertainment game.

In another optional embodiment, the lottery game system or lottery games are enabled to enhance game play by providing games programmed with personality whereby such programming would have stored audio or visual animated characters that would be presented in response to certain factors occurring during the display of the particular lottery game.

In another optional embodiment, the central computer is programmed to conduct one or a plurality of said lottery games or game features with at least one fixed jackpot prize that is a non-predesignated jackpot to a particular game.

In another optional embodiment, the central computer is programmed to conduct one or a plurality of said lottery games or game features with at least one progressive jackpot prize that incrementally increases in some predetermined manner as the particular game or game feature is played until won.

In another optional embodiment, the lottery game system or particular instant-winner lottery game is linked to other game play so that a feature of a game is affected in some manner by such other game play.

In another optional embodiment, the lottery game system is programmed to also provide interactive lottery games, whereby the player may interact with game play by having choices within the games and/or the game interacts in some linked manner with other game play.

In another optional embodiment, the lottery game system or lottery games are enabled to enhance game play by providing those players with winning outcomes with the chance to continue playing by trading in their winnings for a chance for a greater prize or using their winnings as credits to enter into a new game(s) until such credits are depleted.

In another optional embodiment, the non-play data includes advertising, promotions, email addresses, second chance play, player rewards, player tracking, game analytics, lottery game management, prizes and awards from game sponsors, and other similar type data not necessary for the determination of the outcome of the particular initial game.

In another optional embodiment, at least one of the fixed jackpot prizes is replenished after being won so that said fixed jackpot prize can be won again by additional play in said game and/or is determined randomly or in some other methodological fashion that does not pre-designate prior to purchase which particular selected game it will apply and be won.

In another optional embodiment, one or a plurality of shadow progressive jackpots are developed in the system while a progressive jackpot game is conducted until said game is won, wherein one of the shadow progressive jackpots is then used to replace the progressive jackpot that was won.

In another optional embodiment, the lottery retail interface terminals and/or mobile computing devices are located in a plurality of locations within a wide area selected from a subdivision of a whole city, state or one or more countries.

It is intended that each of the above embodiments may be mixed and matched together or separately to create additional embodiments of variations to the above inventions.

In accordance with the foregoing, it is an object of the invention to provide a commercially feasible instant-winner lottery game system and method in which players can purchase digital lottery games at physical point-of-sale locations, rather than, or in addition to, paper-based instant-winner lottery tickets at such locations.

An additional object of this invention is to provide a system and method that allows the information for digital lottery games to be provided to lottery retail interface terminals (lottery retail interface terminals refer to both attendant-assisted and self-service) at any authorized location so that players can select and purchase the digital games at point-of-sale locations and receive the applicable digital information on their mobile computing devices (Smart Devices) from those terminals once purchased.

An additional object of this invention is to provide a system and method that provides information for predetermined digital lottery games to lottery retail interface terminals at any authorized point-of-sale location prior to a player's purchase so that such terminals have no need to communicate with the central lottery computer upon purchase of a game by a player, thus, eliminating the need for real-time communication with the central computer, thereby reducing communication risks.

An additional object of this invention is to provide a system and method that provides for the communication of information for any type of digital lottery game, both or either predetermined and non-predetermined, from the lottery retail interface terminals to a player's Smart Device so that players can receive the play data without the need for the Smart Device to communicate with the central lottery computer for further play data, thus eliminating the need for real-time communication between the Smart Device and the central computer, thereby reducing communication risks.

An additional object of this invention is to provide an attendant-assisted lottery retail interface terminal that can provide for the display and sale of the digital lottery games and communication of those games to players' Smart Devices. The attendant-assisted lottery retail interface terminal would provide for payment means through separate attendant-operated point-of-sale devices.

An additional object of this invention is to provide an attendant-assisted lottery retail interface terminal integrated with existing point-of-sale devices. Such a terminal would provide for the display and sale of the digital lottery games, and the attendant would still provide for payment means through separate attendant-operated point-of-sale devices, but the sale of the digital games could be automated through those existing point-of-sale devices.

An additional object of this invention is to provide self-service lottery retail interface terminals that can provide for the display and sale of the digital lottery games along with an integrated self-service payment means so that upon purchase the data for the games selected can be communicated to players' Smart Devices. This self-service lottery retail interface terminal could be a stand-alone vending machine or incorporated with new and/or existing multi-purpose vending machines, which could optionally sell paper-based instant-winner lottery tickets, digital instant-winner lottery games, lotto type games and/or other lottery games all in one machine.

An additional object of this invention is to provide self-service lottery retail interface terminals that can provide for the display and sale of the digital lottery games along with an integrated self-service payment means and/or clerk-assisted lottery retail interface terminals previously described so that upon purchase a transaction code is communicated to the players or the players' Smart Devices. Once the code is communicated to the Smart Devices, an application communicates such code to a lottery central computer, which then provides the data for the applicable lottery games, including one or more of the enhanced features described herein, such as advertising, progressive jackpots, second chance and bonus play, player rewards, player tracking, etc., to the players' Smart Devices. The self-service lottery retail interface terminal could be a stand-alone vending machine or incorporated with new and/or existing multi-purpose vending machines, which could optionally sell paper-based instant-winner lottery tickets, digital instant-winner lottery games, lotto type games and/or other lottery games all in one machine.

An additional object of this invention is to provide a lottery retail interface terminal that can enable the purchase of digital lottery games, with the display and selection of such games being optional at such device. Under this objective, the display and selection of such games could be available at the lottery retail interface terminal and/or on another device, such as the player's Smart Device, personal computer, or other device. The lottery retail interface terminals under this objective could be a separate device or the point-of-sale devices already deployed at retail locations, in which case the point-of-sale devices could be programmed to communicate a code to the player, the player's Smart Device, or to a program that could communicate such code to the central lottery computer to confirm purchase.

It is an additional object of this invention to eliminate the need for separate lottery retail interface terminals. Under this objective, point-of-sale devices could be used as the means to purchase and confirm lottery game purchases, and the player could select the game from a display on their Smart Device, personal computer, and/or at the point-of-sale device and purchase the game at the point-of-sale device, which could communicate an identification code of the game/transaction to either: the central lottery computer; the player; or, Smart Device, so that the central computer could validate the transaction and provide the game information to the player's Smart Device.

An additional object of this invention is to create equipment that may be necessary to be relatively compact, and inexpensive to manufacture and operate.

An additional object of this invention is to provide a system adaptable to the acceptance of gift cards, reward points or other promotional rewards for the purchase of the digital lottery games.

An additional object of this invention is to provide a system adaptable to the acceptance of digital payments, such as from crypto-currency, a digital wallet and/or other cloud, web-based, or other payment applications.

An additional object of this invention is to provide a contactless retail system, whereby the player can, upon selecting a game, scan a code from a lottery retail interface terminal using a downloaded application on their Smart Device, then pay using a digital wallet and/or cloud, web-based, or other payment application, then receive onto their Smart Device the applicable digital information directly from the lottery retail interface terminal and/or central computer. Alternatively, the player could choose the games from a display on such application, then receive a code from the application on their Smart Device directly from the central computer and purchase such games through the lottery retail interface terminal and/or retail point-of-sale device using a contact-less process, such as a digital wallet and/or other cloud, web-based, or other payment applications (although any approved regulatory payment means could be used).

An additional object of this invention is to provide a retail-free version, whereby the player could by using a downloaded application on their Smart Device choose the games from a display on such application, then pay using an approved regulatory payment means, which could be a credit or debit card, gift card, rewards points, player credits, promotional offerings, crypto currency, digital wallet and/or any cloud, web-based, or other payment application, then receive onto their Smart Device the applicable digital information for the games and, optionally, non-play data, directly from the central computer.

An additional object of this invention is to provide all types of jackpot games, including progressive jackpot games and/or other types of games, which can be linked in various ways, including being linked to an entire retail chain, and/or to locations throughout an entire city or state, multiple states, or multiple countries.

An additional object of this invention is to provide a system and method that allows fixed jackpots from the digital lottery games to be reset after being won to eliminate the problem of stale inventory.

An additional object of this invention is to provide a system and method and/or games in which the games can be geographically and/or demographically oriented, which can be created as a result of having information received from the player and/or the player's Smart Device.

It is a further object of this invention to provide a system and method adaptable to presenting advertising and promotional features within the lottery system and/or within the lottery games. Multiple embodiments of this objective include different systems to communicate the advertising, different methods of displaying the advertising, and integrating the advertising within the game play itself.

It is a further object of this invention to provide a system and method programmed to conduct a feature that provides game play insertions using algorithms that allow “extended view” games to be played to provide a player multiple and continuous chances of winning a prize to lengthen the time a player views the game results in order to enhance the ability to generate more advertising revenue and/or entertaining game play.

It is a further object of this invention to provide player rewards programs from this system. Such programs would be made possible in part due to the additional data the system could receive from the use of players' Smart Devices and the communication of the games played from those devices.

It is a further object of this invention to provide a system and method that can provide extended and second chance play, bonus games, free games, and other related features for the digital lottery games. All the enhanced features, such as progressive jackpots, advertising, rewards and others, could be made available for these additional extended games.

It is a further object of this invention to provide a method of processing players' lottery playing activity to analyze player behavior, including tracking play, winnings, type of games, time played, and the type and location of a players' personal mobile device. This data can be used for targeting the genre of games to a player, targeting advertising and promotions to a player, targeting bonus play type games to a player, targeting free play type games to a player, and providing rewards programs to a player, as well as other features.

It is a further object of this invention to provide a system and method that creates at least one embodiment that provides information for predetermined and/or non-predetermined digital lottery games to lottery retail interface terminals at any authorized point-of-sale location prior to a player's purchase so that such terminals do not need to communicate to the central lottery computer upon purchase of a game by a player, thus, eliminating the need for real-time communication with the central computer at time of purchase, but providing for the option to have communication from the Smart Devices to the central computer of some of the play data and/or non-play data, such as, but not limited to, free games, extended play, second chance play, advertising, rewards programs, and player tracking and game monitoring.

It is a further object of this invention to provide a system and method that creates at least one embodiment that provides information for predetermined and/or non-predetermined digital lottery games to lottery retail interface terminals at any authorized point-of-sale location upon confirmation of purchase and then communicates such information relating to the selected games from the terminals to players' Smart Devices, so no further communication is needed from the Smart Devices to the central computer for the initial game play data.

It is a further object of this invention to provide a system and method that creates at least one embodiment that provides information for predetermined and/or non-predetermined digital lottery games to lottery retail interface terminals at any point-of-sale location upon confirmation of purchase and then communicates such information relating to the selected games from the terminals to players' Smart Devices, so no further communication is needed from the Smart Devices to the central computer for the initial game play data, but communication may be provided for additional features of play and non-play data, such as, but not limited to, free games, extended play, second chance play, progressive jackpots, advertising, rewards programs, and player tracking and game monitoring.

It is a further object of this invention to provide a system and method that creates at least one embodiment that provides information for predetermined and/or non-predetermined digital lottery games to lottery retail interface terminals at any authorized point-of-sale location upon confirmation of purchase and then communicates both play and non-play data relating to the selected games from the terminals to players' Smart Devices and/or from the central computer to players' Smart Devices, so the lottery may have the flexibility to choose the method they deem best for them under the circumstances.

It is a further object of this invention to provide a system and method that creates at least one embodiment that provides information for predetermined and/or non-predetermined digital lottery games to lottery retail interface terminals at any authorized point-of-sale location upon confirmation of purchase and then communicates both play and, optionally non-play data, that includes non-predesignated fixed jackpots and/or progressive jackpots relating to the selected games from either the terminals to players' Smart Devices and/or from the central computer to players' Smart Devices, so the lottery may have the flexibility to choose the method they deem best for them under the circumstances.

It is a further object of this invention to provide a system and method that creates at least one embodiment that provides identifying codes for predetermined and/or non-predetermined digital lottery games to lottery retail interface terminals at any authorized point-of-sale location before purchase and/or upon confirmation of purchase, which are then communicated to a player's Smart Device, whereupon the central computer communicates both play and non-play data relating to the selected games to players' Smart Devices.

It is a further object of this invention to provide a system and method that creates at least one embodiment that provides identifying codes for predetermined and/or non-predetermined digital lottery games to lottery retail interface terminals at any authorized point-of-sale location before purchase and/or upon confirmation of purchase, which are then communicated to a player's Smart Device, whereupon the central computer communicates play data that includes non-predesignated fixed jackpots and/or progressive jackpots relating to the selected games and, optionally, non-play data to players' Smart Devices.

It is a further object of this invention to provide digital lottery games with multi-level chances of winning, such levels including free play, bonus games, tiered play, and any element that provides the player a chance to play again or play another game.

It is a further object of this invention to provide a system and method that can provide different communications methods to best effectuate the novel features described in the above-mentioned objectives.

It is a further object of this invention to provide a system and/or games that can enhance game play by modifying game win algorithms to extend the visual display of entertaining features to those players with initial losing outcomes by the insertion of free play, bonus games, awards, extended play features, second chance play, and/or other incentives.

It is a further object of this invention to provide a system and/or games that can enhance game play by allowing players to trade-in a jackpot or winning situation for a chance to win an even more valuable jackpot. The chance for a more valuable jackpot may be a an extended play game, bonus game or chance to win an extended play or bonus game, or higher jackpot prize, including a progressive jackpot. The bonus jackpots could be funded by the savings achieved from the players trading in their jackpots that would have otherwise been paid.

It is a further object of this invention to provide a system and/or games that can enhance game play by providing game(s) that includes a combination of an entertainment game and a lottery game. The objective of this game combination is to provide an entertainment game that retains the playability and fun of a skill game or other non-traditional lottery game while allowing for a lottery game to still be played and jackpots to still be won.

It is a further object of this invention to provide a system and/or games in which particular lottery games have voice and/or audio character. The objective is to provide audio-visual animated characters in response to elements within the display of a particular lottery game on a Smart Device.

It is a further object of this invention to provide a system and method wherein the central computer, lottery retail interface terminals and mobile software applications can be programmed to network and interface as needed to accumulate, format, and process information required by applicable government agencies and provide applicable forms and/or reports in a cost effective and timely manner.

It is a further object of this invention to provide a system and method wherein the gambling activities of a player can be communicated and processed with social media, such as Facebook, Twitter, TikTok, Instagram, YouTube, Whatsapp, etc, whereby information regarding winning, losing, types of games, location, and other characteristics can be shared and processed and information regarding the player on social media can be retrieved and processed to trigger promotional and social activities.

It is a further object of this invention to provide different embodiments of combinations of the various objectives.

It is a further object of this invention to have the “central” computer or computers be the “cloud” instead of a separate computer arrangement. In fact, the “central” computer can be the entire lottery system and/or a distributed computer system with multiple servers, and need not be located in a single location.

### BRIEF DESCRIPTION OF THE DRAWINGS

The invention directed by way of example, and not by way of limitation, in the figures of the accompanying drawings and in which like reference numerals refer to similar elements and in which:

FIG. 1A is a flow diagram illustrating an Instant Game Network Integrated Technology Enhancement (IGNITE™) Protocol for a lottery to assist in determining the technological architecture for an initial system and methodology to be used for the sale, distribution, and processing of instant-winner lottery games and related features in accordance with an embodiment of the invention;

FIG. 1B is a flow diagram illustrating an Instant Game Network Integrated Technology Enhancement (IGNITE™) Protocol for a lottery to assist in determining the technological architecture for an initial system and methodology to be used for the sale, distribution, and processing of instant-winner lottery games and related features in accordance with an embodiment of the invention;

FIG. 2A is a block diagram showing a system for IGNITE™ 1-1 in accordance with an embodiment of the invention;

FIG. 2B is a block diagram showing a system for IGNITE™ 1-2 in accordance with an embodiment of the invention;

FIG. 2C is a block diagram showing a system for IGNITE™ 1-3 in accordance with an embodiment of invention;

FIG. 3A is a block diagram showing a system for IGNITE™ 2-1 in accordance with an embodiment of invention;

FIG. 3B is a block diagram showing a system for IGNITE™ 2-2 in accordance with an embodiment of the invention;

FIG. 4 is a block diagram showing a system for IGNITE™ 3-1 in accordance with an embodiment of the invention;

FIG. 5 is a block diagram showing a system for IGNITE™ 3-2 in accordance with an embodiment of the invention;

FIG. 6 is a block diagram showing one of the IGNITE™ 4 systems and methods that provide for the display of lottery games on a mobile computing device (user device), the selection of such games by a customer, the purchase of such games at a POS device, and the communication of information relating to the games purchased from the central computer to the user device in accordance with an embodiment of the invention;

FIG. 7 shows the different configurations in which the lottery retail interface terminals could communicate with the central computer in accordance with an embodiment of the invention;

FIG. 8 shows the different configurations in which communication could be achieved between the lottery retail interface terminal and the Smart Device in accordance with an embodiment of the invention;

FIG. 9 is a block diagram showing interaction between a user device, a lottery retail interface terminal and a central computer in accordance with an embodiment of the invention;

FIG. 10A is a block diagram showing a clerk-assisted lottery retail interface terminal system with interaction with a customer and a user device in accordance with an embodiment of the invention;

FIG. 10B is a block diagram showing a clerk-assisted lottery retail interface terminal system with an integrated payment means to the point of sale device with interaction with a customer and a user device in accordance with different embodiment of the invention;

FIG. 11 is a block diagram showing a self-service lottery retail interface terminal system with interaction with a customer and a user device in accordance with an embodiment of the invention;

FIG. 12 is a block diagram showing various payment means for a lottery retail interface terminal in accordance with an embodiment of the invention;

FIG. 13A is a block diagram illustrating promotions or advertisement in or/around the game play area in accordance with an embodiment of the invention;

FIG. 13B shows representations of a lottery game display with promotions or advertisement around the game play area in accordance with an embodiment of the invention;

FIG. 13C illustrates the beginning of an instant-winner lottery game called “Instant Mega Jackpot Game,” by way of showing how advertisers could be shown as sponsors of the game by inserting names into the beginning of the game and game instructions;

FIG. 13D shows the beginning of the instant-winner lottery game, with “white spheres” numbered on the left side, and “multiplier spheres” shown on the right side, with the instructions listed underneath along with a prize schedule;

FIG. 13E shows the progression of the game, with all the circles representing the player's picks for the white spheres and multiplier spheres by way of an example of how advertising can be shown in and around the game play and inserted into the game play;

FIG. 13F shows further progression of the game, with animation of how the game is choosing the winning spheres;

FIG. 13G illustrates the progression of the game to conclusion, where all the winning numbers of white spheres have been popped out and where all the winning multiplier spheres have been shot out;

FIG. 14 is a block diagram showing how extended view features can be integrated in a lottery game in accordance with embodiments of the invention;

FIG. 15 is a block diagram showing player reward, player tracking, and other monitoring programs in accordance with embodiments of the invention; and

FIG. 16 is a block diagram showing interactions of players, lottery retail interface terminals, user devices, and central computers in different jurisdictions in accordance with embodiments of the invention.

Unless otherwise indicated illustrations in the figures are not necessarily drawn to scale.

### DETAILED DESCRIPTION OF THE PREFERRED EMBODIMENTS

Terminology used herein is used for the purpose of describing particular embodiments only, and is not intended to limit the scope of the present invention. It must be understood that as used herein and in the appended claims, the singular forms “a,” “an,” and “the” include the plural reference unless the context clearly dictates otherwise. For example, a reference to “an element” is a reference to one or more elements and includes all equivalents known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Language that may be construed to express approximation should be so understood unless the context clearly dictates otherwise.

Unless defined otherwise, all technical and scientific terms used herein have the same meanings as commonly understood by a person of ordinary skill in the art to which this invention belongs. Preferred methods, techniques, devices, and materials are described. But any methods, techniques, devices, or materials similar or equivalent to those described herein may be used in the practice or testing of the invention. Structures described herein should also be understood to refer to functional equivalents of such structures.

References to “one embodiment,” “one variant,” “an embodiment,” “a variant,” “various embodiments,” “numerous variants,” etc., may indicate that the embodiment(s) of the invention so described may include particular features, structures, or characteristics. However, not every embodiment or variant necessarily includes the particular features, structures, or characteristics. Further, repeated use of the phrase “in one embodiment,” or “in an exemplary embodiment,” or “a variant,” or “another variant” do not necessarily refer to the same embodiment although they may. A description of an embodiment with several components in communication with each other does not imply that all such components are required. On the contrary, a variety of optional components are described to illustrate the wide variety of possible embodiments and/or variants of the invention.

“Predetermined digital instant-winner lottery games” mean lottery games in which the outcome for the games have been pre-determined prior to purchase so that the simulation of play is an unfolding of predetermined results, although the player is not aware of the outcome or prize, if any, at time of purchase.

“Non-predetermined digital instant-winner lottery games” mean lottery games in which one or more of the outcomes have not been predetermined prior to purchase so that the determination of a prize, if any, occurs upon or after purchase of the game.

“Non-predesignated jackpot” means a jackpot that has not been predetermined as to which game it will be won.

“Central computer” means; a type of computer architecture where all or most of the processing/computing is performed on a central server or a host of inter-connected network of servers; the internet cloud; and/or an entire lottery system.

“Smart Device” means any internet capable mobile computing device, such as, but not limited to, smart phones, tablets, laptop computers, smart watches, e-readers, handheld gaming consoles, personal digital assistants, netbooks, ultra-mobile personal computers, pocket mobile personal computers, and other mobile internet capable computer devices.

“Play data” means data relating to the digital display of a simulation of a lottery game.

“Non-play data” means all other data not necessary to display a digital simulation of a particular lottery game, although it could be included in such game, including, but not limited to, advertising, promotions, player rewards programs, player tracking, administration, game management, game analytics, game enhancement features, messages, and anything else related to or provided in conjunction with the lottery games.

A “computer” may refer to one or more apparatus and/or one or more systems that are capable of accepting a structured input, processing the structured input according to prescribed rules, and producing results of the processing as output. Examples of a computer may include: a personal computer (PC); a stationary and/or portable computer; a computer having a single processor, a computer having multiple processors, or a computer having multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer; a personal digital assistant (PDA); a portable telephone; a portable smartphone; wearable devices such as smartwatches; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

The term “processor” may refer to any device or portion of a device that processes electronic data from registers and/or memory to transform that electronic data into other electronic data that may be stored in registers and/or memory. A “computing platform” may comprise one or more processors.

An “algorithm” is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

It will be readily understood by persons skilled in the art that the various methods and algorithms described herein may be implemented by appropriately programmed computers, microcontrollers and computing devices. Typically, a processor (e.g., a microprocessor) will receive instructions from a memory or like device, and execute those instructions, thereby performing a process defined by those instructions. Further, programs that implement such methods and algorithms may be stored and transmitted using a variety of known media.

“Software” may refer to prescribed rules and/or instructions used to operate a computer. Non-limiting examples of software may include: Code segments in one or more computer-readable languages; graphical and or/textual instructions; applets; pre-compiled code; interpreted code; compiled code; and computer programs. An operating system or “OS” is software that manages computer hardware and software resources and provides common services for computer programs.

Certain embodiments described herein can be implemented in an operating environment comprising computer-executable instructions (e.g., software) installed on a computer, in hardware, or in a combination of software and hardware, such as on the lottery retail internet terminal. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object-oriented programming languages and/or conventional procedural programming languages, and/or programming languages or other compilers, assemblers, interpreters or other computer languages or platforms.

A “computer system,” such as the “central computer,” may refer to a system having one or more computers, where each computer may include a computer-readable medium employing software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a plurality of computers and associated devices that may be connected by communication channels to facilitate communication and resource sharing. A network may involve permanent connections such as cables or temporary connections such as those made through telephone, cable, wireless or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include, but are not limited to, an internet, such as the Internet or World Wide Web; an intranet; a personal area network (PAN); near field communication (NFC); a local area network (LAN); a wide area network (WAN); a virtual private network (VPN); internet of things (IoT); and a combination of networks, such as an internet and an intranet.

Aspects of the exemplary systems and methods for providing digital lottery games will be described below with reference to flowchart illustrations and/or block diagrams of methods, steps, apparatus (systems) and computer program products according to embodiments of the invention. Persons skilled in the art will understand that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, microcontroller, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods, and computer program products according to various embodiments of the exemplary systems and methods for providing digital lottery games. It will become readily apparent to persons skilled in the art that each block in the flowchart or block diagrams may represent a module, segment, or portion of code, which comprises one or more executable instructions for implementing the specified logical function(s). It will also be readily apparent to persons skilled in the art that in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any practical order.

It will also be understood by persons skilled in the art that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

It will be readily understood by persons skilled in the art that the various methods and algorithms described herein may be implemented by appropriately programmed computers and computing devices. Typically, a processor (e.g., a microprocessor) will receive instructions from a memory or like device, and execute those instructions, thereby performing a process defined by those instructions. Further, programs that implement such methods and algorithms may be stored and transmitted using a variety of known media.

As is well known to those skilled in the art, many careful considerations and compromises typically must be made when designing the optimal manufacture or commercial implementation of such systems and methods for providing digital lottery games. A commercial implementation in accordance with the spirit and teachings of the invention may be configured according to the needs of the particular application, whereby any aspect(s), feature(s), function(s), result(s), component(s), approach(es), or step(s) of the teachings related to any described embodiment of the invention may be suitably omitted, included, adapted, mixed and matched, or improved and/or optimized by those skilled in the art.

The exemplary systems and methods for providing digital lottery games will now be described in detail with reference to embodiments thereof as illustrated in the accompanying drawings. Unless otherwise indicated illustrations in the figures are not necessarily drawn to scale.

Although the present disclosures have been described at times in terms of certain preferred features, other features of the disclosures including variations in applications, embodiments, configurations and technology will be apparent to those of skill in the art in view of the disclosures herein. In addition, all features detailed in connection with any one embodiment herein can be readily adapted for use in other embodiments herein. The use of different terms or references for similar features in different embodiments does not imply differences other than those which may be expressly set forth. Accordingly, the present disclosures are intended to be descriptive solely by reference to the claims, and not limited to the preferred embodiments disclosed herein.

The invention involves encompassing systems and methodologies that can transform the current lottery industry practice of using paper-based instant-winner lottery tickets as their primary method of selling instant-winner lottery games in point of sale locations to one that is or includes a digital-based system. The transformation process is not focused solely on technology, but on the integration of technology with novel methodologies for providing compelling features that can provide for the economic feasibility to implement such technology as a result of the creation of never-before implemented game and revenue enhancements for instant-winner lottery games sold at point-of-sale retail locations.

### Instant Game Network Integrated Technology Enhancement Protocol

An embodiment of this invention is the Instant Game Network Integrated Technology Enhancement (the “IGNITE™”) systems and methods.

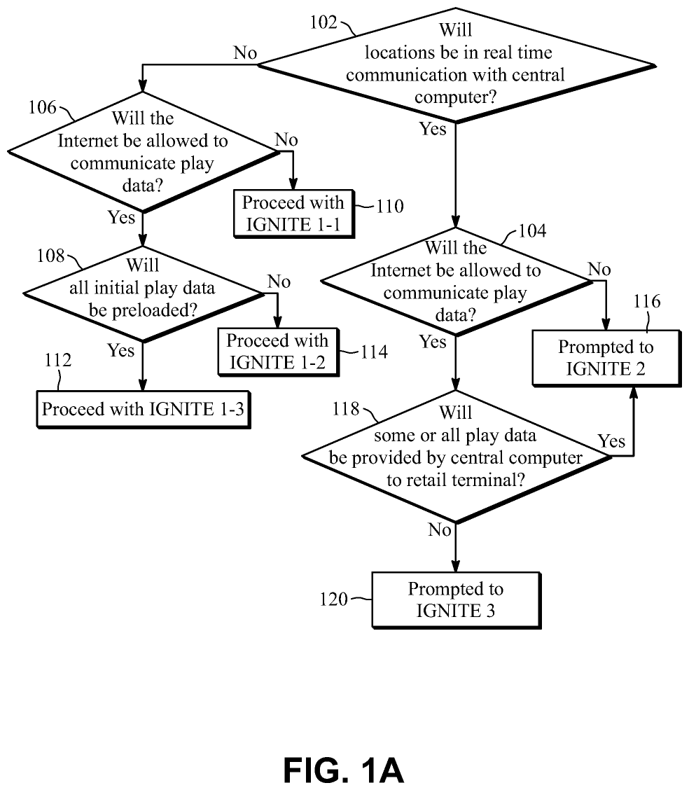

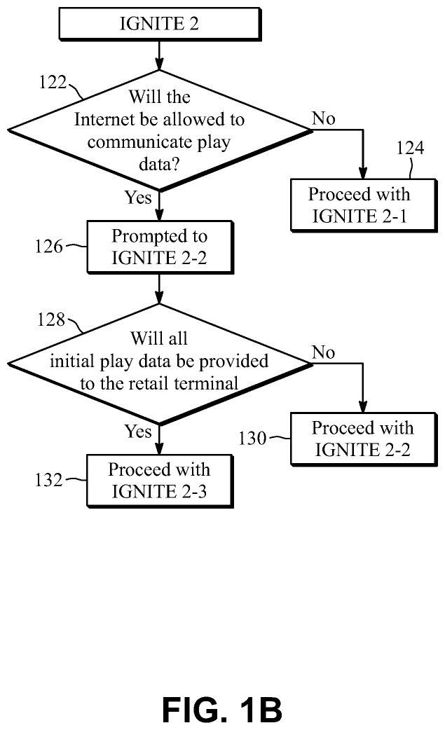

FIGS. 1A and 1B are flow diagrams illustrating an IGNITE™ protocol of this system to assist a lottery in determining an initial system and methodology to be used for the sale, distribution, and processing of instant winner lottery games in accordance with an embodiment of the invention.

First, a Lottery is presented these questions: Does the Lottery use paper-based instant-winner lottery tickets? Does the Lottery want to reduce costs and problems associated with instant tickets? Does the Lottery want to increase its revenue? Does the Lottery want to appeal to a broader spectrum of players, including new generational players? Does the Lottery want to provide greater incentives to players? And, does the Lottery want a more efficient and effective instant-winner game management system?

If the answer is yes to any of the questions, the Lottery is prompted to proceed with IGNITE™ 1 questions. In the first step 102, the Lottery is prompted with the question: Will locations have communication with the central computer at time of purchase from players? If yes, the lottery has the option to proceed with IGNITE™ 2 and 3 system architectures. If no, they are prompted to continue with IGNITE™ 1 system architecture.

As shown in FIG. 1A, continuing with IGNITE™ 1, under step 106, they are asked, do Lottery regulations permit and does the Lottery want the use of the internet to deliver any game play data? If no, they are prompted to proceed with IGNITE™ 1-1 system architecture (all play data and, optionally, non-play data, is preloaded prior to purchase at lottery retail interface terminals and, optionally, non-play data can be communicated to Smart Devices after purchase) (step 110). If yes, they are asked, does the Lottery require all game play data for an “initial” lottery game to be pre-loaded prior to purchase? (step 108). An “initial” preloaded game means the data for an element, phase, tier or some other feature of the game is preloaded and can be played to completion, but other add-on elements, phases, tiers, or other features may continue or be added thereafter. If yes, they are prompted to proceed with IGNITE™ 1-3 system architecture (all of the play data and/or identification codes for at least one initial feature of a lottery game and, optionally non-play data, can be preloaded prior to purchase at lottery retail interface terminals and the remaining play data for other lottery games and/or add-on elements, phases, tiers or other features and, optionally, non-play data can be communicated to Smart Devices after purchase) (step 112). If no, they are prompted to proceed with IGNITE™ 1-2 system architecture (play data and, optionally, non-play data, can be fully or partially loaded, or not loaded at all and only identifying codes loaded, to lottery retail interface terminals prior to purchase and the remaining play data and, optionally, non-play data can be communicated to Smart Devices after purchase) (step 114).

Under IGNITE™ 2 and 3 system architecture paths (step 104), the question is asked: Do the Lottery regulations permit and does the Lottery want the use of the internet to provide play data after purchase? If no, they are prompted to proceed to IGNITE™ 2 system architecture questions. (step 116). If yes, they are asked, does the Lottery require all or some game play data for an initial lottery game to be loaded at time of purchase? (step 118). If yes, they are prompted to proceed with IGNITE™ 2 system architecture questions. If no, they are prompted to proceed with IGNITE™ 3 system architecture (only identifying codes and optionally non-play data, but no play data, is communicated from the central computer to the lottery retail interface terminals at time of purchase, all other data is communicated from the central computer to the Smart Devices) (step 120).

As shown in FIG. 1B, under the IGNITE™ 2 system architecture path, the question is asked, do Lottery regulations permit and does the Lottery want the use of the internet to deliver any game play data? (step 122). If no, they are prompted to proceed with IGNITE™ 2-1 system architecture (all play data and, optionally, non-play data is provided from the central computer to lottery retail interface terminals at time of purchase and optionally, non-play data after purchase) (step 124)

If yes, (step 126), they are asked, does the Lottery require all game play data for an “initial” lottery game to be communicated from the central computer to the lottery retail interface terminals upon purchase? (step 128) If no, they are prompted to proceed with IGNITE™ 2-2 system architecture (play data and, optionally, non-play data, can be fully or partially communicated at time of purchase from the central computer to lottery retail interface terminals, and the remaining play data and, optionally, non-play data, can be communicated to Smart Devices after purchase) (step 130).

If yes, they are prompted to proceed with IGNITE™ 2-3 system architecture (all of the play data for at least one initial feature of a lottery game and, optionally non-play data, can be communicated at time of purchase from the central computer to lottery retail interface terminals and the remaining play data for other lottery games and/or add-on features to an initial lottery game and, optionally, non-play data can be communicated to Smart Devices after purchase) (step 132).

Under IGNITE™ 3 system architecture, identifying codes, but no play data, are provided from the central computer to the lottery retail interface terminals upon purchase from the player, and then from the lottery retail interface terminal to the player's Smart Device, whereupon the lottery is given the option to provide from the central computer to the player's Smart Device the play data in conjunction with any one or all of the following: (i) non play data; (ii) one or more non-predesignated jackpots; (iii) one or more progressive jackpots; (iv) extended view games; (v) multiple play games (e.g. tiered levels of play, bonus games, free games, second chance play, and other similar extended play type games); and any other play and non play related features and enhancements.

Lotteries can also be provided the option to add IGNITE™ 4 system architecture to any of the other IGNITE™ configurations. IGNITE™ 4 is a system that can provide the Lottery with an optional virtually free-of-contact gaming experience for the player. Under this system, the applicable lottery App that can be downloaded onto a Smart Device is programmed to communicate with the central computer and display a list of instant-winner lottery games available under the system that can be purchased at a location(s) optionally shown on the App, whereupon the player can select a game, and be provided an identifying code, which can be used at the applicable point-of-sale location. The player could then visit a selected location and have the identifying code scanned from the Smart Device to the lottery retail interface terminal and/or the point-of-sale device for game selection and sale amount, whereupon the player can make payment via cash, debit, credit, player rewards, gift card, promotional feature, or digital payment. If through card or digital payment, the process can be virtually free-of-contact. Further embodiments of IGNITE 4 system architecture are described later herein. This IGNITE™ system streamlines the initial verification and processing at the point of sale location for quicker processing, and provides contact-less options for health consciousness and labor efficiencies.

Although a lottery may be prompted to higher-order IGNITE™ systems, those systems are always optional for lotteries, as they can always default back to use of the basic IGNITE™ 1 system even if their regulations allow more advanced systems. There are many political and social reasons lotteries may not want to advance a system, so the IGNITE™ 1 system can be used as a default setting. Further, nothing in the above decision tree protocols restrict the ability for the system to provide other configurations to adapt to a lottery jurisdiction's needs, procedures and regulations. For instance, non-play data may be provided to lottery retail interface terminals first rather than play data, and play data can be provided from the central computer to the Smart Devices. There can be many variations to these configurations to fit the needs of a particular lottery jurisdiction under the Invention's technological architecture.

As will be further explained herein, additional embodiments of this invention provide for play and non-play data applications, including new game designs, which are available to be integrated with the above systems and methods. These applications can be added to any of the above referenced configurations in varying degrees depending on the communication means with the central computer. For instance, non-play data can be provided before, during and/or after the processing of the play data, where allowed, via communication between the central computer and the lottery retail interface terminals and then to the Smart Devices, and/or from the central computer directly to the Smart Devices as enhancements. In embodiments of the invention, the additional applications comprise, but are not limited to: Multiple Terminal Configurations, Instant-Winner Games, Linked and Interactive Games, Non-Predesignated Fixed Jackpot Games, Geographically and/or Demographically Enhanced and/or Directed Lottery Games, Advertising and Promotions, Integrated Advertising as Part of Game Play, Extended Play Algorithms-Extended View Feature, Game Information Analyzer, Enhanced Game Features, Extended Game Play through Winnings, Administration, Marketing and Analytical Systems/Game Management, Player Rewards/Tracking Methods/Game Analytics, Player Involvement Component Game Enhancements, Extended play, Second chance play, Bonus play, Free play; Social Media; Other Non-Play and Play-Related Data and Enhancements.

### Instant Game Network Integrated Technology Enhancement Systems and Methods

As previously described, the current method used by lotteries for instant-winner lottery tickets is to have them pre-printed and batched, with all the game results predetermined, so that when a player purchases the ticket they can determine the outcome instantly. In line with that accepted industry practice, one embodiment of the invention provides a system architecture for digital lottery games that is conducted similarly, but solves the problems of pre-printing, paper costs, and administration, while allowing for dynamic new game features that will be described further herein. Although the system can use real-time communication, it can function without real-time communication and can be used at any point-of-sale location. Further, although the system can use internet communication, it can function without internet connection, thus allowing the lottery to choose the minimum level risk of data breach.

The IGNITE™ system is comprised of a central computer programmed to communicate via an intranet, the world-wide web and/or any remote communication means, with such central computer providing lottery games. Within that system, there are different configurations. Some configurations provide for lottery retail interface terminals to be placed at physical locations that are allowed to sell lottery games (e.g. retail locations-supermarkets, drug stores, convenience stores, shopping malls, etc.; and other heavy customer traffic locations-such as, airports, bus stops, bowling alleys, stadiums, subways, train stations, etc). Those lottery retail interface terminals are one of four types: (1) attendant-assisted with no connected payment means; (2) attendant-assisted with integrated payment means; (3) stand alone self-service with no attendant assistance needed; and (4) integrated multi-purpose self-service vending with no attendant assistance needed (a terminal that sells instant-winner lottery digital games as well as other lottery games, such as instant tickets and/or lotto number games).

The lottery retail interface terminals would have: a means capable of entering into a communication interface with said central computer and/or with a data device capable of interfacing with said central computer; a means capable of storing and/or processing digital instant-winner lottery game data and/or identifying codes provided from said central computer; a display of one or a plurality of instant-winner lottery games, displaying visual identification markings of said games to allow selection for purchase and/or, instead of or in conjunction with a display, a means capable of confirming purchase of the selection of said games; and a means capable of communicating and providing data to Smart Devices for the visual presentation of said games, as well as other optional functions common to computers.

The method involves the central computer providing information for the digital display of the simulation of instant-winner lottery games. Once deployed or established, the lottery retail interface terminals would receive communications from the central computer or from an intermediary device provided by a lottery/retailer representative as to the instant-winner lottery games available for sale at that particular terminal. The data from the central computer is communicated one of three ways to the lottery retail interface terminals (also sometimes referred to herein as Retail Terminals or computer terminals): (a) direct through real time connection (direct connection can be wireless-satellite, internet, etc; or wired); (b) direct through intermittent connection; and (c) indirect through an intermediary, such as a person(s) physically bringing the data from the central computer to the lottery retail interface terminals (such as with a mobile hand-held device or a storage device, e.g. a thumb drive), with such data being downloaded wirelessly or through physical connection, or by a separate interface, such as through a communication means of the retail location or local area communication means that may interface with another communication means.

Depending on the IGNITE™ technological configuration chosen by the lottery, the games could be batched, in much the same way they are done today in preset numbers and prizes based on established algorithms of the particular lottery game, and, if so, those batches could be provided to each lottery retail interface terminal in much the same way that batches of paper-based instant tickets are sent to retail locations today, except digitally rather than printed on paper. Alternatively, depending on the jurisdiction's lottery regulations, the games could be unbatched, so that an unlimited number of games in a particular genre and theme could be played, and fixed prizes could be reset automatically based on the established algorithms of the particular lottery game. The games would have the option to include a progressive jackpot feature that would allow for higher and more exciting jackpots to be won by players.

Another configuration would not need separate lottery retail interface terminals, but instead would integrate point-of-sale devices to enable them to accept identifying codes from mobile computing devices for the purchase of the lottery games. Once purchased, the point-of-sale devices could provide an identifying code that would be communicated directly or indirectly to the central computer so that the information relating to the games purchased could be communicated to the particular user device. This methodology and other similar configurations are further explained under the IGNITE™ 4 hybrid systems.

### IGNITE™ 1 Systems and Methods

Under the IGNITE™ 1 technological configuration, no information would be necessary to transmit between the lottery retail interface terminals and the central computer upon purchase by a player; therefore, at time of purchase of a game by a player, there would be no communication necessary between the lottery retail interface terminals and the central computer. All the unique identifying play data would either be transmitted prior to purchase (IGNITE™ 1-1 configuration) or some or all the unique identifying play data and/or codes could be transmitted prior to purchase, and the remaining data transmitted after purchase (IGNITE™ 1-2 and 1-3 configurations). The IGNITE™ 1 configuration allows a lottery to provide lottery retail interface terminals to any location without the necessity of real time communication with the central computer at time of purchase from a player. IGNITE™ 1-1 mirrors current lottery protocols, while IGNITE™ 1-2 and 1-3 can also follow similar protocols but with additional internet communication enhancements.

### IGNITE™ 1-1 System and Method

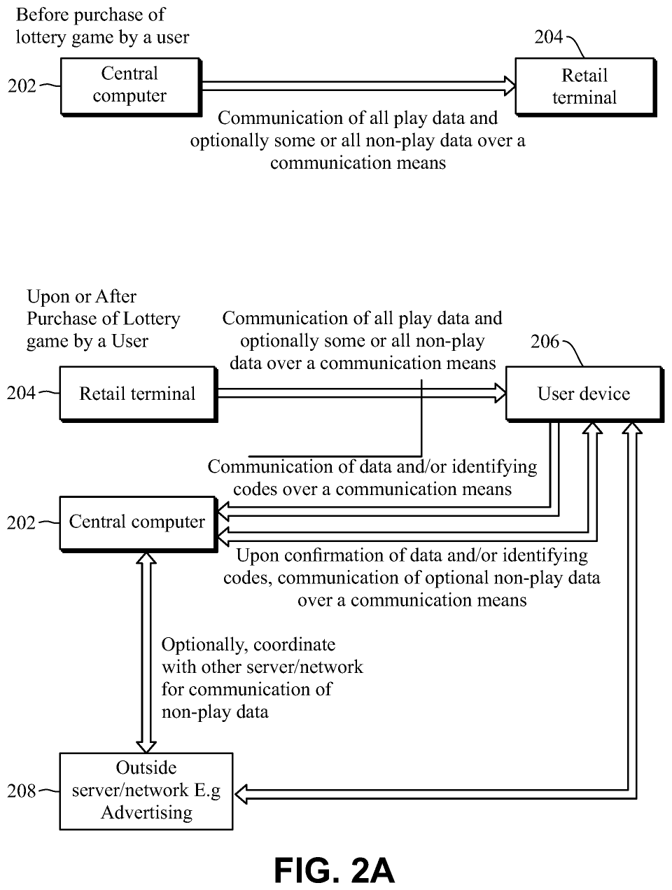

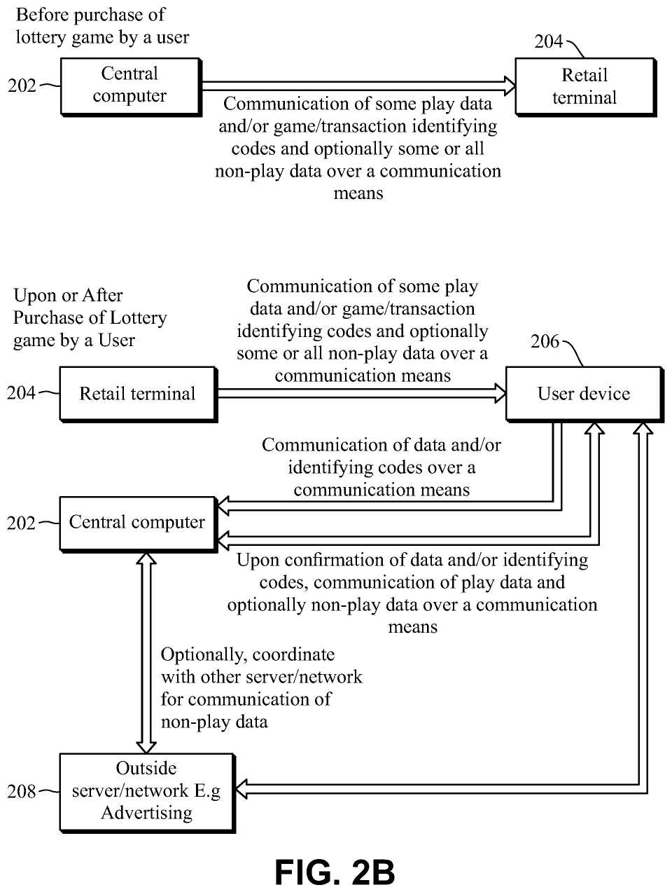

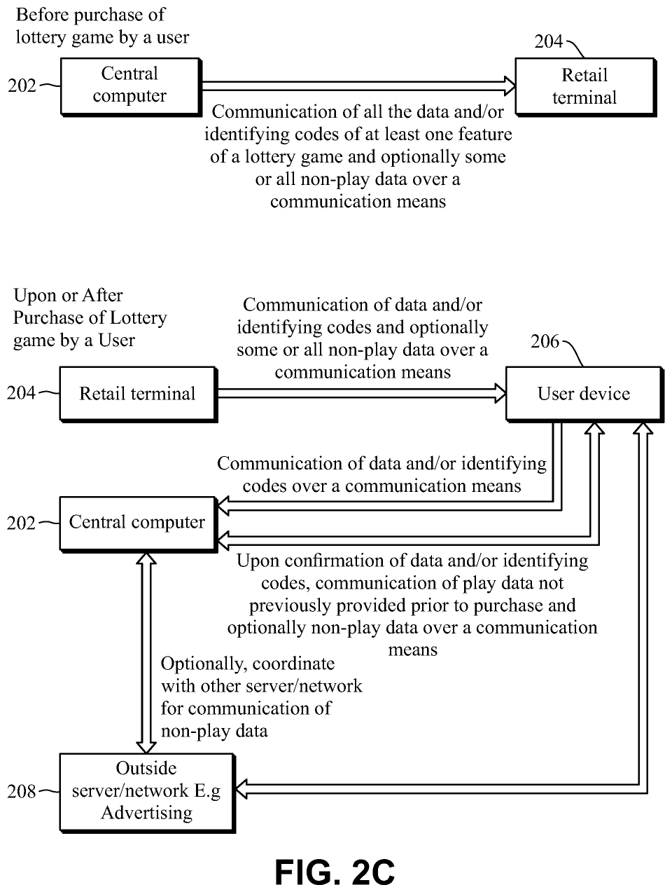

FIG. 2A is a block diagram showing a system for IGNITE™ 1-1 configuration in accordance with an embodiment of the invention. Under IGNITE™ 1-1 system architecture, all the unique identifying data of the lottery games including, optionally, non-play data, would be communicated to the lottery retail interface terminals 204 prior to the purchase of the particular games. For instance, the information could be communicated at set time schedules over a network or by lottery or retail representatives physically bringing the information to the terminal 204. Or, instead of set time schedules, the lottery retail interface terminals 204 could be programmed to alert the lottery, particular retailer or other representative that the number of preloaded games of a particular lottery type is low, whereupon the lottery system is alerted to communicate further games to the lottery retail interface terminal 204, either over a network or by physical transport.

Under this configuration, the information that is communicated and preloaded to the lottery retail interface terminals 204 would preferably provide completed play information of predetermined instant-winner lottery games that have all the results of the game, with no further information necessary to determine the outcome(s). Such information would then be stored in the lottery retail interface terminals 204 at the physical locations. Optionally, additional non-play data (further described herein) could be provided at the same time and incorporated in the same data download as the play data, so that when a player purchases the game, the player receives both play and non-play data. The system provides this additional option so that the lottery application program on the player's Smart Device 206 can communicate with the central computer 202, or other network or data bases 208, to retrieve and send non-play data after the initial game play data has been communicated to the Smart Device 206.

Players that want to purchase the games would download a software application onto their Smart Device 206, such application made available on the worldwide web, the retail locations, the applicable lottery jurisdiction, and/or authorized lottery agents and other outlets. Players, upon identifying an applicable lottery retail interface terminal 204 at a location (the mobile application could optionally be programmed to identify a location near to them), are able to visually see the different game types on the display at or near the terminal. The location displays could be digital or manual signage. Manual signage means that the display is non-digital, wherein physical rather than digital representatives identifying the game types are presented. Optionally, the players could be shown a display of the different game types on their mobile application for that particular retail location, making a display at the retail site optional-further explained in the IGNITE™ 4 system.

If the lottery retail interface terminal 204 is attendant-assisted, the player could select the game(s) they wish to purchase by either informing the clerk or manually touching an interface on the terminal (the system envisions either the option of allowing the player to manually touch an interface or informing the attendant to manually touch an interface for the selection of the games). Optionally, the lottery retail interface terminal 204 could provide a contactless feature to provide QR codes, bar codes or other types of codes that a player could scan from their Smart Device, so the games are selected and input into the lottery application on the Smart Device 206. Another option would allow the players to obtain the QR codes, bar codes or other type of codes from the mobile application on their Smart Device 206, and then scan those codes at the lottery retail interface terminal 204 or attendant assisted point-of-sale device. Once the game(s) are selected, the player would pay the attendant the required amount of money using the point-of-sale devices at the location, either with cash, debit, credit, gift card, other promotional credits, or via a digital wallet or cloud/web-based, or other application. In a contactless option, the player after downloading the appropriate App, could pay for the games via a digital wallet or cloud/web-based application, whereupon the lottery App could communicate with the lottery retail interface terminal 204 (or central computer in the higher-order IGNITE™ systems) for confirmation of the purchase, whereupon the data for the purchased instant-winner lottery games and, optionally, non-play data, are communicated to the Smart Device 206.

If the lottery retail interface terminal 204 is self-service, the player would select the game(s) they wish to purchase by manually touching an interface (screen and/or button) on the terminal. Optionally, the terminal 204 could provide QR codes, bar codes or other types of codes that a player could scan from their Smart Device, so the games are selected and eventually input into the lottery application on the phone. Another option would allow the players to obtain the QR codes, bar codes or other type of codes from the mobile application on their mobile device 206, and then scan those codes at the lottery retail interface terminal 204. Once the game(s) are selected, the player would pay the required amount of money, either with cash, debit, credit, gift card, other promotional credits, or via a digital wallet or cloud based application via the payment means of the self-service terminal. The contactless option for selection and payment would also be available for the self-service terminal.

The self-service terminal could be stand alone, in which it only sells instant-winner lottery games, or it could be a multi-purpose vending machine, in which it could sell multiple lottery type games, such as paper-based instant tickets and/or lotto type number games. Since self-service terminals for instant tickets and lotto number games already exist, another embodiment of this invention is the reconfiguration of multi-purpose vending machines to include the sale of digital instant-winner games using the means shown by this invention.

Once payment for the games has been confirmed by the lottery retail interface terminals 204 (either automatically with integrated payment means, manually input from an attendant, or from contactless payment means via a digital wallet or cloud/web-based means), the data relating to the selected games and non-play data, if any, would be provided by communication means from the lottery retail interface terminals 204 to a Smart Device 206. The preferred communication means would be wireless and, in one configuration, include any well known wireless short range system in which the Smart Device 206 would be very close (e.g. within or about 40 cms) to the lottery retail interface terminal so that the information would be securely communicated only to the device 206 of the player purchasing the games, with no ability for interception by other devices. In this manner, the play data (and, if applicable, non-play data) could be automatically transferred to the Smart Device 206 upon confirmation of purchase. Various alternative wireless communications include infrared wireless technology, near-field communications, ultra wide band, wi-fi, wireless HD, wireless USB, ZigBee, Bluetooth, or other similar types that may be developed and known in the industry (see FIG. 8).

Although not required in the system, another configuration of the system and method provides additional steps for added security. Under this configuration, the player would place their Smart Device 206 at or near the lottery retail interface terminal 204 to scan a code provided by the lottery retail interface terminal 204 upon selection of the game(s) or purchase of the games, with such code providing an identification for the lottery application on the Smart Device 206 that then allows the lottery retail interface terminal 204 to link with the Smart Device, whereupon the data would be wirelessly communicated after confirmation of the code by the lottery retail interface terminal 204 with the Smart Device 206, similar to how Bluetooth communication links devices. This would allow the communication to use the least expensive wireless application that allows less restrictive distance requirements for communication, while ensuring the data is sent to the correct Smart Device 206.

Alternatively, the communication could be conducted via scanning of a data code sufficient to supply the amount of data of the digital game and, if applicable, non-play data, such as a dynamic QR code, bar code, or other code unique for each game provided by the lottery retail interface terminal 204, with such code displayed on the lottery retail interface terminal 204 upon purchase confirmation to make communication even more secure. Such a method would require the lottery retail interface terminal 204 to include an optical display device and player to use an adaptable scanning feature on their Smart Device.

Once the data is transmitted to the player's Smart Device 206, the data would be visually displayed as a digital instant-winner lottery game, preferably animated, upon command by the player via the lottery application on the Smart Device 206. If the outcome of the game is a winner, the player could then redeem the winnings at any authorized retail location, lottery supplier, or the lottery, by providing the identifying code of the game that would be provided as part of the information communicated to the player's Smart Device 206. The identifying code could be scanned by or manually input into a redemption device that is already well know in the art and used in the lottery industry for scanning instant lottery tickets and lotto type tickets for redemption. Optionally, the system would provide its own redemption device, which is commonly used in the retail industry and easily adaptable for this lottery industry use.

As will be further described herein, this invention provides an alternative to redemption whereby the player could use their winnings for additional game play instead of redemption. This enhancement is available under all the IGNITE™ configurations, and can be a major benefit to lotteries as most players will likely play small winnings rather than redeem them, saving lotteries both costs of administration and payouts.

### IGNITE™ 1-2 System and Method

FIG. 2B is a block diagram showing a system for IGNITE™ 1-2 in accordance with an embodiment of the invention. Under the IGNITE™ 1-2 configuration, unique identifying data and/or codes relating to predetermined and/or non-predetermined digital instant-winner lottery games and, optionally, non-play data, would be communicated to the lottery retail interface terminals 204 prior to the purchase of the particular games, with the remaining play and non-play data provided from the central computer 202 (or other databases or networks 208) to the Smart Devices 206 after purchase. The protocols under this configuration would be the same, except that upon receipt of the unique identifying data and/or codes from the lottery retail interface terminals 204 upon purchase, the lottery application on the Smart Device 206 would communicate with the central computer 202 by providing the identifying data and/or codes, whereupon the central computer 202 would confirm such codes as having been issued in the system. Upon confirmation of the codes, the central computer 202 would then provide the remaining data, if any, necessary to complete the particular lottery game or feature of the game, and also provide and receive any further non-play data. Preferably, all play related data would be encrypted.

The IGNITE™ 1-2 system architecture provides the lottery the ability to supply whatever amount of play data, if any, they believe needs to be securely sent from the central computer 202 to the lottery retail interface terminals 204 with dedicated secure transmission, as previously described, and limit play data over the internet to specific enhancements, such as non-predesignated jackpots, both fixed and progressive, and linked interactive games, which can drive sales and excite players to play more while minimizing security issues. Also, dynamic enhanced game features can be provided, such as player involvement dynamics, extended play, second chance play, bonus games and free play.

Alternatively, the system can provide only unique identifying transaction and/or game codes that can be preloaded to the lottery retail interface terminals 204, and all the play and, optionally non-play data, can be communicated between the central computer 202 and the Smart Devices 206 once the unique identifying transaction and/or game codes have been communicated from the lottery retail interface terminals 204 to the Smart Devices 206. Or, a combination of communications can be provided, such as unique identifying transaction and/or game codes with non-play data could be preloaded, so that when a player purchases the game, lottery and/or sponsored messages and/or advertisements could immediately be displayed while the lottery application on the Smart Device 206 downloads the remaining play and non-play data.

Similar to IGNITE™ 1-1, dynamic non-play data can be provided and received under this configuration, such as real-time advertising and promotions, player rewards, player tracking, and game management.

### IGNITE™ 1-3 System and Method

FIG. 2C is a block diagram showing a system for IGNITE™ 1-3 in accordance with an embodiment of invention. Under the IGNITE™ 1-3 configuration, unique identifying data and/or codes of at least one feature of a predetermined and/or non-predetermined digital instant-winner lottery game and, optionally, non-play data, would be communicated to the lottery retail interface terminals 204 prior to the purchase of the particular games, with the other play and non-play data provided from the central computer 202 (or other databases or networks 208) to the Smart Devices 206 after purchase. The purpose of this system is to provide the Lottery the option to provide complete play data for an initial feature of a game to be preloaded, such as the first tier of game play or the determination of a fixed jackpot prize, but then allow for additional game data to continue game play to additional tiers, or provide a non-predesignated jackpot or progressive jackpot, or some other extended game or unique feature variation to continue game play. The options for extended game play are extensive, many of which are described in further detail herein. The protocols under this configuration would be the same, except that upon receipt of the unique identifying data and/or codes from the lottery retail interface terminals 204 upon purchase, the lottery application on the Smart Device 206 would communicate with the central computer 202 by providing identifying data or codes, whereupon the central computer 202 would confirm such data or codes as having been issued in the system. Upon confirmation, the central computer 202 would then provide the additional play data necessary to continue the game or feature of the game, and also provide and receive any further non-play data. Preferably, all play related data would be encrypted.

### IGNITE™ 2 Systems and Methods

The IGNITE™ 1 and 2 systems and methods are similar, except that under the IGNITE™ 2 system and method, since the particular locations can have real time communication with the central computer, all the play data and, optionally, non-play data could be transmitted between the lottery retail interface terminals and the central computer upon purchase by a player (IGNITE™ 2-1) or some of the play and non-play data could be transmitted between the lottery retail interface terminals and the central computer upon purchase by a player and the remaining play data and, optionally, non-play data could be provided from the central computer to the particular Smart Device of the player (IGNITE™ 2-2).

All of the remaining features of IGNITE™ 2 system architecture remain the similar to IGNITE™ 1, except no play data need be preloaded onto the lottery retail interface terminals, although it would still be an option for the lotteries to do so. The games could be predetermined, as in IGNITE™ 1-1, and/or non-predetermined, similar to IGNITE™ 1-2. The major difference in the methodologies is that under IGNITE™ 1 no communication is necessary between the lottery retail interface terminals and the central computer upon purchase by a player, wherein, under IGNITE™ 2, communication does occur.

IGNITE™ 2 system architecture provides the lotteries the flexibility to decide upon the best system that works for their retail network. IGNITE™ 2 removes the administrative burden of preloading instant games onto the lottery retail interface terminals and monitoring when to restock, whereas, IGNITE™ 1 removes the need for real time communication between the lottery retail interface terminals and central computer at time of purchase of the games.

### IGNITE™ 2-1 System and Method

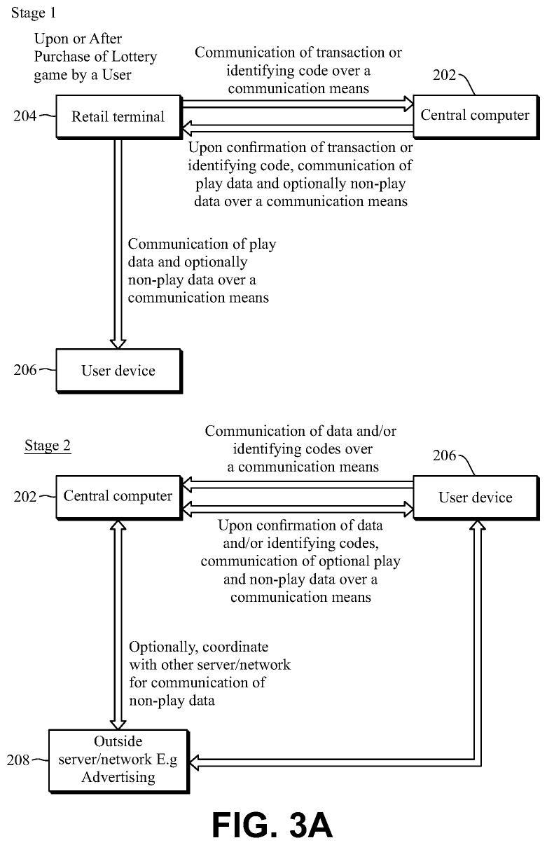

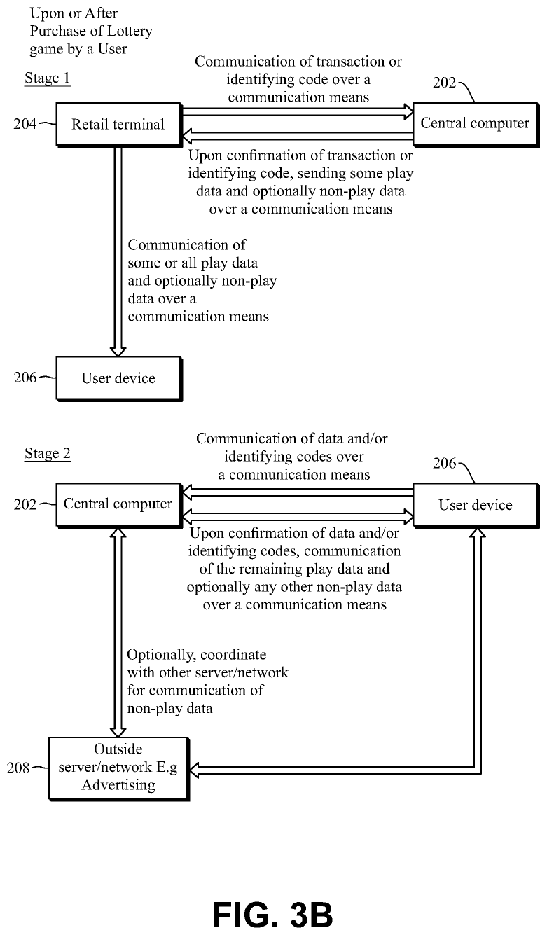

FIG. 3A is a block diagram showing a system for IGNITE™ 2-1 in accordance with an embodiment of the invention. Under the IGNITE™ 2-1 configuration, when a player selects a particular game from a lottery retail interface terminal 204, the same procedures occur, except that, upon confirmation of payment, the lottery retail interface terminal 204 generates a transaction or other identifying code and communicates such code to the central computer 202, whereupon the central computer 202 confirms such code as one having been authorized in the system and then sends the play data and, optionally, non-play data, to the lottery retail interface terminal 204, which then communicates such information to the lottery application on the player's Smart Device 206 via one of the previously described communication methodologies.

Upon receipt of the information, the player can then command to see the visual simulation of the game play. Under the IGNITE™ 2-1 system architecture, no further communication of play data is needed from the central computer 202 to the Smart Device 206, making this system extremely secure, but providing all the game enhancements of the IGNITE™ system.

Although no play data is needed, this system still provides the ability of the Smart Device 206 to receive and provide non-play data from and to the central computer 202 and/or other third party server/network 208, so that lotteries can reap the benefits of advertising and promotions, player tracking, player rewards, game management and analytics, as well as all other non-play information, while maintaining extreme security of play data, which is only provided by the particular lottery's choice of secure communication between the central computer 202 and lottery retail interface terminals 204, and then from the lottery retail interface terminals 204 to the Smart Devices 206.

Optionally, certain add-on features relating to play data can be provided through encryption over the internet between the central computer 202 and the Smart Devices 206, such as extended play, second chance play, bonus games, and the ability to continue to play winnings instead of having to redeem such winnings, as well as all non-play data, as more fully described in IGNITE™ 2-3.

### IGNITE™ 2-2 System and Method

FIG. 3B is a block diagram showing a system for IGNITE™ 2-2 in accordance with an embodiment of the invention. Under the IGNITE™ 2-2 system configuration, when a player selects a particular game from a lottery retail interface terminal 204, upon confirmation of payment, the lottery retail interface terminal 204 generates a transaction or other identifying code and communicates such code with the central computer 202, whereupon the central computer 202 confirms such code as one having been authorized in the system and then has the option to send some or all of the play data and, optionally, non-play data, to the lottery retail interface terminal 204, which then communicates such information to the lottery application on the player's Smart Device 206.

Upon receipt of the information, the lottery application on the player's Smart Device 206 sends the particular code to the central computer 202, which confirms such code as one having been issued in the system and communicates the remaining play data, if any, and any other non-play data (from central computer 202 or from outside server/network 208) to the Smart Device 206 so the player can then continue or command to see the visual simulation of the complete game play. All play data related communication could be encrypted.

All the IGNITE™ system game enhancements (both play and non-play) would be available under this configuration. As in all configurations, play enhancements include: non-designated fixed jackpots that can solve stale inventory issues; progressive jackpots that can excite players to chase a larger jackpot; linked play that can provide interactive excitement to players; extended play, second chance play, and bonus games that can extend game viewing and provide more excitement to players; the ability to continue to play winnings instead of having to redeem such winnings; player involvement features, such as virtual reality that can appeal to younger demographics; and a plethora of other features. Non-play enhancements include: advertising and promotions: player tracking; player rewards; game management and analytics; as well as other non-play information.

Because at least some play and/or non-play data is communicated from the lottery retail interface terminal to a player's Smart Device under both the IGNITE™ 1 and 2 systems and methods, a player can immediately begin viewing the simulation of play data and/or non-play data without having to wait for further communication from their Smart Device to a lottery's central computer-a major benefit of these configurations of the IGNITE™ systems and methods. Players are extremely impatient and any delay in beginning to view some form of entertainment is a liability to the game. Not every location will be a “hot” spot for rapid internet communication, and not every player will have access to rapid internet communication even if they are in a hot spot. This issue is another flaw in prior proposed mobile applications. In IGNITE™ 1-2 and 2-2, even though further play and/or non-play data may be necessary to be obtained from the central computer, the system can immediately begin playing the information already downloaded so any further delay in downloading the remaining information from the central computer would go unnoticed by the player. The downloading of additional information can be conducted seamlessly with the playing of information the player would have already received from the lottery retail interface terminal.

Although under IGNITE™ 1-2, 1-3, 2-2, and 2-3, the internet is used for play data, the reason the system is more secure than any system in prior art is because a first piece of play data can be received securely from the lottery retail interface terminal to a Smart Device. By receiving some play data, any potential of interception of other play data over the internet could be made useless to the interceptor, because without the first piece of the puzzle, the remaining pieces can be configured to be virtually meaningless. This invention allows for the highest security possible for information sent over the internet to Smart Devices because of this unique configuration with the first piece of the play data, making any further pieces of play data only useful to someone who has the first piece.

### IGNITE™ 2-3 System and Method

The IGNITE™ 2-3 system architecture is very similar to the IGNITE™ 2-2 system architecture with IGNITE™ 1-3 system particulars. Under the IGNITE™ 2-3 system architecture, unique data and/or codes of at least one complete feature of a predetermined and/or non-predetermined digital instant-winner lottery game and, optionally, non-play data, would be communicated to the lottery retail interface terminals 204 at or after time of purchase of the particular games, with the other play and non-play data provided from the central computer 202 (or other databases or networks) to the Smart Devices 206 after purchase. The purpose of this configuration is to provide the Lottery the option to provide complete play data for an initial feature of a game to be securely sent from the central computer to the lottery retail interface terminal, such as the first tier of game play or the determination of a fixed jackpot prize, but then allow for additional game data to continue game play to additional tiers, or provide a non-predesignated jackpot or progressive jackpot, or some other extended game or unique feature variation to continue game play. The options for extended game play are extensive, many of which are described in further detail herein. The protocols under this configuration would be the same, except that upon receipt of the unique identifying codes from the lottery retail interface terminals 204 upon purchase, the lottery application on the Smart Device 206 would communicate with the central computer 202 by providing the identifying transaction or game code, whereupon the central computer 202 would confirm such code as having been issued in the system. Upon confirmation of the code, the central computer 202 would then provide the additional play data necessary to continue the game or feature of the game, and also provide and receive any further non-play data. Preferably, all play related data would be encrypted.

### IGNITE™ 3 Systems and Methods

The IGNITE™ 3 systems and methods provide for embodiments of the invention that minimize the amount of information transmitted from the central computer to the lottery retail interface terminals, by providing multiple methodologies that combine game play with either play data enhancements and/or non-play data enhancements. Under the system, only identifying codes would either be preloaded from the central computer to the lottery retail interface terminals prior to purchase or communicated at time of purchase. If communicated prior to purchase, the system would be essentially the same as IGNITE™ 1-2. If communicated at time of purchase, the system becomes IGNITE™ 3.

### IGNITE™ 3-1 System and Method

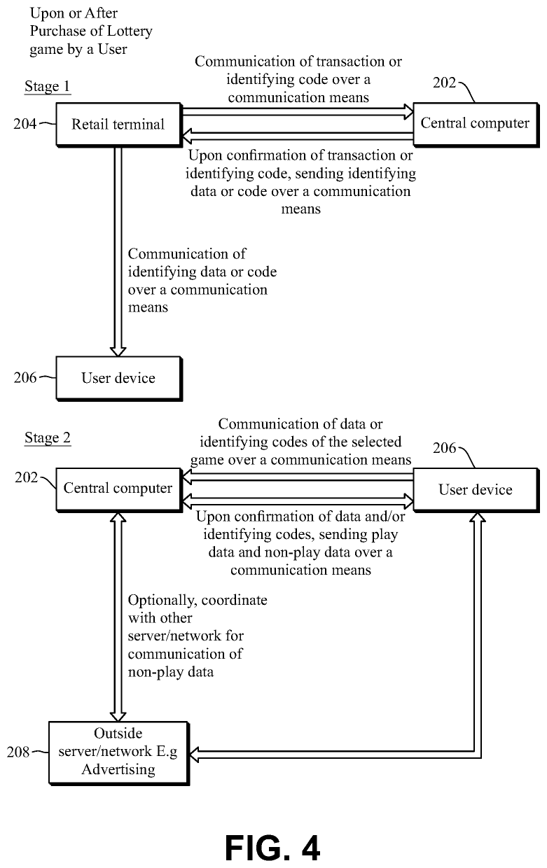

FIG. 4 is a block diagram showing IGNITE™ 3-1 system architecture in accordance with an embodiment of the invention. The IGNITE™ 3-1 system and method provides a lottery the option to use multiple methodologies combining both play data and non-play data to a player's Smart Device. An example of non-play data is advertising, which could be shown within or around the game play. Unlike the other IGNITE™ configurations where the non-play data is optional, the non-play data in this IGNITE™ 3-1 system is an important element with the play data. The IGNITE™ 3 system is derived from an understanding that conventional game data alone is insufficient to maximize the revenue potential of the games and to create new revenue streams; therefore, the system incorporates play enhancements and/or non-play applications with the data provided to the Smart Devices.

Under this system, a player would select a game(s) from the lottery retail interface terminal 204 and pay for the game in the same manner as the other configurations. The preferred IGNITE™ 3 systems and methods provide that the lottery retail interface terminal 204 would then communicate such purchase with said central computer 202, which would confirm said purchase as one that is valid in the lottery system, and then communicate the unique identifying data or code of the selected game to said lottery retail interface terminal 204. The player provides a Smart Device 206 with an applicable lottery gaming application so that the unique identifying data or code of the selected game can be communicated from the lottery retail interface terminal 204 to the Smart Device 206. The application on the Smart Device 206 then communicates the unique identifying data or code of the selected game with the central computer 202, which confirms such data or code as one that was issued in the lottery system, which then provides all the play and applicable non-play data to said application on the Smart Device 206 to complete the display and processing of the particular lottery game(s) and non-play applications. The system also optionally provides for the coordination with other computer servers/networks 208, the communication of non-play data to and/or from the player's Smart Device 206.

Alternatively, the player could communicate his/her mobile device number (or other identifying Smart Device ID) to the lottery retail interface terminal upon purchase, whereupon the lottery retail interface terminal would communicate such identifying purchase transaction information to the central computer, which would then directly communicate with the applicable Smart Device. This would be an alternative to the lottery retail interface terminal providing codes to the Smart Device that must be confirmed with the central computer.

In another alternative, the lottery retail interface terminal could communicate such identifying purchase transaction information to the applicable Smart Device, which could then communicate such information with the central computer. Under this alternative, the lottery retail interface terminal would not need to directly communicate the purchase transaction with the central computer, enabling the system not to require real time communication at time of purchase at the point-of-sale location.

In another embodiment under IGNITE™ 3, the player could have all the information and display of the lottery games provided on the Smart Device applicable lottery App, wherein the player could select the game on the App, then visit the applicable retail location selected with the lottery App or other methods, whereupon the player could present the identifying data or codes generated by the App to the lottery retail interface terminal and/or the applicable point-of-sale device and provide payment by one of the means previously described. Upon payment, the lottery retail interface terminal could notify the central computer of the payment or the lottery retail interface terminal could provide an identifying code to the player or Smart Device, so the applicable lottery App could notify the central computer of the payment. Upon notification of payment, the central computer could communicate the applicable data to the applicable Smart Device.

All of the IGNITE™ game play and non-play enhancements can be adapted to this system and method since it can provide for encrypted internet access with a player's Smart Device.

### IGNITE™ 3-2 System and Method

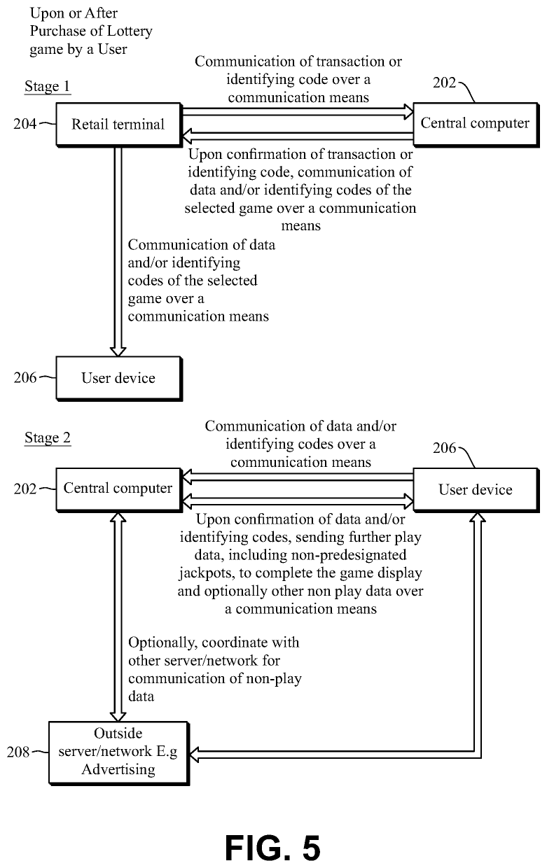

FIG. 5 is a block diagram showing a system for IGNITE™ 3-2 system architecture in accordance with an embodiment of the invention. The IGNITE™ 3-2 system and method provides a lottery the option to use multiple methodologies combining non-predesignated jackpots with other play data, which could be sent from the central computer to a player's Smart Device. Non-predesignated jackpots are fixed jackpot prizes that are not predesignated to a particular game and/or progressive jackpots that incrementally increase in some predetermined manner as the particular game and/or game feature is played until won.

Under the preferred IGNITE™ 3-2 system and method, a player would select a game(s) from the lottery retail interface terminal 204 and pay for the game in the same manner as the other configurations, then the lottery retail interface terminal 204 would communicate such purchase with said central computer 202, which would confirm said purchase as one that is valid in the lottery system, and then communicate the unique identifying data or code of the selected game to said lottery retail interface terminal 204. The player provides a Smart Device 206 with an applicable lottery gaming application so that the unique identifying data or code of the selected game can be communicated from the lottery retail interface terminal 204 to the Smart Device 206.

The application on the Smart Device 206 then communicates the unique identifying data or code of the selected game with the central computer 202, which confirms such game as one that was issued in the lottery system, which provides the play data to said application on the Smart Device 206 to complete the display and processing of the particular lottery game(s) and/or a feature(s) of the games on the player's Smart Device 206, and also optionally provides, and/or coordinates with the central computer 202 and/or other computer servers/networks 208, the communication of non-play data to and/or from the player's Smart Device 206. The play data under this configuration would include the novel feature of non-predesignated jackpots. Non-predesignated jackpots have never before been offered or possible in traditional instant-winner lottery systems provided at point-of-sale locations.

Alternatively, the player could communicate his/her mobile device number (or other identifying Smart Device ID) to the lottery retail interface terminal upon purchase, wherein the lottery retail interface terminal could communicate such information to the central computer, which would then directly communicate with the applicable Smart Device, avoiding the need for the lottery retail interface terminal to provide codes to the Smart Device that must be confirmed with the central computer.

In another alternative, the lottery retail interface terminal could communicate such identifying purchase transaction information to the applicable Smart Device, which could then communicate such information with the central computer. Under this alternative, the lottery retail interface terminal would not need to directly communicate the purchase transaction with the central computer, enabling the system not to require real time communication at time of purchase at the point-of-sale location.

In another embodiment, under all IGNITE™ 3 system architectures, the player could have all the information and display of the lottery games provided on the Smart Device applicable lottery App, wherein the player could select the game on the App, then visit the applicable retail location that could be selected with the lottery App or other methods, whereupon the player could present the identifying data or codes generated by the App to the lottery retail interface terminal and/or the applicable point of sale device and provide payment by one of the means previously described. Upon payment, the lottery retail interface terminal could notify the central computer of the payment or the lottery retail interface terminal could provide an identifying code to the player or Smart Device, so the applicable lottery App could notify the central computer of the payment. Upon notification of payment, the central computer could communicate the applicable data to the applicable Smart Device.

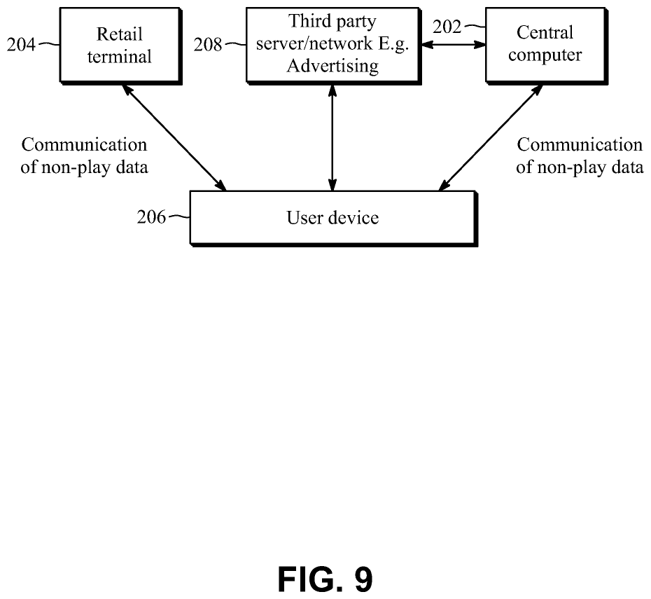

FIG. 9 is a block diagram showing interaction between a user device, a lottery retail interface terminal and a central computer in accordance with an embodiment of the invention. The user device 206 can be in communication with the lottery retail interface terminal 204, third party server/network 208 and central computer 202 for communication of non-play data depending on the configuration of the IGNITE™ system.

### IGNITE™ 4 Systems and Methods

IGNITE™ 4 system architecture provides systems and methods for a contact-less system option that can be combined with any of the IGNITE™ configurations. The IGNITE™ 4 system provides for the selection of games with a Smart Device rather than at lottery retail interface terminals, and initial identifying codes generated with the Smart Device rather than with the lottery retail interface terminals, allowing greater efficiencies for a player to select and purchase a game.

Under IGNITE™ 4 systems and methods, the applicable lottery App that could be downloaded into a player's Smart Device can be programmed to automatically communicate with the central computer to provide updated information on the types of instant-winner lottery games available under the system and, optionally, the authorized point-of-sale locations. The player could be provided the ability on their Smart Device to select a particular lottery game from a display on the lottery App (instead of having to chose the game at a display at the lottery retail interface terminal), then, after selection, have an identifying code sent from the central computer to the Smart Device (or the central computer could alternatively provide pre-loaded codes to lottery applications, such as the lottery App for the Smart Device, prior to selection by the player) that identifies the game so the player can use the code to purchase the game at a lottery retail interface terminal or point of sale device at a selected location. Payment could be by any means previously described, including digital payments so the process could be contact-less. The lottery retail interface terminal or point-of-sale device could provide upon purchase a code to the player or to the player's Smart Device (input wirelessly or manually) so the lottery App could communicate the code to the central computer to confirm payment, whereupon the central computer could communicate the play data and any non-play data to the Smart Device.

Alternatively, the lottery retail interface terminal, if in communication with the central computer, could confirm payment of the game and the identifying codes that were provided from the Smart Device to the central computer, whereupon the central computer could communicate the play data and any non-play data to the Smart Device. In this alternative, no further information is necessary to be communicated from the lottery retail interface terminal to the Smart Device after payment. This method would simplify the data the lottery retail interface terminals would need to process, reducing the cost associated with the lottery retail interface terminals.

Alternatively, the lottery retail interface terminal could provide some or all play data and optionally non-play data to the Smart Device upon payment confirmation. This would occur in IGNITE™ systems where the lottery pre-loads play data prior to purchase onto the lottery retail interface terminals or the play data is provided from the central computer to the lottery retail interface terminals at time of purchase.

In another embodiment of the IGNITE™ 4 systems and methods, existing point-of-sale devices at retail locations and/or existing self-service vending machines could be substituted for lottery retail interface terminals, so there would be no need to have separate lottery retail interface terminals at point-of-sale locations in locations with such existing devices and machines, reducing the cost of implementation of the system. Under this embodiment, the existing point-of-sale devices and machines could be programmed to provide applicable identification codes that would be used to confirm purchase of the games. The codes could be provided to the player or player's Smart Device, or directly to the lottery system (similar to how communication is currently provided for gift cards from point-of-sale devices at retail locations). Once such codes are confirmed as valid in the system, the central computer could provide the play data and, optionally, non-play data (or such non-play data could be provided from other third party systems), to the applicable Smart Device.

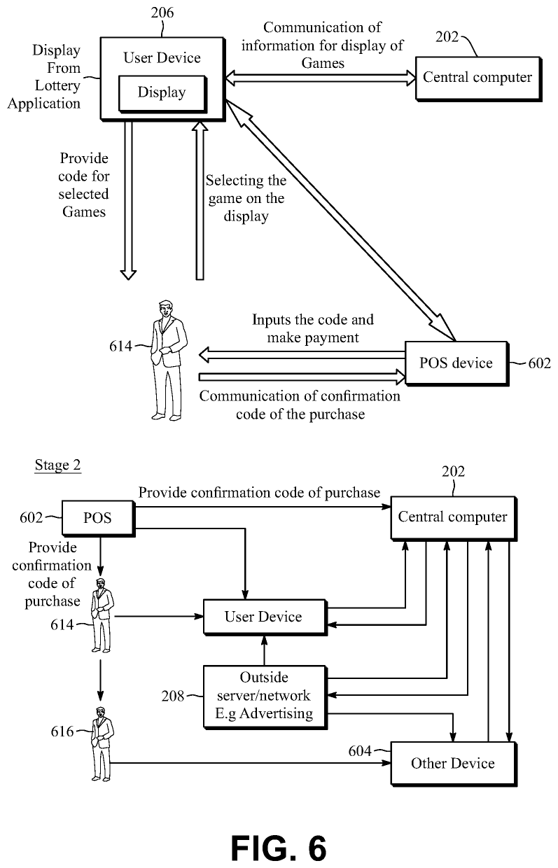

FIG. 6 is a block diagram showing a system in accordance with an IGNITE™ 4 embodiment of the invention. The user device 206 downloads an application that can display the lottery games via a communication connection with the central computer 202. The player 614 selects the games on the display on the user device 206, and is provided a code from the lottery system for the selection. The player 614 then uses the code at a point-of-sale (POS) device 602 and makes a payment to the POS device 602. The POS device 602 then provides a confirmation code of the purchase to either: 1) the player 614, who can gives the code to someone else 616 (like a gift) to use on an internet compatible device 604 or can input the code into their user device 206, which then communicates the code to the central computer 202; (2) the user device 206, which then communicates the code to the central computer 202; or, (3) directly to the central computer 202. Once the central computer 202 receives the code and confirms it as one in the system, it communicates the information relating to the selected games to the user device 206 (or other internet compatible device 604) and, optionally, sends or coordinates with an outside server/network 208 non-play data to the user device 206 (or other internet compatible device 604).

In a further embodiment of the IGNITE™ 4 systems, a player can purchase a game directly from the applicable lottery App and have the game communicated directly to their Smart Device where authorized. However, at this time, most lottery jurisdictions limit such purchases to authorized lottery websites and many only allow cash purchases. Nevertheless, an embodiment of this invention is to provide this system so the lotteries have the ability to expand players' ability to purchase and play instant-winner lottery games when and if authorized by lottery jurisdictions.

The advanced IGNITE™ 4 systems have the ability to incorporate all the unique features of the other IGNITE™ systems for enhanced game play and non-game data, such as advertising into the system, without having to interact with lottery retail interface terminals. So, although other systems currently allow the purchase of a digital game from lottery websites, this system would allow the purchase of IGNITE™ features (e.g. extended play games, progressive jackpot games, non-predesignated fixed jackpot games, interactive games, virtual reality games, and games integrated with advertising and promotions) which are unique to this patent invention and not found on lottery websites.

All of the IGNITE™ game play and non-play enhancements can be adapted to this system and method since it provides for encrypted internet access with a player's Smart Device.

All of the IGNITE™ systems can allow redemption of lottery winnings either from retailers, the lottery, and/or a feature on the player's Smart Device, such as a digital wallet. The system could also allow redemption of lottery winnings into Crypto currency, if allowed by the particular lottery jurisdiction.

If a digital wallet, or similar payment system, on a player's personal mobile device is used, or Crypto currency is used, the system, depending on existing applicable gaming laws, could allow for the player to continue to purchase and play games until the money in the digital wallet, or similar system, or Crypto currency is depleted to zero.

### Lottery Retail Interface Terminals

It is envisioned under certain configurations of this invention that lottery retail interface terminals would be deployed to and/or established (by converting existing adaptable devices/machines) at retailers and other designated lottery retail locations. It is an object of the invention to make them as inexpensive as possible by providing basic elements (as described herein). In essence, a lottery retail interface terminal would be a device/machine/computer that is able, if needed, to display instant-winner lottery games (such games could alternatively be displayed on Smart Devices, as described herein), receive data either directly or indirectly from a central computer and/or receive and communicate data to players upon confirmation of purchase. The lottery retail interface terminal could be clerk-assisted (with an integrated payment means or no connected payment means) or self-service (stand alone or multi-purpose vending of other lottery products).

The lottery retail interface terminal comprises a means capable of entering into a communication interface with the central computer (including an interface for information physically delivered from the central computer, under certain configurations); an optional display capable of showing the available instant-winner lottery games, displaying the visual identification markings of the games to allow selection for purchase (the display can be integrated with or separate from the terminal); a means capable of confirming purchase of the selection of the games; a means capable of storing and/or processing the data communication received from the central computer; a means capable of communicating and receiving/providing data to Smart Devices for the visual presentation of the games; and, other optional computer functions.

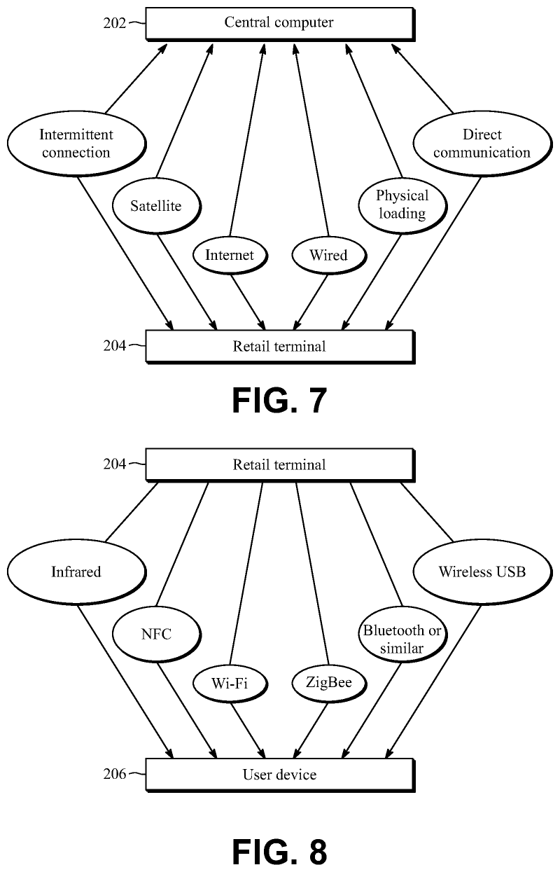

FIG. 7 shows the different configurations in which the lottery retail interface terminals 204 could communicate with the central computer 202 depending on the IGNITE™ system and method: direct through real time connection (direct connection can be secure wireless—satellite, intranet, internet, etc; or wired); direct through intermittent connection; and indirect through an intermediary, such as a person(s) physically bringing the data from the central computer to the lottery retail interface terminals (such as with a mobile hand-held device), with such data being downloaded wirelessly or through physical connection, or by a separate interface, such as through a communication means of the retail location or local area communication means that may interface with another communication means.

A real time connection could allow data from/to the central computer to continuously be provided to/by the lottery retail interface terminal. IGNITE™ 2 and 3 systems and methods assume that locations would have real-time connection or connection available at time of each purchase.

IGNITE™ 1 systems and methods assume that the locations do not have real-time connection or that a particular lottery has opted not to use such connection. Instead of real-time, the connection would, wired or wirelessly, have direct communication to/from the central computer at periodic intervals and achieve similar benefits as under a real-time system, but with delayed reporting. This method may decrease communication costs. Or, the lottery retail interface terminal could be segregated from communication from the central computer, so that no direct communication occurs, thereby reducing costs even further. Under the method of no direct communication with the central computer, a mobile device could be used to provide an interface between the central computer and the lottery retail interface terminal. Under that scenario, a designated person could use a mobile device to interact with the central computer, and then use that device to interact with the lottery retail interface terminal. The mobile device could interact wirelessly with the central computer and lottery retail interface terminal, or be configured to directly connect to both the central computer and lottery retail interface terminal at different times (such as with a detachable storage device). The mobile device would then provide the identifying codes and/or play and, optionally, non-play data from the central computer to the lottery retail interface terminal, and, likewise, provide the sales and other information from the lottery retail interface terminal to the central computer.

If the lottery retail interface terminal communicates only periodically with the central computer either via direct communication or intermediary communication, such as through a separate mobile device, the lottery retail interface terminals could be provided digital lottery games in batches, so that the central computer monitors how many games it sends to those specified lottery retail interface terminals, although, as previously described, this could optionally be done real-time as well. The batching could be done in much the same fashion that traditional paper based instant-winner tickets are currently sent in batches to retail locations. However, the current invention would provide more flexibility than previously existing methodologies in that the games do not have to be sent in batches even if the lottery retail interface terminals are not in real-time connection.

Whether batched or unbatched, one methodology for this flexibility provides that all of the play data and, optionally, non-play data to be provided to the lottery retail interface terminal and another methodology provides some play data and/or identifying codes relating to the games and, optionally, non-play data, to be provided to the lottery retail interface terminal, in which case the remaining play data and non-play data would be communicated from the central computer to the player's Smart Device. Even if batched the invention still provides the ability for enhanced jackpots using a similar methodology of the central computer providing additional play data to the player's Smart Device once it has been communicated to that device from the lottery retail interface terminal. Other methodologies for flexibility will become obvious as a result of deployment of this new invention.

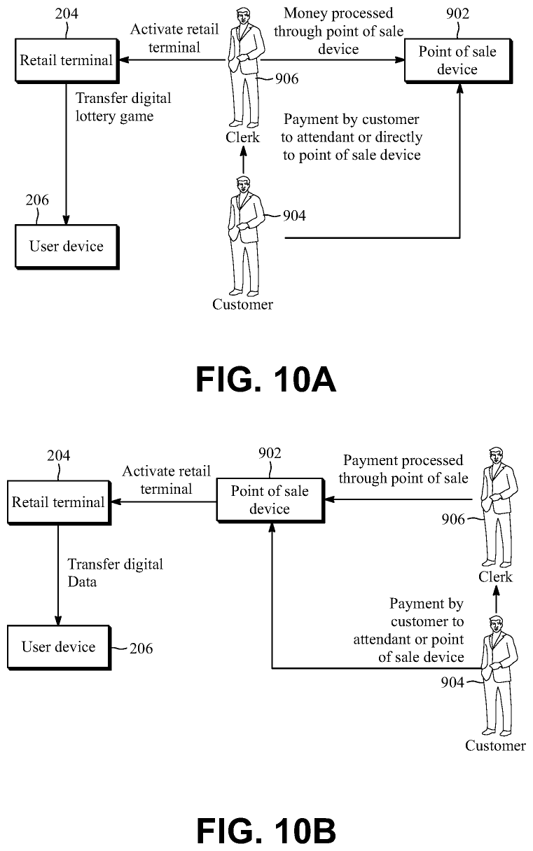

FIGS. 10A and 10B show a clerk assisted lottery retail interface terminal 204 in accordance with embodiments of the invention. If clerk-assisted, the lottery retail interface terminal 204 would consist of a computer, a keypad, a communication device(s), and, optionally, a display screen(s), along with other wires and connections, including electrical connections, necessary to enable everything to operate together. The main display screen could allow all the designated lottery games and pertinent information (such as game names, designs, prices, and other identifying features) to be displayed to the potential players 904 (although this is optional if such displays are made available through an applicable lottery App for Smart Devices). An optional additional display screen could be provided for the clerk 906 to monitor the transactions. Alternatively, an inexpensive manual display could be provided separate from or attached to the lottery retail interface terminal that could display the games available to reduce equipment costs.

A player 904 would choose which lottery games they wish to purchase from the display screen (either at the lottery retail interface terminal 204 or Smart Device 206). The screen could be “touch” activated, in which the player could touch which game they want, or it could be “button” activated, or the lottery retail interface terminal could have “numbered buttons” corresponding to the games shown, or there could be no player interaction and only clerk interaction, where players 904 tell the clerk 906 which games they want and a clerk activates the appropriate device mechanisms for the lottery retail interface terminal 204 for those games. Once the games have been selected, the player 904 would provide their payment means, such as cash, credit, debit, digital wallet or other mobile device payment application, to the clerk 906 or point-of-sale device 902.

Once payment or other authentication (such as a gift card, promotional code, etc) is confirmed by the retail clerk 906 using a point of sale device 902, and activated onto the lottery retail interface terminal 204 by the retail clerk 906, the lottery retail interface terminal 204 would then communicate the play data and/or identifying code and, if applicable, the non-play data to the player's Smart Device. Although, alternatively, the system could provide the option to have the player choose the particular game on the applicable lottery App, whereupon they could have the play data communicated directly to their Smart Device 206 from the central computer once they have received, or the central computer has received, a confirmation code generated from the applicable lottery retail interface terminal 204 or point-of-sale device 902 of payment.

FIG. 8 shows the various methods in which communication could be achieved between the lottery retail interface terminal 204 and the Smart Device 206. As previously described, the preferred communication means between the lottery retail interface terminal 204 and Smart Device 206 would be wireless and, in one configuration, include any well known wireless short range system in which the Smart Device would be very close (e.g. within 40 cms) to the terminal so that the information would be securely communicated only to the device of the player purchasing the games, with no ability for interception by other devices. Wireless communications include infrared wireless technology, near-field communications, ultra wide band, Wi-Fi, wireless HD, wireless USB, ZigBee, Bluetooth, or other similar types that may be developed and known in the industry.

Another configuration of the system and method provides that the player would place their Smart Device at or near the lottery retail interface terminal to scan a code provided by the lottery retail interface terminal upon selection of the game(s) or purchase of the games, with such code providing identification for the lottery application on the Smart Device and allow the lottery retail interface terminal to link with the Smart Device, whereupon the data for the games would be communicated after confirmation of the code by the lottery retail interface terminal with the Smart Device, similar to how Bluetooth communication links devices. This would allow the communication to use the least expensive wireless application that allows less restrictive distance requirements for communication, while ensuring the data is sent to the correct Smart Device.

Alternatively, the communication could be conducted via scanning of a data code sufficient to supply the amount of data of the digital game, such as a dynamic QR code, bar code, or other code unique for each game provided by the lottery retail interface terminal, with such code displayed on the lottery retail interface terminal upon purchase confirmation to make communication even more secure. Such a method would require the player to use an adaptable scanning feature on their Smart Device.

FIG. 10A shows a clerk-assisted lottery retail interface terminal 204 system in accordance with different embodiments of the invention. A clerk-assisted lottery retail interface terminal could be deployed as a new device/machine to the retail locations, or existing devices/machines at the retail locations could be converted to function as a clerk-assisted lottery retail interface terminal, such as existing lottery displays and machines, existing cash registers, and other similar type of retail point-of-sale equipment. Some existing point-of-sale equipment may only need a display screen added for such conversions. Whatever the choice, the ultimate result of a clerk-assisted lottery retail interface terminal 204 is the device/machine envisioned by this invention under this embodiment.

FIG. 10B shows a clerk-assisted lottery retail interface terminal 204 system that has an integrated payment means. The system is essentially the same as the system shown in FIG. 10A except that the point of sale device 902 is integrated with the lottery retail interface terminal 204 so that once payment is made through the point of sale device 902 the lottery retail interface terminal 204 is automatically notified of the purchase confirmation; whereupon the lottery retail interface terminal 204 can provide the particular digital data to the customer's user device 206, communicate with the central computer to provide further data to the customer's user device 206, and/or provide other identification codes to the customer's user device 206, which can then communicate with the central computer for further data.

FIG. 12 is a block diagram showing payment means for a lottery retail interface terminal in accordance with an embodiment of the invention. Through a point-of-sale device 1102, the player has an option to purchase the game by paying using any approved applicable regulatory means (e.g. credit or debit card, gift card, rewards points, promotional offerings, crypto currency, digital wallet and/or any cloud or web-based payment application).

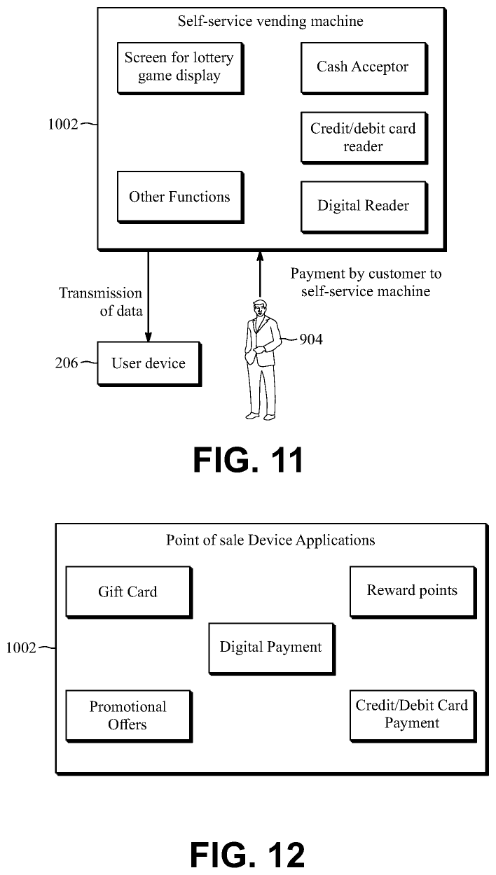

For locations without clerks or where the locations do not want to interface with customers for lottery games (such as at high-volume supermarkets, shopping malls, airports, subways, etc), a self-service lottery retail interface terminal 1002 could be provided (FIG. 11). This terminal would consist of the same devices and mechanisms as the clerk-assisted lottery retail interface terminal except that it would include one or multiple payment interface devices, such as a bill acceptor, card reader, and/or device capable of interfacing with a digital wallet or other personal mobile device payment application. Since most high-volume lottery locations already have self-service vending machines for instant tickets and lotto type games, it is envisioned that these machines could be retrofitted, as described herein, to include the lottery retail interface terminal. FIG. 11 shows an embodiment where the customer 904 interacts with the self-service terminal 1002 by use of a payment method once the customer selects a game from a game display; whereupon the self-service terminal would provide the particular data to the customer's user device 206 or to the central computer upon or after payment confirmation.

### Integrated Multi-Purpose Self-Service Vending Machines

Currently, lotteries deploy multi-purpose self-service vending machines in many locations. Some of these machines provide for paper-based instant-winner lottery tickets (scratch off and/or pull tab) to be presented and sold and others provide for other lottery game applications that allow for the sale of lotto and other on-line number games. These machines are referred to as multi-purpose self-service vending machines.

Under this invention, either a new integrated multi-purpose self-service vending machine could be manufactured and deployed integrating the digital instant-winner lottery game system of this invention or the existing multi-purpose self-service vending machines could be retrofitted to incorporate the components of and serve as the lottery retail interface terminal.

If a new machine, the cost of integration could be minimal since all the components, except for a larger display and a data communication device, currently exist in the configuration of most multi-purpose self-service vending machines that include lotto game sales, thereby requiring very little cost to add this invention's features. The integration process might provide for a larger digital screen to be added to the configuration in order to display the digital instant-winner games and a data communication device, either for wireless communication and/or an optical code generator to enable scanning, to communicate the digital data to a player's Smart Device.

If an existing multi-purpose self-service vending machine, the machine could be retrofitted by adding a digital display screen for selection of the games and a data communication device(s) to communicate the digital data to a player's Smart Device. In addition, the vending machine would need modified programming to integrate the additional selection process and communication necessary with the central computer.

By integrating the IGNITE™ system and methods into multi-purpose self-service vending machines, the cost can be dramatically reduced for the deployment of the system into high-volume locations that already have or would otherwise have a multi-purpose self-service vending machine. This integration process is an embodiment of this invention.

### Hybrid Mobile Retail System

This invention provides for advanced hybrid systems, referred to as IGNITE™ 4 systems, whereby the lottery application on the Smart Device can integrate features otherwise found at the lottery retail interface terminal and/or point-of-sale devices to streamline the transaction process.

In one embodiment of this system, an instant-winner lottery game system is provided, similar to the other IGNITE™ systems with a central computer programmed to communicate predetermined or non-predetermined digital instant-winner lottery games via an intranet, the world-wide web and/or any remote communication means; a plurality of lottery retail interface terminals located at one location or a plurality of spaced-apart locations, said plurality of lottery retail interface terminals comprising: (1) a means capable of entering into a communication interface with (i) said central computer and/or (ii) a device providing information to and/or from said central computer; (2) a means capable of storing and/or processing information provided from said central computer; and (3) a means capable of communicating and providing said information to Smart Devices; with a plurality of Smart Devices capable of downloading an applicable lottery gaming application and communicating with the central computer. The lottery retail interface terminals optionally could have a screen to visually display the identification markings of one or a plurality of instant-winner lottery games. However, under this system, a player can select said games from a display of one or a plurality of games on a Smart Device using the lottery gaming application, rather than at the retail location. If the player selects the game on the Smart Device, then an identifying code is provided either from the lottery application (in a preloaded type manner so no further communication is necessary with the central computer) or from the central computer to the lottery application upon such selection; whereupon such code can be used to process the transaction at an applicable computer terminal, such as the lottery retail interface terminal or point-of-sale device.

After selecting the particular game and receiving the particular code, the player can visit a selected physical location (which optionally can be selected from a list of such locations that can be shown on the lottery application), whereupon the player can purchase said games via point-of-sale devices separate from or integrated with said lottery retail interface terminals, including self-service terminals. At time of or after purchase, the lottery retail interface terminal can communicate the applicable identifying data of the game, and/or the identifying transaction and/or game code to either: the player and/or mobile computing device; or, the central computer. The determination of where to communicate will depend on whether the retail location can be in real time communication with the central computer. If communicated to the central computer, then no further communication would be necessary between the lottery retail interface terminal and the Smart Device because the central computer could confirm the purchase and communicate the play data to said application on the mobile computing device to complete the display and processing of one or a plurality of said lottery games and/or a feature(s) of said games, and, optionally, coordinate internally and/or with other computer servers/networks the communication of non-play data to and/or from said Smart Device.

If instead, the lottery retail interface terminal communicates the identifying data of the game, and/or the identifying transaction and/or game code, to the Smart Device, then further communication would depend on whether any further play data and non-play data was to be received. If additional data was to be received, then said application on the Smart Device would communicate the unique identifying data and/or codes of the selected game with the central computer, which would confirm such data and/or codes as one that was issued in the applicable lottery system and provide any additional play data to said application on the Smart Device to complete the display and processing of one or a plurality of said lottery games and/or a feature(s) of said games, and, optionally, coordinate internally and/or with other computer servers/networks the communication of non-play data to and/or from said Smart Device.

This embodiment streamlines the transaction process by eliminating the need for a player to spend time in front of a display screen at a physical location to decide on which games to purchase. Instead, the player can decide at their leisure by seeing the available games on their Smart Device. The player can simply use the code downloaded to their Smart Device on the applicable lottery application or from the central computer upon selection, and have it scanned at the computer terminal or point-of-sale device at the designated physical location, whereupon they would make payment (by any applicable regulatory approved and available payment means). After payment, whether they receive further data or codes from the lottery retail interface terminal and/or from the central computer will depend on the particular IGNITE™ configuration. All such previously described methodologies would be available to IGNITE™ 4.

In another embodiment of this system, an instant-winner lottery game system is provided. The system comprising: a central computer programmed to communicate predetermined or non-predetermined digital instant-winner lottery games via an intranet, the world-wide web and/or any remote communication means; and a plurality of Smart Devices capable of downloading an applicable lottery gaming application and communicating with the central computer. In this system, lottery retail interface terminals would be optional to place at physical locations, as the player could process the entire transaction on their Smart Device and/or use a location's existing computer terminals, such as the point-of-sale device. However, a lottery is likely to still want to have retail presence, so all the IGNITE™ configurations would still be available to integrate with this embodiment.

Under this system, a player can select said games from a display of one or a plurality of games on a Smart Device using the lottery gaming application. Once selected, a player could purchase said games by using any approved applicable regulatory means (e.g. credit or debit card, gift card, rewards points, promotional offerings, crypto currency, digital wallet and/or any cloud or web-based payment application) via their Smart Device. Alternatively, because many lottery jurisdictions do not permit internet purchases, another embodiment provides that once the player selects the game and receives an identifying code via their Smart Device, they would be instructed to visit an authorized point-of-sale location to purchase the selected games by providing the identifying code to the retailer or retail point-of-sale device (such as a cash register or self-service vending machine) to be input; whereupon the retail device at the location could communicate with the central computer (or applicable intermediary server), similar in the art as to how gift cards are activated at retail locations, or provide an activation code that the player could scan or input into their Smart Device, which could then communicate such code to the central computer. Once the central computer receives and confirms the activation, the data for the particular game and any non-play data could be communicated to the Smart Device via the lottery application from the central computer.

The lottery application on the Smart Device could provide an age verification process as well.

Once purchased, the central computer would communicate the applicable play data to said application on the Smart Device to complete the display and processing of one or a plurality of said lottery games, and, optionally, coordinate internally and/or with other computer servers/networks the communication of non-play data to and/or from said Smart Device. Any winnings from the game played could be redeemed via the application on the Smart Device that could place the winnings into a digital wallet, crypto currency, prepaid card, points, or other web-based application. Alternatively, any winnings could be redeemed at the applicable lottery or an approved lottery representative location by confirmation that the unique identifying code included in the said data communicated to the mobile device was one that was issued in the applicable lottery system.

Additional embodiments include integrating the enhanced features available under this invention into the communication of the data to the Smart Device. In one example, after the player purchases a game through the application on a Smart Device, the central computer would communicate play data with non-play data. For instance, the novel advertising features of this invention could be the non-play data, so that when the central computer provides the play data, it includes the advertising features with the play data. In another example, the central computer could communicate play data that includes the novel non-predesignated jackpot features of this invention. The non-predesignated jackpots would allow either or both fixed jackpots that are not predesignated to a particular game play and progressive jackpots that incrementally increase with game play until won randomly. In another example, the central computer could communicate play data that included the novel “extended play” features of this invention. In another example, the central computer could communicate play data related to “linked” and/or “interactive” games, where the play of other players affect the game results. All of the play and non-play features described in this invention would be available to integrate into the communication of the data sent from the central computer to a Smart Device.

### Instant-Winner Lottery Games

This invention creates a new system and methodology for deploying and selling instant-winner digital lottery games to physical point-of-sale locations and eliminates the need for paper-based instant-winner tickets (although lotteries may still use such tickets in parallel to digital games).

As previously described, instant-winner lottery games that are sold from physical point-of-sale locations are currently sold as paper-based instant-winner “scratch off” or “pull-tab” type tickets, whereby a player purchases the ticket then scratches off or pulls off a designated surface of the ticket to reveal the game results. Digital lottery games, on the other hand, are currently only sold or offered from websites or from gambling devices, such as from video lottery machines, where authorized by the particular jurisdiction.

Instant-winner lottery tickets are pre-printed at a secure printing facility then deployed to the lottery and/or designated lottery point-of-sale locations. The costs of printing the tickets, the scrutiny and security measures of deploying the tickets and the administration to monitor the deployment and sales of the tickets are the heaviest cost burden per dollar of revenue to most lotteries. In addition to the tremendous cost burdens, the tickets are activated (“live” in the lotteries' systems) prior to a player's purchase, making them subject to theft, pilferage and mismanagement. Further, all of the tickets for the instant-winner lottery games must have predetermined jackpot winners and predetermined number of tickets in a ticket batch for a particular game. These limitations prevent lotteries from creating exciting progressive jackpot games and allow the remainder of a batch of tickets to become stale once the largest predetermined fixed jackpots have been won.

The IGNITE™ systems and methodologies allow a lottery or lottery supplier to deploy an economically feasible system for instant-winner digital lottery games. As a result, this invention enables the creation of an almost endless number of different types of instant-winner lottery games capable of being sold from a point-of-sale system, such as: mega-link games for fixed and progressive jackpots; interactive multi-player games; multi-level jackpot games; games with vertical and horizontal reels; games with spinning wheels; combination games; card games; dice games; race games-horse, vehicles, caricatures; bonus games; multi-level games; word games; hidden prize games; treasure hunt games; keno games, bingo games; match games; digit games; and other symbols, numbers and caricature games. Prior art focuses on the simulation of instant-winner ticket games, which simply show a scratch-off type simulation of those games. It is an embodiment of this invention to provide much more comprehensive instant-winner lottery games that provide simulations that are more entertaining than scratch-off type simulations. This invention provides for the digital simulation of any of the above referenced games, so that instead of scratch-off simulations, the games can simulate more elements and interactions. Embodiments of games from this invention can include elements that provide some type of winning combination that results in an outcome whereby the player can be awarded a prize (generally such prize would be a monetary jackpot, but could be free game play, extended game play, and trade-in game play). A winning combination could be a series of particular elements or only one element.

Because of the limitations associated with instant tickets and instant-winner games, all the prizes for traditional paper-based instant tickets are batched and pre-determined by ticket, based on the number of tickets in the batch, the price of the ticket, and the payout percentage of the game. Theoretically, this is a pari-mutuel system, but practically speaking, it never is a pari-mutuel system because seldom if ever do all the tickets sell in a particular batch, which means the payout could be more or less than a true pari-mutuel system. This is a problem that appears to be over-looked in pari-mutuel jurisdictions, but a problem nevertheless. In most participating states in the U.S., all prizes except for the progressive top jackpot are fixed amounts, meaning that they stay the same no matter the volume of play. The progressive jackpot, however, is generally calculated on a pari-mutuel basis, meaning that the amount each winner receives changes depending on how many tickets were sold for that particular game and how many other winners there are at the same level.

For instant ticket games, the lottery industry has never been able to achieve a truly pari-mutuel system because no existing traditional instant ticket system provides a progressive jackpot. This is a major lingering legal problem for some jurisdictions. For instance, the California Lottery requires all lottery prizes to be calculated on a pari-mutuel basis. As such, the instant ticket games in California are calculated on a pari-mutuel basis, but they seldom if ever achieve a truly pari-mutuel basis-contradicting the requirement under California law. The reason, as previously explained, is that seldom if ever are all the tickets sold, meaning too much money or too little money has been distributed to the players based on a truly pari-mutuel determination. This invention solves that problem because it can create a true pari-mutuel system for California and for every other lottery in need of a true pari-mutuel system, which has never before been possible for instant-winner ticket games.

An embodiment of this invention is the creation of truly pari-mutuel instant-winner games and systems. By enabling a digital system using the IGNITE™ 1-2 or higher system and methodologies, this invention can allow every game to be based on a pari-mutuel system, which would achieve full compliance of the law that California or other pari-mutuel lotteries have never been able to achieve with the existing instant ticket games. However, its flexibility can also provide fixed level prizes as well, so it can fit into other lottery jurisdictional goals and regulations.

This invention allows all types of jackpots to be capable of being played. Any algorithm and type of payout play as determined by a lottery jurisdiction can be used for the deployment of a game under the system and methodology of this invention. An embodiment of this invention is the ability to provide flexibility to lotteries for the sale of any type of lottery game algorithm and payout for point-of-sale locations.

Of special note, this invention can deploy “non-activated” games, whereby the games communicated to the lottery retail interface terminal from the central computer are not “live” and cannot be played until a player purchases the particular game or otherwise provides an alternative activation (e.g. via gift card or promotion code) of the particular game. The reason this is of special note is because this would completely eliminate any loss of revenue due to theft, pilferage or mismanagement of the games, which is a major problem with traditional paper-based instant-winner lottery tickets and the retailer inventory system. This benefit alone could warrant implementation of this new system and methodology.

As previously described under lottery retail interface terminals, under the IGNITE™ systems, the lottery games can be batched or unbatched. Games that are batched generally would mean that there would be a predetermined number of lottery games per batch. The play data in the games batched or unbatched could be “complete” or “incomplete” when communicated from the central computer to the lottery retail interface terminals. A “complete” game is one that requires no further play data, and can be played to conclusion by a player once communicated to the player's personal mobile device. Complete games generally have predetermined jackpot payouts as established by the overall algorithm of the particular lottery game.

An “incomplete” game is one that requires further play data to be provided by the central computer in order for it to be played to conclusion by a player once communicated to the player's personal mobile device. The data to be provided for an incomplete game could be related to the progressive nature of a jackpot prize, to the reset feature of a fixed jackpot prize, to the elements or features within the game, to an outside factor (such as a random number generator, or a generator based on some feature of the particular game sale) in determining a winner, to extended play, to bonus games, and/or to other aspects of the lottery game. Incomplete games could also have no initial play data, in which case the lottery retail interface terminal provides only the information necessary (authentication code and/or other data) to activate an App or function on the player's personal mobile device that initiates the communication of the play data from that App or function after further communication with the central computer.

Under the IGNITE™ systems and methodologies, the information to be provided from the central computer relating to the instant-winner games could be provided to the lottery retail interface terminals prior to the time of purchase (so no communication is needed with the central computer at time of purchase), at time of purchase (if real-time communication with the central computer is available), and/or after purchase (if internet communication with a player's Smart Device is allowed). If the additional play data is communicated from the central computer to the player's personal mobile device, the player would be required to have downloaded an applicable App or link to receive communication from the central computer. An identifying code would be embedded in or provided with the information received from the lottery retail interface terminal that would allow specific communication between a player's Smart Device and the central computer. For security purposes, the lottery could establish a portal to a separate computer established by the central computer to handle communication of play data to either lottery retail interface terminals and/or Smart Devices so, even though data communication would be encrypted, an additional firewall is created to prevent initial hacking attempts.

In addition to progressive jackpot games, interactive games with multiple players could be implemented under this system. Such games could include card games, such as black jack, poker, pai gow, baccarat, and others, which could be games of skill, if allowed by the applicable jurisdictional authorities, or games of chance, where the outcome of the games can be determined by set algorithms even though the players may appear to be making the decisions. Similarly, the games could include any sort of game of either skill or chance that may appear interactive, from racing games (e.g. horse, dog, car, caricatures) to number games (e.g. keno, bingo, lotto), and any other type of game.

### Linking of Instant-Winner Lottery Games for Progressive Jackpots

As previously described, this new system and methodology provides lotteries with the ability to offer players more excitement as they can not only chase large instant-winner jackpots that can be progressed and continued until won, similar to Powerball® and Mega Millions®, but they can enjoy colorful and entertaining digital presentations of the results of the games rather than static paper-based ticket results after scratching or pulling a tab off a ticket. A progressive jackpot for instant-winner games could be linked to games purchased and/or played at some or all locations within a single jurisdiction, or within multiple jurisdictions domestically or internationally around the world, and/or to games purchased and/or played on user devices within a single jurisdiction, or within multiple jurisdictions domestically or internationally around the world.

One embodiment of this invention is to create progressive jackpot features for one and/or all instant-winner lottery games that may be processed through this new instant-winner lottery system. A progressive jackpot as used herein is a jackpot where the value of the jackpot increases (usually in a small amount) in a predetermined matrix for applicable wagers played in a particular game.

The progressive jackpot inventions of this patent are completely different from any feature described in any previous invention as this patent application envisions several different types of progressive jackpots and different progressive jackpot methodologies all uniquely invented solely for instant-winner lottery games processed using the systems in this invention.

It is another object to provide a random selection method, both on a pooled and non-pooled basis, which is under the control of the lottery or regulated entities, for determining the instant winner of the progressive jackpot.

An embodiment of this invention would also include any progressive jackpot for internet and remote communication play (initial play, extended play, and second chance play) of the systems and methods herein from applicable Smart Devices.

Under this invention, individual game designs of the instant-winner lottery games could have specific progressive jackpot features themselves. As an example of an instant-winner game concept, a theoretical game called “Lightning Rich” (which could be called any name) could be a progressive jackpot game. In this example, Lightning Rich would be an instant-winner lottery game, just like any other lottery game, which data is provided to the lottery retail interface terminals and/or to the Smart Devices via one of the IGNITE™ configurations. Upon the sale and communication of play data, a progressive jackpot feature would allow a portion of the sale to be applied to a main jackpot and/or smaller jackpots (as well as a smaller “shadow” jackpot). Under this invention, where the game is purchased and communicated would not matter for the progressive jackpot feature. The feature would be specific to the particular instant-winner lottery game. Lightning Rich is merely an example and this claim would be for any progressive jackpot relating to any instant-winner lottery game using the methodologies of this system. The multi-state/multi-national progressive jackpot system in this patent application would equally apply to a progressive jackpot for these lottery games.

This patent invention would be the first of its kind to enable lotteries to offer a progressive jackpot for intrastate, interstate and international play for instant-winner digital lottery games offered and/or purchased at point-of-sale locations. Unlike the progressive jackpots for future draw lottery games, this progressive jackpot would be an instant-winner progressive jackpot and not a future draw progressive jackpot.

A progressive jackpot under this invention can be determined a number of ways, including a pooled methodology and non-pooled methodology.

There are a plethora of variations under the pooled and non-pooled methods. For instance, instead of numbers, the computer could use caricatures or symbols (bells, whistles, cartoon caricatures, game caricatures, such as monopoly, wheel of fortune, etc), so that those caricatures or symbols are matched in the same random manner that the numbers would have been matched.

Both pooled and non-pooled methods can be very advantageous. The lottery authority running the game can control the selection method used depending on applicable laws, and the chances of winning. The chances of winning can be controlled by selecting the number of games/numbers in the pool or, in a non-pooled method, the number of potential random numbers that could be generated.

Other known electronic progressive jackpot selection processes also can be used. Each has the advantage in an instant-winner lottery game of allowing the lottery retail interface terminals and mobile computing devices to be located over very wide areas, including many states, and even countries, because truly random selection can be assured. The randomness is not affected by real or apparent bias, fraud or the risk of theft in the location of a winning game.

### Linking of Instant-Winner Lottery Games on Websites and Apps

Currently, the only instant-winner type digital lottery games that can be accessed and purchased are in a small number of legalized lottery websites and applications. Because those websites and applications have limited exposure and sales and stand apart from other lottery game sales, they have limited excitement for players.

An embodiment of this invention provides for instant-winner digital lottery games that are provided and/or purchased at physical point-of-sale locations and/or on mobile computing devices to be linked to digital instant-winner lottery games provided on lotteries' virtual websites and applications so that the excitement of huge jackpot prizes and play volume derived from sales at point-of-sale locations and/or mobile computing devices can also be enjoyed on websites and similar applications. Such jackpot and game linking is a unique embodiment of this new invention. Further, the linking would provide for better integration of promotions, advertising, and rewards programs to players. Linking could include progressive jackpot games, fixed jackpot games, and other interactive games.

### Linking of Instant-Winner Lottery Games Domestically and Internationally

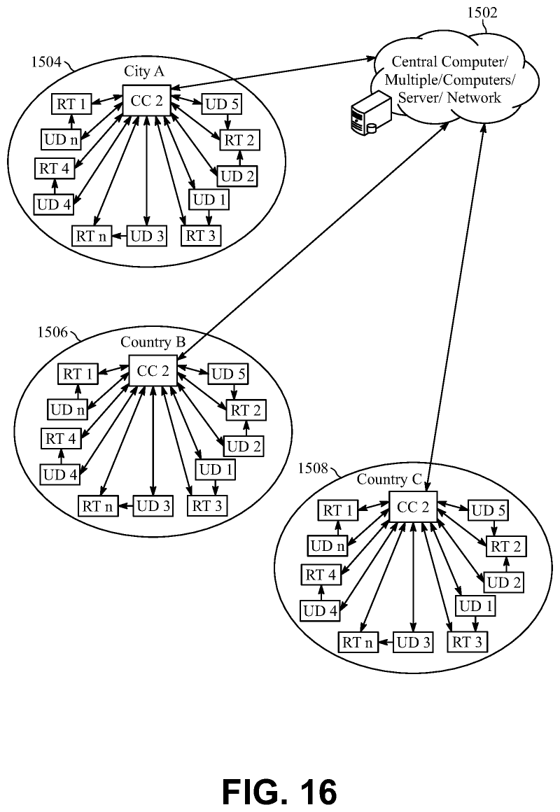

As previously described, another embodiment of the invention is enabling the lottery gaming system and/or lottery games to provide linked game play, both domestically and internationally. FIG. 16 is a block diagram showing interactions of players in different jurisdictions in accordance with an embodiment of the invention. Under this embodiment, when a player purchases a game, the game play is linked to other games purchased by other players either within one jurisdiction or multiple jurisdictions, such as a city 1504, a state 1506, and/or an entire country 1508. There are a number of type games that can be established once linked game play is enabled.

One type of game includes a progressive jackpot feature, previously described. Under this embodiment, the central lottery computer 1502 is programmed to conduct one or a plurality of lottery games and/or game features with at least one progressive jackpot prize that incrementally increases in some predetermined manner as the particular game and/or game feature is played until won. Although progressive jackpot prizes are well-established in the lottery industry, as Mega-Millions®, Powerball® and EuroMillions are progressive games, such games are NOT instant-winner games, they are delayed results draw type games. Draw games require the pooling of game entrants over a designated period of time, whereupon a draw occurs to determine a winner. If there is no winner, the jackpot increases until the next draw. Unlike draw type games, there has never been an instant-winner progressive jackpot for instant-winner digital lottery games purchased and/or sold at point-of-sale locations. This invention creates the first ever progressive jackpot for instant-winner digital lottery games purchased and/or sold at such locations.

The linking could also involve other games with fixed jackpot features. Or, the linking could involve a specific feature of the game. Further, the linking could involve interactive play between all players, or players demographically matched. Any feature of a lottery game could be linked under the system and methodology of this new invention.

In FIG. 15, the linked game would be operated from a central computer (CC) 1502, which could interact with the lottery retail interface terminals (RT) and/or Smart Devices (UD) either directly with the central computer, indirectly through a separate lottery central computer, or indirectly through an intermediary means. Alternatively, instead of one central computer, the linked game could be operated by multiple computers CC, which then interact directly or indirectly for updated game deployment and results, and also directly or indirectly with the lottery retail interface terminals RT and/or Smart Devices UD.

As previously mentioned for progressive jackpots, the amount of the jackpot earned from each transaction would be determined by the host lottery or lotteries in accordance with their game design and particular lottery rules and regulations. The amount of the jackpot would likely change frequently based on game play and, preferably be shown prominently on a display attached to or part of the lottery retail interface terminal RT, integrated multi-purpose self-service vending machine RT, and/or the player's personal Smart Device UD once the game has been communicated to such device. The central computer(s) CC would stop the accumulation of a jackpot once it has been won, and a new jackpot would be created at some smaller amount. The smaller amount can be a fixed sum or it can be determined by accumulating a “shadow” jackpot of a smaller amount per game transaction. The “shadow” jackpot would be substituted for the main jackpot once the previous main jackpot has been won. Instead of the progressive jackpot being reset to zero or some minimum fixed level when won, a shadow jackpot allows the progressive to be reset to a higher amount that still motivates players to play the progressive game.

### Non-Predesignated Fixed Jackpots

As previously mentioned, another embodiment of this invention is enabling the system to provide for fixed jackpot prizes that are not pre-designated. The major objective of this methodology is to eliminate the lotteries' “stale” inventory problems, which happen when the top jackpots of a particular instant-winner lottery game are won before all the play for the particular game has concluded; thereby making the remaining unsold games in that particular game batch stale. Players do not want to play a particular lottery game if there is no chance of winning one of the top jackpots. This methodology would allow the top jackpots to be “replenished” (i.e. reset), thus solving the stale inventory problems.

When an instant-winner lottery game is batched, all the games in the batch have set fixed jackpots and are predetermined as to the unique identifying code of the game in the batch. Under this embodiment of the invention, one or a plurality of the jackpots of a particular instant-winner lottery game batch would not be pre-designated to any particular game in the batch. Instead, a central computer would determine the winner of the particular fixed jackpot based on a methodology that does not pre-designate a particular game, such as a random number generator, or transaction number, or some other identification or code related to the game, or some other methodology. Based on predetermined algorithms, the central computer would then determine which game wins the fixed jackpot.

Once the highest amount is won, the system can automatically “replenish” the jackpot so it can continue to be won as more games are purchased, thus solving the lotteries' stale inventory problems. This invention also enables a lottery to continue a game genre for as long as players want to play it, instead of stopping a game genre as soon as all the batched games are sold or all the top jackpots are won in that genre.

Geographically or Demographically Enhanced and/or Directed Lottery Games

Since the system and method provide digital lottery games to be communicated and played on a player's Smart Device, another embodiment of this invention is providing geographically or demographically oriented instant-winner lottery games, which can be enabled not only for greater entertainment, but for targeted advertising and free promotional games.

A game can be initially geographically and demographically oriented based on the location of the lottery retail interface terminal or point-of-sale device, if such terminal is used to communicate play data and/or a code to the player. Once the game has been communicated onto the player's Smart Device, the additional geographic and demographic information from that device, which can be received as a result of GPS sensors of the device and information of the owner, can be used to target certain types of initial play, extended play, second chance play, bonus play and free play to that player's device. Examples of targeted games include specific themes, designs, and play-type popular in that geographic region or to that demographic group.

In addition, an augmented reality application can be provided to interact with a particular lottery game for enhancement of that game based on the geographic location of the player. In addition, and as more fully described under Advertising and Promotion herein, not only can the system provide targeted games and enhanced play features to the player because of the geographic location of the player's personal mobile device and the demographics of that player, but targeted advertising and promotions as well.

### Advertising and Promotions

Additional embodiments of this invention are novel advertising and promotions methodologies that can be incorporated into the IGNITE™ system. This new invention allows for the ability to provide promotional discounts, gifts, and advertisements in a variety of applications. These features can be provided in conjunction with the digital lottery games communicated to a player's personal Smart Device, such as, before, during and after visual presentation of a lottery game, or separate from the game, such as, separate alerts or other communications as to new games, the size of jackpot prizes, jackpot winners, and/or advertising and reward program communications.

One embodiment is for the lottery gaming system or particular lottery game to be programmed to provide for the games to be adaptable for the display of advertising, and/or advertiser's images, and/or other promotional offerings, including merchandise promotions, and/or cross-marketing coupons and/or other visual messages offering values and/or discounts for purchase, within or around the visual presentation of the game. The lottery gaming system or particular lottery game could provide within or around the visually displayed game play shown on the Smart Devices, advertising and/or advertiser's images, and/or other promotional offerings that can be shown randomly, in a pre-set pattern, or at will, based on one or more factors related to the game play, such as: time elements; stages of the game; winning or losing; the occurrence of certain events; the demographics of the location or player; and, the presentation of certain numbers, letters, symbols, caricatures, game pieces, and/or other images.

In addition, the advertising and/or advertisers' images and/or other promotional offerings could add to, replace, overlay, and/or correspond with some of the numbers, letters, symbols, caricatures, game pieces, and/or other images that otherwise could be used for the particular game. The game could be any type of instant-winner lottery game, whether a non-predetermined game, such as a progressive jackpot game, or pre-determined jackpot game.

The particular lottery gaming system for this invention could provide a number of different methods of providing advertising, which would be part of non-play data provided by or coordinated with the IGNITE™ system. The central computer could be programmed to provide the particular advertising to the lottery retail interface terminals along with the game play data, so both play and non-play data would be communicated to a player's Smart Device upon purchase from the lottery retail interface terminal or point of sale device. Or, depending on the IGNITE™ configuration, the advertising could be provided along with any other non-play data directly from the central computer to a player's Smart Device. Or, both methods could be provided.

Of the different methods, the advertising could be delivered as part of the game play, or separate from the game play. If part of the game play, the advertising and promotions could be included with the game play data provided by the central computer to the lottery retail interface terminals so that they can be played immediately on a player's Smart Device; and/or they could be provided after the Smart Devices communicate with the central lottery computer

Another embodiment provides for the display of promotions and advertising to be provided through software programs conducted by the central computer. Under this method, the central computer could have access to a database established for such promotion and advertising with the data base obtaining its data from internal or external input. Alternatively (or in conjunction with a database), the central computer could be configured to communicate directly with external ad networks. An example of such an ad network is AdMob, which is Google's advertising platform for promoting and monetizing mobile applications. Under this method, the central computer could be configured as generally known in the art to have access to the AdMob site whereby it would obtain the promotion and advertising provided by the site for presentation ultimately on the Smart Devices. Other similar ad networks include, but are not limited to, Airpush, InMobi, LeadBolt, MobFox, MoPub, RevMob, Smaato, Tapjoy, and Unity Ads. All the ad networks operate similarly in that an application would be created to remotely connect the particular ad network to the central computer in order for promotions and advertising to be transmitted. The central computer would then coordinate the transmission of the promotions and advertising provided from the database or external ad network to the lottery retail interface terminals and/or Smart Devices in conjunction with the visual presentation of the particular lottery games.

Another method for the display of promotions and advertising through this system could be through the lottery applications downloaded onto the Smart Devices that could have direct remote connection to either a database or to ad networks that are separate and apart from the central computer that would display promotions and advertising in coordination with the presentation of the particular lottery game. Under this method, the lottery applications could be configured to allow the display of promotions and advertising from the external database and/or ad network in connection with the visual presentation of the particular lottery games. And, another method may include a hybrid of both central computer coordination and external data base or ad network coordination to either the central computer or applications on the lottery retail interface terminals and/or Smart Devices. There may be other methodologies that could provide for the transmission of the display of promotions and advertising as well. Ultimately, the method used would provide for the transmission of the visual presentation of promotions and advertising, which is more fully described herein, on the Smart Devices in conjunction with or related to the visual presentation of the particular lottery games.

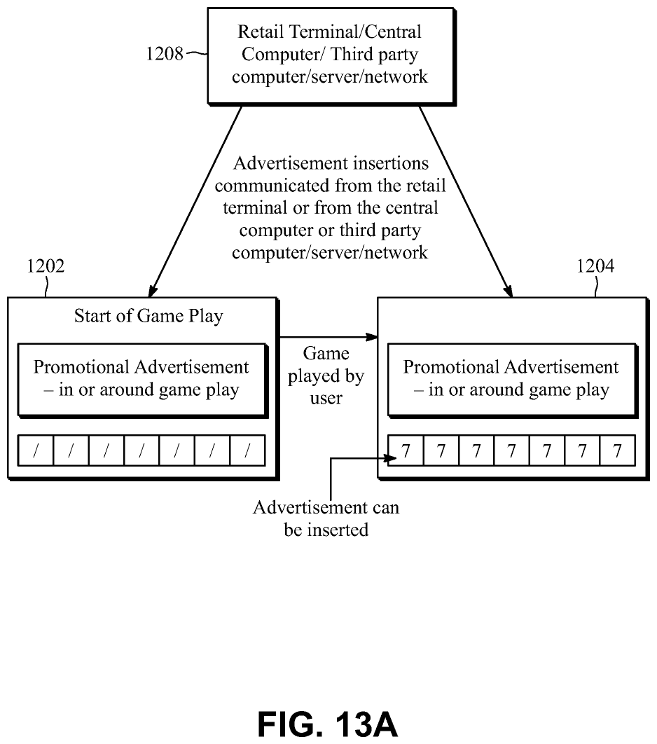

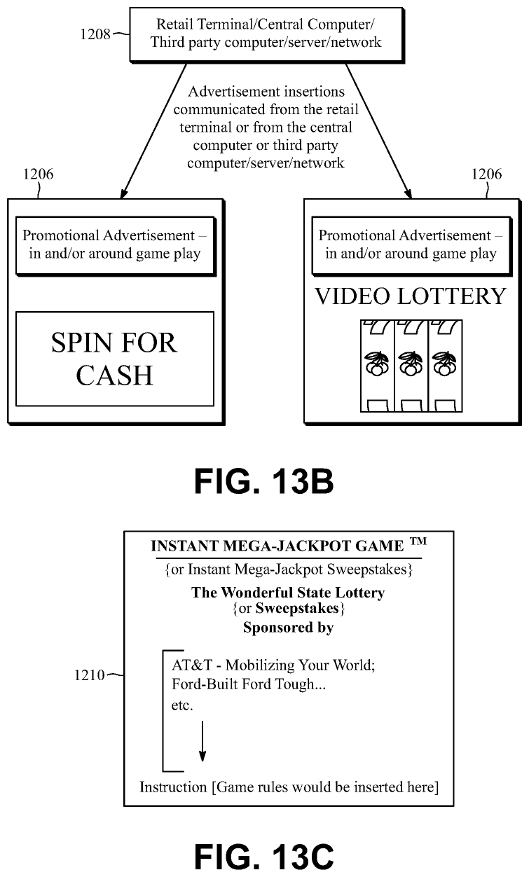

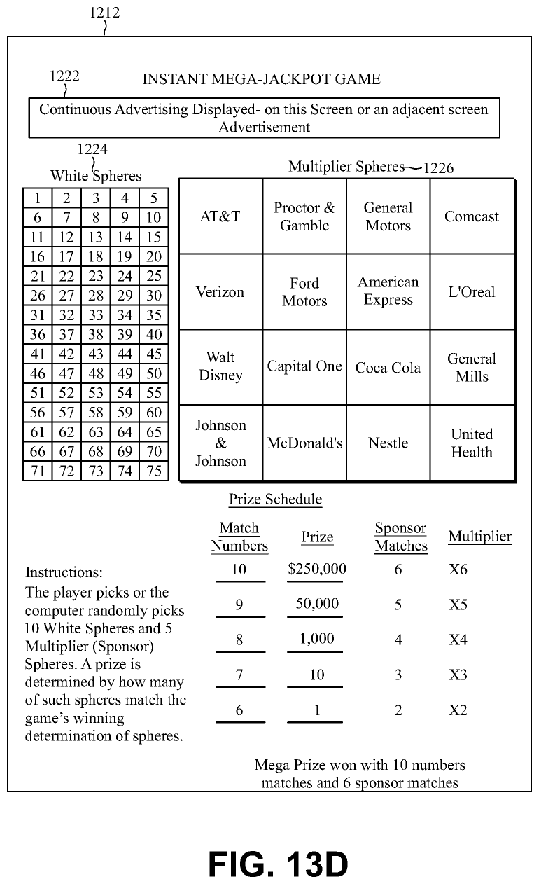

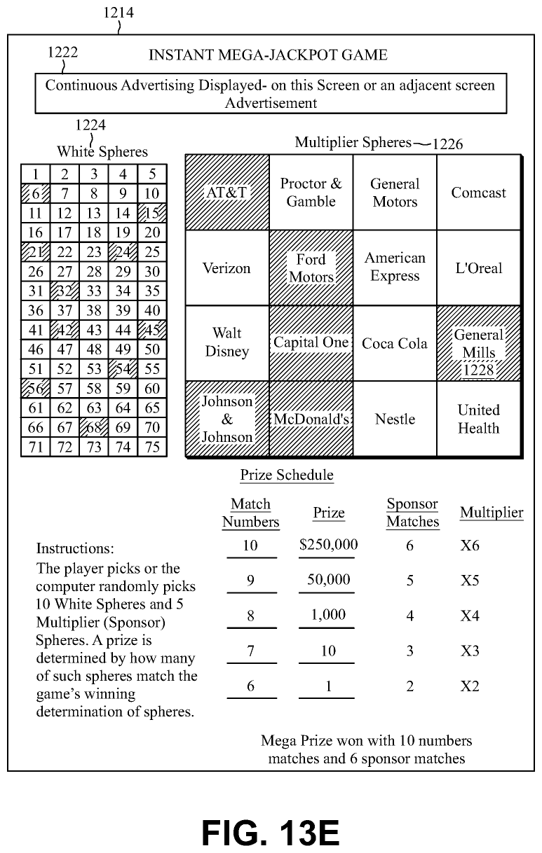

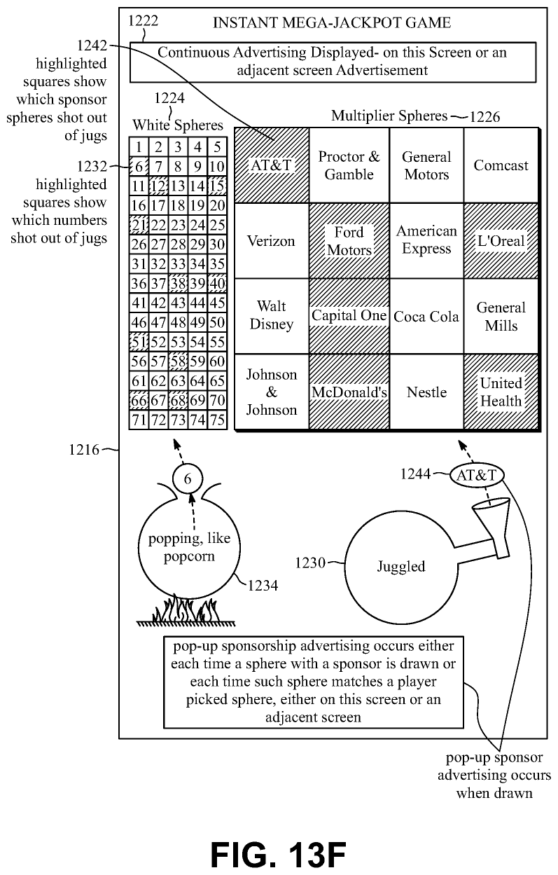

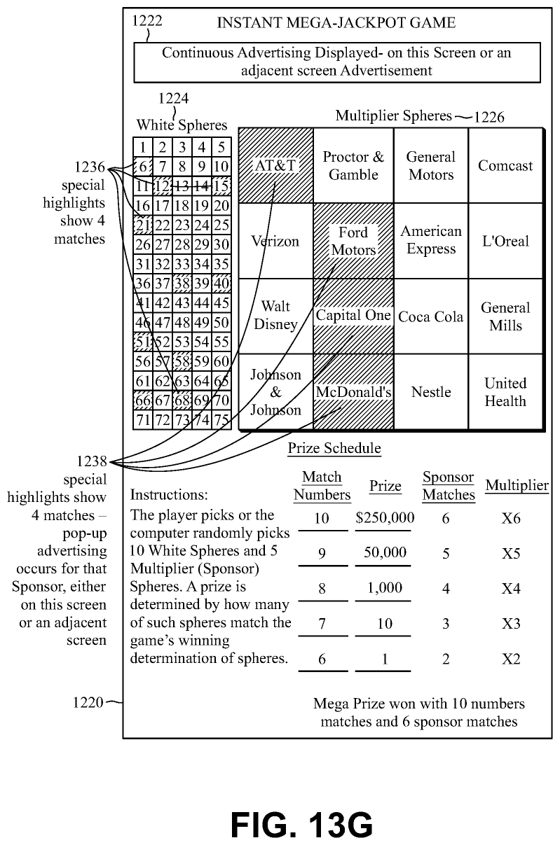

FIG. 13A shows an illustration of advertising data being communicated from the lottery retail interface terminal, central computer, and/or third party computer, server and/or network 1208. Advertising is shown inserted in or around game play at the start of game play 1202. Then, as game play continues, advertising is shown inserted in or around game play as well as into features of the game; in this instance the game is showing 7's, but advertising logos, tag lines, or ads could be inserted in place of one or more of the 7's or in addition to the 7's 1204. FIG. 13B shows still pictures of lottery play with an illustration of “promotional advertisement—in and/or around game play” 1206 that is meant to represent the advertising that could be inserted anywhere in the picture—top, bottom, sides, and within the game itself.

In addition to advertising, the invention enables the ability to provide for unlimited promotional features, including: product (tangible and intangible) giveaways for lotteries, non-lottery businesses, and activities (such as, video game providers, airlines, retail stores, restaurants, travel entities, governments, and others); rewards points, extended play, second chance play, free games, and an assortment of other promotions.

### Integrated Advertising as Part of Game Play

Another embodiment also provides that the lottery gaming system or particular lottery game can be enabled to provide for games adaptable for the display of advertising, and/or advertiser's images, and/or other promotional offerings within the game itself. This means that advertising and/or advertiser's images and/or other promotional offerings can be displayed within the game play. For instance, a bingo game could have particular advertisers logos shown as part of the displayed numbers; a card game could have particular advertisers logos shown on the cards; a match and play game could have matches related to particular advertisers logos; a game could have advertisement in the background within the game; an advertisement could be presented upon an event happening within the game, such as a ball hitting a symbol in a pinball type game; an advertisement could happen upon a bonus event; and other advertisement possibilities within the game are almost endless.

Another embodiment of this system is a method whereby the advertising and advertising sponsor logos are predetermined and inserted within the game so that the play data is pre-packaged and coordinated with advertisers prior to play data being communicated to a player's Smart Device. Another embodiment of this system is where the advertising and advertising sponsor logos are not predetermined, but rather inserted in preprogrammed positions within the game at the time the game is communicated to the player's Smart Device. The second methodology allows for flexibility as to advertising sponsors and the ability to charge advertising prices based on market conditions, including time of the day, demographics, and geographies, allowing the ability to maximize advertising sponsor revenue.

FIGS. 13C through 13G are shown to illustrate some of the embodiments of the insertion of advertising into game play. FIG. 13C illustrates the beginning of an instant-winner lottery game 1210 called “Instant Mega Jackpot Game.” This figure illustrates how advertisers could be shown as sponsors of the game by inserting names into the beginning of the game and game instructions.

FIG. 13D shows the game beginning 1212, with “white spheres” 1224 numbered on the left side, and “multiplier spheres” 1226 shown on the right side, with the instructions on how a player wins listed underneath along with a prize schedule. This game provides that if the player's selected “white sphere” 1224 match the game's selected white spheres 1224, the player wins a prize, as shown. Then, the player multiples the prize by the number of multiplier spheres 1226 that match the player's selections. In this illustration, advertising is inserted at the top of the screen “continuous advertising displayed” 1222 to provide an example of how advertising can be shown in and around the game play, and within the multiplier spheres 1226 to illustrate how advertising can be inserted into the game play.

FIG. 13E shows the progression of the game 1214, with all the circles 1228 representing the player's picks for the white spheres 1224 and multiplier spheres 1226. The illustration continues to provide an example of how advertising is shown in and around the game play and inserted into the game play.

FIG. 13F shows progression of the game 1216, with animation of how the game is choosing the winning spheres. The white spheres 1224 are shown being popped out of a pot with fire underneath (similar to popcorn) 1234. Each white sphere that pops out is a winning number 1232. Similarly, the multiplier spheres 1226 are shown being shot out of a jug after being juggled 1230, with each sphere representing a winning sphere 1242. The highlighted white spheres 1232 and the highlighted multiplier spheres 1242 represent the spheres that are winning spheres. The illustration continues to provide an example of how advertising is shown in and around the game play and inserted into the game play, with the advertisers 1244 shown on each multiplier sphere 1226 being shot out of the jug. This animation further shows how animation can be used to extend the viewing time by methodically animating each presentation of an element of a game. The longer the animation, the longer the viewing time, and the longer advertising can be presented.

FIG. 13G shows progression of the game 1220 to conclusion, where all the winning numbers of white spheres 1232 (FIG. 13F) have been popped out and where all the winning multiplier spheres 1242 (FIG. 13F) have been shot out. The highlighted white spheres 1236 on the left show which winning numbers matched the player's numbers, while the highlighted multiplier spheres 1238 on the right show which winning multiplier spheres matched the player's multiplier spheres. The illustration continues to provide an example of how advertising can be shown in and around game play and inserted into game play. In particular, it illustrates how advertising can be further inserted into game play by showing pop-up advertisement 1244 each time a winning match of multiplier spheres occurs. In this example, when a winning multiplier sphere is shot out of the jug, the game stops for a moment while an advertisement from the particular advertiser on the sphere is presented on the screen. By providing advertising upon a winning combination for the player, the advertisement can be viewed favorably by the player. In this example, the advertisement occurs in direct relationship to an occurrence in the game—in this instance, a winning multiplier sphere. Since the player won four multiplier spheres, the system was able to insert four advertising segments, along with showing name sponsors in the spheres and continuous banner advertising-providing potentially significant advertising income. There are almost an infinite number of ways under this invention advertising can be shown in the IGNITE™ system for game play and non-game play. The sequence of illustrations described herein is simply for purposes of showing one example of how advertising can be shown in and around game play and inserted into game play.

### Extended Play Algorithms-Extended View Feature

One of the main problems why advertising has never been able to be commercialized with gaming play in conventional systems is because games are shown for too short of time to provide advertising. There has never been a successful application of an extended viewing feature for digital gaming because extended viewing defeats the objective of both the game provider and the player.

Of course, non-gambling video gaming applications extend viewing over significant lengths of time because the challenge of the game is the primary motivator and the suppliers make money by providing challenging games. However, for gambling settings the primary motivator is the outcome-whether there is a winning or losing result. The gambling provider (i.e., the lottery, casino, etc) generates revenue by increasing game play—the longer the game, the less the number of games that can be played, and the less revenue that can be generated. Thus, providers are motivated to keep the games as short as possible while providing some entertainment value. Similarly, players want some entertainment, but also want to know if they have won or lost as soon as possible as well. Thus, the convergence of those two motivations has established “rapid results” games where the standard of the time length of digital gambling in the industry is between 3 to 10 seconds. Not so coincidentally, advertising standards have similarly set “attention spans” for digital ads at about 7 seconds.

Unfortunately, “rapid results” play makes advertising impractical since very little money can be made from advertising for such short period of time, and lottery play is very different from casino gaming because a player is usually only purchasing a limited quantity of games. Although this invention provides for entertainment features to delay results, most players are not playing the lottery games purely for entertainment-they want to know their results. Therefore, an embodiment of this invention combines animation features with an extended view feature, which may seem simple, but is complex. This feature is also similar to a Rubik's Cube, because all the elements can be seen but how to extend viewing, maintain a player's attention, calculate win algorithms, and provide economic feasibility is extremely complex.

Embodiments of this invention are methods to solve that Rubik's Cube for extended viewing. This invention provides novel methodologies to maintain a player's attention and patience while prolonging the visual presentation of the play results in an entertaining fashion with visual effects and/or varying game stages over extended lengths of time in order to provide a media that is not only entertaining, but more economically viable for the integration of promotions and advertising.

One methodology involves enabling the lottery game system and/or lottery games to enhance game play by providing win algorithms that allow for the extension of the visual display of entertaining features to those players with initial losing outcomes by the insertion of free play, bonus games, bonus awards, extended play features, second chance play, and/or other incentives. One example of this methodology is when the digital display of a particular lottery game ends in a losing outcome, whereupon the system and/or game can be programmed to provide for a continuation option, such as another level to the existing game and/or a free bonus game so the player has the ability to extend the existing game or play another game because win algorithms have been altered to provide for such extra play while keeping ultimate win outcomes within the parameters of a lottery's regulations. In another example, the player could be provided a free play of an assortment of digital lottery games in which no monetary winnings are awarded, but promotional offerings could be provided.

In order to provide extended game features, the win algorithms of the games must be modified in order to account for the additional possibilities of winning during the free play, bonus play, extended play, or other extended play options. An embodiment of this invention is the modification of win algorithms to provide for such extended game play in combination with animation features for viewing the extension.

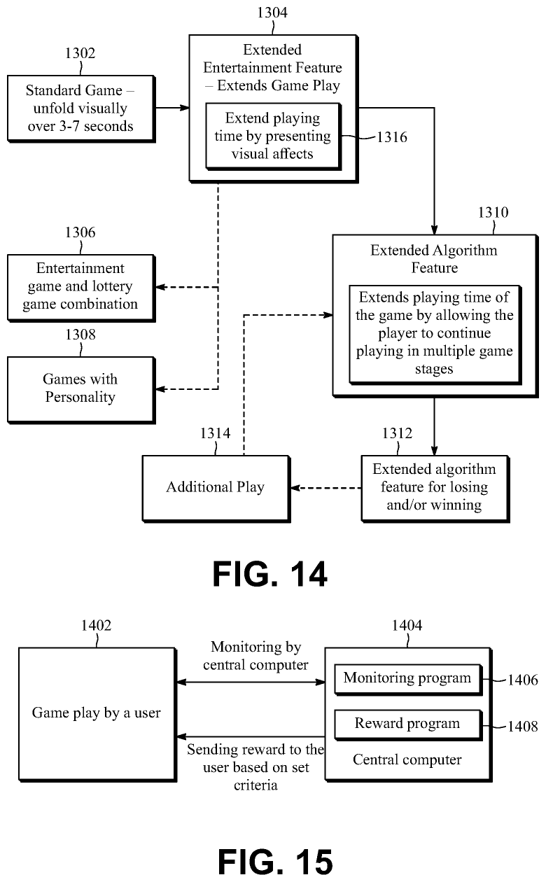

FIG. 14 shows an illustrative diagram of some of the embodiments of this invention to extend viewing time. Block 1302 represents how current digital instant games are played. Block 1304 shows the embodiment of this invention's “extended entertainment features” that “extend playing time by presenting visual effects” associated with multiple game features. Examples of extending game features by visual effects include games with personality 1308 and an entertainment game and lottery game combined 1306. The extended visual effects and multiple game features are made possible by the Extended Algorithm Feature 1310, which extends playing time by allowing the player to continue to be able to win in multiple game stages (extension of existing game, tiered leveled games, bonus games, and other features that allow the player to continue playing). One embodiment of an extended algorithm feature is additional play 1314 to be provided to a player losing and/or winning. This embodiment could allow for such play to continue for multiple cycles.

In order to provide long play and viewing time, the aforementioned insertion of extended and/or bonus game features could optionally continue on for a considerable extended period of time, so that a player could be provided multiple play levels, free plays, bonus games, bonus awards, extended play features, second chance play, and/or other incentives in order to have play extended from the normal rapid play time of 3-10 seconds to this invention's preferred extended play time of 1-10 minutes. However, this invention has no limitation on how long play can be extended, such as up to 30 minutes, one hour, or longer. Under this method, after the outcomes are known, promotional games could be made available to play all day. This methodology provides the ability for a lottery supplier and/or lottery to generate significant additional revenue from advertising sponsors that has never before been possible in the lottery or gaming industries.

Another embodiment is enabling the lottery game system and/or lottery games to enhance game play by providing game(s) that include a combination of an entertainment game and a lottery game 1306, where the combination provides an entertainment game that retains the playability and fun of a game of chance and/or skill while allowing for a lottery game to still be played and jackpots won before, during or after the entertainment game. In some embodiments, the wager-based lottery game is tied directly into the entertainment game, which provides additional entertainment and excitement. Other embodiments separate some of the aspects of the lottery game from the entertainment game to retain the feel of a lottery game while still providing an entertainment game to the player. By adding the combination, the player can enjoy playing the challenge of an entertainment game, which generally can occupy the attention of a player for many minutes, thereby allowing the display of the results of the lottery game to be extended over that same time period.

Another embodiment is enabling a lottery winner to continue playing an extended feature of the game for a chance to win an even greater prize or a new or bonus game, so that the player can continue playing without having to redeem their winnings.

Another embodiment is enabling the lottery game system and/or lottery games to enhance game play by providing games(s) programmed with visual and audio character effects 1308, whereby such programming would have stored audio and/or visual animated characters that would be presented in response to certain factors occurring during the display of the particular lottery game. The character may have a personality that may be encouraging, happy, uncertain, taunting, older, younger, or another quality, or even based on licensed characters from sports, TV, or movies, etc. A plurality of expressions of the personality would be presented, between one extreme and another, dependent upon the history and results of game outcomes. For instance, an animated character (or licensed known real-life character) display could be provided either by voice or visual, when the particular lottery game commences, prompting the player to play more, and/or make certain interactive moves, and/or be entertained from emotions elicited by the character upon certain factors happening in the game. The more entertaining the game becomes, the longer the period of time the game can be visually displayed, thus extending the viewing time of the game

All of these embodiments provide for the ability to extend the viewing of the game by providing a feature in which the gaming system or particular instant-winner lottery game is designed to provide entertaining visual effects and/or game stages that prolong the visual presentation of the game results over an extended length of time in order to provide a media better adaptable for additional promotions and advertising.

### Game Information Analyzer

Another embodiment of this system provides for a means to automatically record detailed player behavior and a process for analyzing that behavior in a rapid and cost-effective way. FIG. 15 shows an illustration of such an embodiment. Information on a player's playing activity 1402 would be communicated from the player's Smart Device to the central computer 1404 and processed through a software program 1406. Alternatively, the information could be communicated to the lottery retail interface terminal, and then later communicated to the central computer 1404.

The information could include the type of instant-winner game chosen, including, specific lottery identification, the amount of money spent on the games, the amount of money won or lost, the time of play, the location of play, the demographics of the player, the location of redemption of winnings, and player reward program information, if applicable.

Essentially, the lottery could have a fully automated reporting system that could dramatically reduce the lottery's administrative costs in operating instant-winner lottery games by providing game sales, retailer sales, redemptions paid and location from which paid, money due from retailers, and an assortment of game play and demographic data. The system provides information for player rewards programs 1408, whereby lotteries could monitor player activity 1402 and award points or other benefits to players. The players could also be targeted with specific advertising and promotions.

### Enhanced Game Features

Another embodiment of this invention is enabling the system to provide enhanced game features, some of which have been previously mentioned and described.

A previously described methodology under this system's extended view features is enabling the lottery game system and/or lottery games to enhance game play by providing win algorithms that allow for the extension of the visual display of entertaining features to those players with initial losing or winning outcomes by the insertion of free play, bonus games, bonus awards, extended play features, second chance play, and/or other incentives. This is a key and novel enhancement that provides cost effective reasons to enable this novel digital instant-winner lottery system for point of sale locations. Also previously described are entertainment games that can be played along with lottery games, as well as lottery games with visual and/or audio preprogrammed characters.

Other game enhancements include “player involvement” features, such as for virtual reality and augmented reality games, in which the lottery system can enable these new state of the art games for the first time into their game portfolio. Virtual and augmented reality games provide novel opportunities not only for enhanced game play, but for advertising and promotions.

The implementation of player involvement lottery games on a player's mobile device is envisioned under this system and method, whereby the lottery system and/or particular lottery game can be enabled to initiate the virtual or augmented reality game upon communication of the unique identification code to the central computer from the lottery retail interface terminals and/or the Smart Devices. Optional features in these games would provide for player involvement components, for instance, reward points could be awarded if a player visits a certain sponsor location in the real world, or it might send a player to a certain location in a virtual scavenger hunt in the lottery game, with such location being a sponsor location. It incorporates virtual reality and augmented reality aspects into the games, and provides ways of generating sponsor revenue by incorporating aspects of those games into sponsor benefits, while at the same time providing entertaining digital displays for players.

Extended Game Play from Winnings

As previously described, another embodiment of this invention is extended game play from player winnings. Currently, a player must redeem their instant tickets if the outcome of the game is a winner. However, this invention eliminates instant tickets and provides for digital games thereby enabling the system to either redeem the winnings or, if allowed in the particular lottery jurisdiction, to simply continue playing using the winnings to purchase new games.

Under this method, there are two ways the player can continue playing using their winnings if they do not want to redeem their winnings, depending on how the system configuration is initially set. If the player receives all the play data from a computer terminal, and no further communication is provided between the Smart Device and the central computer for further play data, then the player can return to the lottery retail interface terminal (or, optionally, any computer terminal in the system) and use the credits from any winnings to purchase further games on the computer terminal. This saves the player from having to redeem the winnings, and then separately purchase lottery games.

Alternatively, the system could be configured so that the lottery application on the Smart Device could prompt the player to purchase additional lottery games using the player's winnings, whereupon the application would coordinate encrypted communication with the central computer, which would provide such additional games to the Smart Device without the need to return to the lottery retail interface terminal. Although many lottery jurisdictions do not allow purchases of lottery games by credit or through the internet, using a player's winnings to purchase games may be acceptable in most jurisdictions because it is neither using credit nor a purchase through the internet because the player originally purchased the game at an authorized location. Using winnings can be considered simply an extension of game play and not a purchase of such games. This novel feature of this invention could dramatically increase lottery sales because of its convenience to players. Most players are likely to parlay small winnings into additional game play rather than redemptions.

### Administrative, Marketing and Analytical Systems

Another embodiment of the system enables tremendous administrative, marketing and analytical benefits for lotteries. Under all the configurations, the central computer is informed of all game purchases and non-play data that are provided to the player.

Under the configurations where the lottery applications on the players' mobile devices are programmed to communicate with the central computer, the central computer is further informed of additional play and non-play data, such as player information, geographic information, length of game play, advertising revenue, player choices, game analytics, player rewards programs, game feedback, player tracking programs, and extended play analytics (such as conversion of winnings into additional play rather than redemptions). An embodiment of this system is a game management program that provides for the tracking and monitoring of all of these elements 1406, such as that shown in FIG. 15. The system would not only provide how much money has been wagered and won by each game, but track all the other elements as well. The lottery and/or lottery supplier managing the system would be provided periodic reports of the game management and, optionally, have real-time game management reports generated through game management modules in communication with the central computer and visible on administrative lottery retail interface terminals managing the system. The game management system of this invention would virtually eliminate most of the administrative costs burdening the existing paper-based instant-winner lottery ticket systems.

The administrative system includes an embodiment to provide some or all governmental agency reporting requirements, such as providing form W-2G to the applicable winners of games, providing required information in compliance with money laundering monitoring obligations, and providing required information in compliance with governmental agency oversight boards and commissions. The unique features of this invention provide an ability to program the central computer, lottery retail interface terminals and mobile software applications in the network to accumulate, format, and process the applicable data, in a cost effective and timely manner.

### Player Rewards and Tracking Systems

Another embodiment of this invention is novel player rewards and tracking systems 1408 for instant-winner lottery games, such as shown in FIG. 15. Under one embodiment, data from the game play by a player would be communicated to a central computer from the lottery retail interface terminal and/or the player's Smart Device. Alternatively, data about the player and game play could be provided by other means (such as from the player through an App) and communicated to a central computer. Based on such data, player's could be awarded points, promotional offerings, and/or some other form of recognition based on play time, games played, location, demographics, and/or other data. Advertising, promotions, rewards, and other communications could be provided to the Smart Device used by the player based on all the data obtained from the player, the game played, the geographic location, and the other demographics and information obtained from the Smart Device. Algorithms could be created to provide players with specific lottery games, and tailored to provide players with specific advertising and promotions based on the demographics of the data.

There are a number of methods to provide player rewards and player tracking. This invention does not limit the various methodologies. The claims of this invention include any method that monitors game play on a player's Smart Device and/or by the player, and provides rewards points based on such monitoring. Further, the claims of this invention include any method that tracks lottery activity on a player's Smart Device and/or by a player, and provides analytical information related to such game play.

Under an example of a method, the lottery application for the Smart Devices and/or the central computer would be configured to communicate with at least one server via the lottery network. The application and/or central computer would be configured to monitor the display of play data and establish a particular reward based at least in part on a monetary value associated with the purchase value of the particular game. The application would be programmed to detect an award trigger during or at completion of the play of the game at a first point in time and grant an award upon detection of the award trigger, wherein the award includes an activation date, an expiration date, and a value that may be known or unknown to the player at the time of being awarded. Then, at a second point in time on or close to the activation date, the second point in time being subsequent to the first point in time, the player is notified that the award is active at a third point in time subsequent to the second point in time, receive a redemption request from the player to redeem the award; determine, in response to receiving the redemption request from the player, a redemption status of the award; based on the redemption status, either: (a) reveal a value of the award and provide the value of the award to the player between the activation date and the expiration date, or (b) notify the player that the award is expired. Optionally, the program could initiate a payout, game credit, a sponsor promotion, or other tangible or intangible thing of value associated with the award following receipt of a redemption request. There are a number of different ways the above could be implemented, including specifically modifying how a reward is determined, the amount of the reward, and how it may be redeemed,

Optionally included with the above, the lottery application and/or central computer could be configured to display a player tracking interface and receive player identification information via the tracking interface as well as the player account information, if available. Activation messaging is also optionally available under this system.

### Player Involvement Component Game Enhancements

IGNITE™ systems and methods provide for the embodiment of player involvement components to enhance game experiences and create new lottery games. Most of us understand player involvement from the virtual reality sense, whereby a player is provided a game that can be played on virtual reality platforms. As previously described, this type game provides the opportunity to insert advertising and promotions, as well as provide the player with a more dynamic visual game experience.

In addition, there are a number of other embodiments for game features. One embodiment is referred to as the exchange feature, an in-game marketing system, whereby the player pays and/or exchanges for a desired item or upgrade, with resources that they've collected, in a fixed and transparent exchange—e.g. the player hands over some units of wood to a craftsman or workbench, and they hand you back a wooden shield. The goal of this type of game would be to accumulate the resources necessary to win a prize in the game. As in all lottery games, the game winnings could be predetermined by set algorithms, but such algorithms can be set based on each decision the player makes within the game, much like how a bonus game or new level of a game works. Alternatively, the winnings could be non-predetermined, so that the algorithms within the game randomly determine the winner. In jurisdictions where games of skill are allowed, the game can work similar to card games where there are a set number of resources, the player is dealt certain of those resources, and the odds of exchanging for the right resources are calculated into the odds of winning. A player may also, in jurisdictions where permitted, be able to purchase the resources, in which the game would have modified algorithms to reconsider the wager depending on whether the outcome is predetermined, non-predetermined, or based on a skill type odds game. These types of games provide inherently greater time periods to play, thereby providing greater advertising and promotion opportunities to be inserted.

In another embodiment, referred to as architecture-exchange, the player must find a representational recipe, schematic, or blueprint (all referred to as the architecture) to determine what they must find to win a jackpot. Finding the architecture then provides them with the ability to exchange and/or pay for the items needed to win the jackpot, as previously described. Again, the game can be programmed to provide for predetermined, non-predetermined, or skill-odds results.

The IGNITE™ system embodies any type game designed to include player involvement in instant-winner digital games purchased from point-of-sale locations and/or any internet capable device. And all forms of advertisement and promotions, including integrated advertising, as previously described can be provided into and or around the display of these types of games, which are created primarily to extend the viewing time, in order to provide a revenue stream from third party sponsors.

### Extended Play, Second Chance Play, Bonus Play, Free Play

Another novel application of this system is the ability to provide extended play, second chance play, bonus play, and free play in a way never before possible for instant-winner lottery games purchased and/or sold at point-of-sale locations.

### Extended Play

As described under Extended Play Algorithms-Extended View Feature, all of these features can be inserted into an instant-winner game in order to extend the viewing time of such game. Each feature has its own advantages and disadvantages.

An extended play type feature can be provided by programming multiple layers of game play so that a player has a chance to win at every level and/or the player must win at an initial level to get to the next level (and any level thereafter) in order to win a jackpot. Or, the game can be programmed so that the player can parlay any lower level winnings into further game play to reach a higher level jackpot. Any combination can be provided, with the algorithms of the game set to continue game play over an extended period of time.

### Second Chance Play

Second chance play is a concept that is currently used in the instant-winner ticket games whereby players who have a losing outcome can enter a drawing to have a chance to win a prize. But, in order to enter, they have to provide their personal information and send in their losing lottery ticket-quite the hassle and effort. Under the IGNITE™ system, under one embodiment the players who lose could automatically be entered immediately into a drawing that could occur at some designated time without having to write to the lottery or provide further information. Under another embodiment, the players could simply be provided a new second chance game that could either be autonomous from other player's play, and the algorithms established for a second chance game, or conducted as a pooled pari-mutuel instant-winner type game so that all second chance play from all players are continuously determined.

### Bonus Play

Bonus play can be conducted similar to extended play, wherein there could be multi-levels to the game play and the player is automatically provided bonus play if the outcome of the initial play is a losing outcome. Or, it can simply be that a player can win a bonus play game during the play of the original game. In this configuration, a bonus game can be one of the winning outcomes of the game. Or, it can be that a player is provided a bonus game randomly by the system. Or it can be that a player is provided a bonus game from a player rewards program. Any type of bonus game reward under the IGNITE™ system is an embodiment of this invention.

### Free Play

Free play under the IGNITE™ system is also an embodiment of this invention. There is no invention that has been able to create a system to provide free lottery play through the sale of instant-winner lottery games at point-of-sale locations. Under this system, after purchase of a lottery game, a player can be provided free games to continue playing a digital game for entertainment purposes. This is made economically feasible by two means: first, the player has paid money for a first digital game, making the communication of further entertainment games cost effective; second, the advertising and promotions embodiment of this invention enable the lottery supplier to provide such advertising during the visual display of the free games, making the on-going communication of such games profitable to the lottery supplier. Further, the free games could be coordinated with a player rewards programs, so that the player could be awarded points by viewing the free games and/or a hidden prize could be provided in the free games.

### Other Non-Play and Play Related Data and Enhancements

Another embodiment of this invention is enabling the system to provide an assortment of other non-play and play-related data both to the player and to the lottery. Non-play and play-related data (all of which is referred to as non-play data) includes: advertising, promotions, email addresses, second chance play, player rewards, player tracking, game analytics, lottery game management, and other similar type data. An embodiment was previously described for advertising and promotions. Similar embodiments are envisioned under this invention for other non-play data.

In one of the embodiments where play data is communicated and pre-loaded to the lottery retail interface terminals from the central lottery computer, non-play data can be included with such communication so that the lottery retail interface terminals would have such data prior to purchase. In which case, upon purchase the data would be communicated from the computer terminal to a player's Smart Device along with the play data.

In another configuration, the non-play data can be communicated to the lottery retail interface terminals after confirmation of a purchase of a lottery game. The advantages of communicating to the lottery retail interface terminals from the central computer include increased communication security and the ability to immediately display such non-play data on a player's Smart Device once such device receives the data from the computer terminal.

However, another embodiment provides for the Smart Devices to also receive non-play data from the central computer after receipt of the initial play data or unique identifying code from the lottery retail interface terminals. Under this method, the central computer would provide and/or receive non-play data to/from the Smart Devices. This method would provide the greatest flexibility for advertising and promotions, player rewards, player tracking, game analytics, game management, virtual and augmented reality game possibilities, free play and extended visual presentation features. Since non-play data requires less security, using internet communication between the central computer and the Smart Devices creates less of a security issue for the lotteries and more ability to implement these novel features to these digital games.

These methodologies are not exclusive. It is envisioned the non-play data can be provided before purchase or at time of purchase to the lottery retail interface terminals, so the player receives on their Smart Device at time of purchase, or after purchase on a player's Smart Device, or using all three methods concurrently, so the player could receive part of the non-play data upon purchase and other non-play data after purchase.

The central computer could provide the non-play data or it could coordinate with other internal or external data bases and websites to provide the non-play data.

### Gifts

In another embodiment of this invention, the system provides the ability for a player to purchase a game and provide it as a gift to another person. An example of such an embodiment is provided within one of the IGNITE™ 4 systems, wherein a player can select a game using their Smart Device, then purchase the game at a point-of-sale device, whereat they can receive a code that can be communicated to the central computer via an applicable lottery application either on their Smart Device or any internet capable computing device. In such a system, the player could provide the code as a gift to another person to use and play the particular lottery game on any internet capable computing device. Any of the IGNITE™ systems can be modified to provide codes to the player so that they can be given as gifts to other people to use. Such a unique feature could be quite popular and provide lotteries another revenue producing sales method.

### Social Media

In another embodiment of this invention, the system provides the ability to communicate a player's gambling activities with social media platforms, such as Facebook, Twitter, TikTok, Instagram, YouTube, Whatsapp, etc., whereby information regarding winning, losing, types of games, location, and other characteristics can be shared, and, vice versa, information from those platforms can be retrieved and shared on the system. Further, the system can provide data necessary to create specific groups and communities of players and observers of the particular instant-winner games and related activities associated with such games.

The system can be programmed to provide a protocol that would allow players to grant permission to access their social media accounts. An example of such authorization is a protocol provided by OAuth Authentication. Once a player has provided authorization, the system can be programmed to access the player's data and post on their behalf. The system can also be programmed to retrieve data in real-time from a player's social media accounts through the social media platforms' data feeds. Generally, social media platforms provide application programming interfaces (APIs) that allow access to their data and functionality. The system can use these APIs to post updates, retrieve data, and interact with users on social media platforms.

The system can be programmed to allow social media platforms to send data to the system when specific events occur, such as when a user posts a new message or likes a post. By doing so, the system can use the data to update its own databases and/or alert the player of those users' activities, which could prompt the player to play a particular instant-winner game, travel to a particular location to purchase the particular instant-winner game, or trigger other actions.

By sharing information on social media platforms, the system can allow the particular lottery provider to reach a wider audience and increase its visibility. Social media platforms have millions of users, which provide a great opportunity for a lottery to expand its reach and attract new visitors. Social media platforms are designed for interaction and engagement, which can help a lottery and the particular player, build relationships with larger audiences. By sharing information on social media, the lottery through the players can encourage followers to engage with its content, comment, share, and like, which can increase its overall engagement levels. Overall, sharing information on social media platforms can help lotteries increase their visibility, engagement, traffic, and provide valuable insights into audience behavior and preferences for games, all of which can contribute to greater success, while keeping their players engaged and incentivized to play as a result of community affirmation of their activities.

Having fully described at least one embodiment of the instant game network integrated technology enhancement systems and methods for providing digital lottery games and gaming and non-gaming enhancements related to such games, other equivalent or alternative systems and methods for providing digital lottery games and enhancements according to the invention will be apparent to those skilled in the art. Various aspects of the invention have been described above by way of illustration, and the specific embodiments disclosed are not intended to limit the invention to the particular forms disclosed. The particular implementation of the instant game network integrated technology enhancement systems and methods for providing digital lottery games and enhancements may vary depending upon the particular context or application.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Although specific features of the instant game network integrated technology enhancement systems and methods for providing digital lottery games and enhancements are shown in some drawings and not others, persons skilled in the art will understand that this is for convenience. Each feature may be combined with any or all of the other features in accordance with the invention. The words “including,” “comprising,” “having,” and “with” as used herein are to be interpreted broadly and comprehensively, and are not limited to any physical interconnection. Claim elements and flowchart steps herein may have been numbered and/or lettered solely as an aid in readability and understanding. Any such numbering and lettering in itself is not intended to and should not be taken to indicate the ordering of elements and/or steps in the claims to be added at a later date.

Any amendment presented during the prosecution of the application for this patent is not a disclaimer of any claim element presented in the description or claims to be filed. Persons skilled in the art cannot reasonably be expected to draft a claim that would literally encompass each and every equivalent.

What is claimed is:

1. An instant-winner lottery game system comprising:
a. a central computer programmed to:
i. communicate via an intranet, the world-wide web and/or any remote communication means; and
ii. process digital instant-winner lottery games;
b. one or more lottery retail interface terminals located at one or more spaced-apart locations, having at least:
i. a means capable of entering into a communication interface with:
1) said central computer; and/or
2) a device providing information to and/or from said central computer;
ii. a means capable of storing and/or processing information provided from said central computer; and
iii. a means capable of communicating and providing information to mobile computing devices;
c. one or more mobile computing devices capable of downloading an applicable software application and entering into a network to communicate with said central computer;
d. wherein, a player can select digital instant-winner lottery games from a display of one or more of said games on said mobile computing device using said application and receive an identifying code or data relating to such selection;
e. wherein, said identifying code or data can be communicated to said lottery retail interface terminals and/or point-of-sale devices, which are either separate from or integrated with said lottery retail interface terminals, in connection with the purchase of said digital instant-winner lottery games;
f. wherein, upon or after purchase, information and/or codes relating to the selected game(s) can be communicated from said lottery retail interface terminals to said mobile computing devices for the display and processing of one or more of said digital instant-winner lottery games and/or a feature(s) of said digital instant-winner lottery games.

2. The system of claim 1 wherein information and/or codes relating to digital instant-winner lottery games are communicated from the central computer to the one or more lottery retail interface terminals via real-time, intermittent and/or intermediary communication and stored in said lottery retail interface terminals prior to purchase.

3. The system of claim 1 wherein, upon or after communication from the one or more mobile computing devices of the identifying code or data relating to a player's game selection to the one or more lottery retail interface terminals and/or point-of-sale devices, said one or more lottery retail interface terminals communicates such identifying code or data and/or another identifying code or data to said central computer, which, after confirmation such code or data as being valid in the system, communicates information and/or codes relating to said games to said lottery retail interface terminals.

4. The system of claim 1 wherein the one or more lottery retail interface terminals have a display of one or more digital instant-winner lottery games, displaying visual identification markings of said digital instant-winner lottery games to allow selection for purchase.

5. The system of claim 1 wherein, upon the one or more mobile computing devices receiving information and/or codes relating to the selected digital instant-winner lottery games from the one or more retail interface terminals, the applicable software application on the one or more mobile computing devices communicates information and/or code relating to the selected digital instant-winner lottery games, and/or some other identifying code relating to said digital instant-winner lottery games and/or related purchase transaction, with said central computer, which confirms such information and/or code as one being valid in the instant-winner lottery game system, whereupon said central computer communicates play data to said applicable software application on said mobile computing device to complete and/or continue and/or commence the display and processing of one or more of said digital instant-winner lottery games and/or a feature of said games on said mobile computing device.

6. The system of claim 1 wherein, upon the one or more mobile computing devices receiving said information and/or codes relating to the selected games from the one or more lottery retail interface terminals, the applicable software application on said one or more mobile computing devices communicates information and/or code relating to the selected game, and/or some other identifying code relating to said game and/or related purchase transaction, with said central computer, which confirms such information and/or code as one being valid in the instant-winner lottery game system, whereupon said central computer communicates and/or receives, and/or coordinates with one or more databases and/or with one or more external advertising, marketing platforms, or similar networks, in order to communicate and/or receive, non-play data to/from the applicable software application and/or other applications on the said at least one mobile computing device; wherein, non-play data would mean advertising, promotions, email addresses, second chance play, player rewards, player tracking, game analytics, lottery game management, prizes and awards from game sponsors, and other similar type data.

7. The system of claim 1 wherein, any winnings from one or more digital instant-winner lottery games can be: redeemed by confirmation that the identifying code included in the information is one that is valid in the applicable lottery system; and/or, used for additional play.

8. The system of claim 1 wherein the central computer is programmed to conduct one or more of digital instant-winner lottery games and/or game features that have at least one fixed jackpot prize that is a non-predesignated jackpot to a particular game and/or at least one progressive jackpot game that incrementally increases in some predetermined manner as the particular game and/or game feature is played until won.

9. The system of claim 1 wherein the instant-winner lottery game system or particular digital instant-winner lottery games provide advertising, and/or advertisers' images, and/or promotional offerings, including merchandise promotions, and/or cross-marketing coupons or other visual messages offering values and/or discounts for purchase before, during and/or after the display of said lottery game(s) within or around the visually displayed game play, and/or inserted into game play features, that can be shown randomly, in a pre-set pattern, or at will, based on one or more factors related to the game play, such factors include: time elements; stages of the game; winning or losing; the occurrence of certain events; the demographics of the location or player; and, the presentation of certain numbers, letters, symbols, caricatures, game pieces, and/or other images.

10. The system of claim 1 wherein at least one of the digital instant-winner lottery games includes an extended view feature in which the algorithms of a lottery game system or particular lottery game are designed to insert extended play features into games with losing and/or winning outcomes, such features including, free play, extended play, second chance play, bonus games, bonus awards, tiered levels, other incentives, and similar games and features that prolong the visual presentation of game results over an extended length of time in order to provide a media better adaptable for more entertainment and/or additional promotions and advertising, and/or other game and non-game features.

11. The system of claim 1 wherein the instant-winner lottery game system or particular lottery games are programmed to provide: interactive lottery games, whereby the player may interact with game play by having choices within the games; and/or, linked games, whereby a feature of a game can be affected in some linked manner with play in one or more other game(s).

12. The system of claim 1 wherein the instant-winner lottery game system and/or particular lottery game are enabled to enhance game play by providing players with the chance to continue playing by allowing them to trade in their winnings for a chance for a greater prize and/or use their winnings as credits to enter into a new game(s) until such credits are depleted.

13. An instant-winner lottery game system comprising:
a. a central computer programmed to:
i. communicate via an intranet, the world-wide web and/or any remote communication means; and
ii. process digital instant-winner lottery games;
b. one or more lottery retail interface terminals located at one or more spaced-apart locations, having at least:
i. a means capable of entering into a communication interface with:
1. said central computer; and/or
2) a device providing information to and/or from said central computer;
ii. a means capable of storing and/or processing information provided from said central computer;
iii. a means capable of communicating and providing information to mobile computing devices;
c. one or more mobile computing devices capable of downloading an applicable software application and entering into a network to communicate with said central computer;
d. wherein, a player can select digital instant-winner lottery games from a display of one or more of said games on said mobile computing device using said application and receive an identifying code or data relating to such selection;
e. wherein, said identifying code or data is communicated to said lottery retail interface terminals and/or point-of-sale devices, which are either separate from or integrated with said lottery retail interface terminals, in connection with the purchase of said games;
f. wherein, upon or after purchase, information relating to the selected game(s) can be communicated from said central computer to said mobile computing device to complete the display and processing of one or more of said lottery games and/or a feature(s) of said games.

14. The system of claim 13 wherein, upon or after communication from said mobile computing device of the identifying code or data relating to a player's game selection to said lottery retail interface terminal and/or point-of-sale device, said lottery retail interface terminal communicates such identifying code or data and/or another identifying code or data relating to such purchase to either:
a. said central computer, which confirms said purchase as being valid in the lottery system; or
b. said player, who inputs, or allows another person to input, said code into one of said mobile computing devices, which communicates such code or data to said central computer to confirm said purchase as being valid in the lottery system; or
c. said mobile computing device, which communicates said code or data to said central computer to confirm said purchase as being valid in the lottery system.

15. The system of claim 13 wherein said lottery retail interface terminals have a display of one or more instant-winner lottery games, displaying visual identification markings of said games to allow selection for purchase.

16. The system of claim 13 wherein any winnings from the game played can be: redeemed by confirmation that the identifying code included in the information is one being valid in the applicable lottery system; and/or, used for additional play.

17. The system of claim 13 wherein the central computer communicates and/or receives, and/or coordinates with one or more databases and/or with one or more external advertising, marketing platforms, or similar networks, in order to communicate and/or receive, non-play data to/from said application and/or other applications on said mobile computing device; wherein, non-play data would mean advertising, promotions, email addresses, second chance play, player rewards, player tracking, game analytics, lottery game management, prizes and awards from game sponsors, and other similar type data.

18. The system of claim 13 wherein said central computer is programmed to conduct one or more of said lottery games and/or game features that have at least one fixed jackpot prize that is a non-predesignated jackpot to a particular game and/or at least one progressive jackpot game that incrementally increases in some predetermined manner as the particular game and/or game feature is played until won.

19. The system of claim 13 wherein the instant-winner lottery game system or particular lottery games provide advertising, and/or advertisers' images, and/or promotional offerings, including merchandise promotions, and/or cross-marketing coupons or other visual messages offering values and/or discounts for purchase before, during and/or after the display of a said lottery game(s) within or around the visually displayed game play, and/or inserted into game play features, that can be shown randomly, in a pre-set pattern, or at will, based on one or more factors related to the game play, such factors include: time elements; stages of the game; winning or losing; the occurrence of certain events; the demographics of the location or player; and, the presentation of certain numbers, letters, symbols, caricatures, game pieces, and/or other images.

20. The system of claim 13 wherein at least one of the digital instant-winner lottery games includes an extended view feature in which the algorithms of a lottery game system or particular lottery game are designed to insert extended play features into games with losing and/or winning outcomes, such features including, free play, extended play, second chance play, bonus games, bonus awards, tiered levels, other incentives, and similar games and features that prolong the visual presentation of game results over an extended length of time in order to provide a media better adaptable for more entertainment and/or additional promotions and advertising, and/or other game and non-game features.

21. The system of claim 13 wherein the instant-winner lottery game system or particular lottery games are programmed to provide: interactive lottery games, whereby the player may interact with game play by having choices within the games; and/or linked games, whereby a feature of a game can be affected in some linked manner with play in one or more other digital instant-winner lottery games.

22. The system of claim 13 wherein the lottery game system and/or particular lottery games are enabled to enhance game play by providing players with the chance to continue playing by allowing them to trade in their winnings for a chance for a greater prize and/or use their winnings as credits to enter into a new game(s) until such credits are depleted.

23. An instant-winner lottery game system comprising:
a. a central computer programmed to:
i. communicate via an intranet, the world-wide web and/or any remote communication means; and
ii. process digital instant-winner lottery games;
b. point-of-sale devices located at one or more spaced-apart locations that are capable of processing identifying codes or data relating to said lottery game system;
c. one or more mobile computing devices capable of downloading an applicable software application and entering into a network to communicate with said central computer;
d. wherein, a player can select one or more digital instant-winner lottery games from a display of one or more of said one or more digital instant-winner lottery games on said mobile computing device using said application and be provided an identifying code or data relating to such selection;
e. wherein, said identifying code or data can be communicated from the said one or more mobile computing devices to the said point-of-sale devices in connection with the purchase of said games;
f. wherein, said point-of-sale devices are programmed to communicate an identifying code or data relating to such purchase to either:
i. said central computer, which confirms said purchase as one being valid in said lottery system; or
ii. said player, who inputs, or allows another person to input, said code or data into one of said mobile computing devices, which communicate said code or data to said central computer to confirm said purchase as one being valid in said lottery system; or
iii. said one or more mobile computing devices, which communicates said code or data to said central computer to confirm said purchase as one being valid in said lottery system;
g. wherein, upon or after confirmation of said purchase, information relating to the selected game(s) can be communicated from said central computer to said mobile computing device to complete the display and processing of one or more of said lottery games and/or a feature(s) of said games.

24. The system of claim 23 wherein the point-of-sale devices: have a display of one or more instant-winner lottery games, displaying visual identification markings of the one or more digital instant-winner lottery games to allow selection for purchase; and/or, are separate from or integrated with lottery retail interface terminals that have said display.
